(19) United States
(12) Patent Application Publication
(10) Pub. No.: US 2013/0202116 A1
(43) Pub. Date: Aug. 8, 2013

(54) Apparatus and Method for the Time-Oriented Evaluation and Optimization of Stereophonic or Pesudo-Stereophonic Signals

(71) Applicant: StormingSwiss GmbH, Morges (CH)

(72) Inventor: Clemens Par, Cinous-chel (CH)

(73) Assignee: StormingSwiss GmbH, Morges (CH)

(21) Appl. No.: 13/792,488

(22) Filed: Mar. 11, 2013

Related U.S. Application Data
(63) Continuation of application No. PCT/EP2011/065694, filed on Sep. 9, 2011.

(30) Foreign Application Priority Data
Sep. 10, 2010 (CH) 01468/10

(51) Int. Cl. H04R 5/00

(52) U.S. Cl. CPC H04R 5/00
USPC 381/17

(57) ABSTRACT

The present invention relates to devices and methods for producing stereophonic or pseudostereophonic signals. In particular, the interrelations between spatial and technical parameters are examined and new ways of optimizing said parameters are proposed. Furthermore, inverse problems are applied in an unexpected manner to optimization problems pertaining to the conversion. The invention is relevant particularly to the encoding of audio signals.

This application is a continuation of international application PCT/EP2011/065694 filed on Sep. 9, 2011, the contents of which is enclosed by reference. It claims priority of Swiss patent application CH10/1468, filed on Sep. 10, 2010, the contents of which is enclosed by reference.

The invention relates to devices and methods for stereophonizing a mono signal resp. for obtaining pseudostereophonic signals.

In particular, time resp. phase differences between different signals are more closely analyzed, in order on the one hand to be able to draw conclusions as to the acoustic properties of the signals and on the other hand to synthethize stereophonic or pseudostereophonic signals (this term also includes signals with more than two channels) that also exhibit these or other acoustic properties in an ideal form.

In particular, stereophonic or pseudostereophonic signals are analyzed that have been generated according to devices or methods according to EP1850639 or WO2009/138205 or WO2011/009649 or WO2011/009650 or CH01264/10 resp. PCT/EP2011/063322 and that are to be optimized either in terms of their psychoacoustic properties or that are to be matched with existing stereophonic or pseudostereophonic signals in terms of their psychoacoustic properties.

Methods so far in connection with EP1850639 or WO2009/138205 optimize the parameters exclusively in terms of an angle-dependent virtualization of a classic MS array. According to the invention, this arrangement is additionally subjected to a time-dependent virtualization.

The present invention not only explores all possibilities of such a virtualization—partly through the radical simplification of the systems existing with EP1850639 or WO2009/138205 or WO2011/009649 or WO2011/009650 or CH01264/10 resp. PCT/EP2011/063322—but even achieves their automatization through the unexpected reformulation of the so-called inverse problem known for noise filters and interference filters.

Hereinafter, the state of the art will be described, in particular with respect to devices or methods for obtaining, improving or optimizing stereophonic or pseudostereophonic audio signals.

EP0825800 (Thomson Brandt GmbH) proposes the generation of different kinds of signals from a mono input signal by means of filtering, said signals being used—for example by using a method proposed by Lauridsen based on amplitude and time difference corrections, depending on the recording situation—to generate virtual single-band stereo signals separately, which are then subsequently combined to form two output signals.

WO/2009/138205 as well as EP1850639 describe among others a method for methodically evaluating the angle of incidence for the sound event that is to be mapped, said angle of incidence being enclosed by the main axis of the microphone and the directional axis for the sound source, this being achieved by applying time differences and amplitude corrections which are functionally dependent on the original recording situation (which may be interpolated by using the system). The contents of WO/2009/138205 as well as of EP1850639 are hereby incorporated as a reference.

U.S. Pat. No. 5,173,944 (Begault Durand) applies HRTFs (Head Related Transfer Functions), which correlate with 90, 120, 240 and 270 degrees azimuth respectively, to the differently delayed but uniformly amplified monophonic input signal, the formed signals in turn being finally superimposed on the original mono signal. In this case, the amplitude correction and the time difference corrections are chosen independently of the recording situation.

U.S. Pat. No. 5,671,287 (Michael A. Gerzon) proposes among others cascaded all-pass filters for forming a pseudo-sterophonic signal. A further suggestion relates to the use of all-pass filters in both channels, with a frequency-dependent rotation matrix being connected downstream thereof; although this method manages to disperse sound sources having the same frequency, there is no perceptible spatial separation of these sound sources as achieved by EP1850639 or WO2009/138205 or WO2011/009649 or WO2011/009650 or PCT/EP2011/063322.

WO2011/009649 proposes the ostensibly not purposeful downstream connection of one or more panoramic potentiometers or equivalent means in a device according to WO2009/138205 or EP1850639 after stereo decoding has taken place (after an MS matrix, for which the relation

L=(M+S)*1/√ 2̅

and

R=(M−S)*1/√ 2̅

applies, has been passed through), which—unlike in the case of intensity stereophonic signals, i.e. for stereo signals which differ exclusively in terms of their levels but not in terms of time resp. phase differences or different frequency spectra—do not result in the intended narrowing of the image width or in the intended shifting of the localisation direction of the obtained stereo signals, but rather result in the degree of correlation being increased or decreased. The contents of CH701497 resp. WO2011/009649 are hereby incorporated as a reference.

WO2011/009650 enables an optimum choice of those parameters that form the basis for generating stereophonic or pseudostereophonic signals. The user is provided with means for specifying the degree of correlation, the definition range, the loudness as well as further parameters of the resulting signals according to psychoacoustic aspects, and hence for preventing artifacts. The contents of CH01776/09 resp. WO2011/009650 are hereby incorporated as a reference.

CH01264/10 resp. PCT/EP2011/063322 for the first time makes it possible to evaluate invariants for example of the combination of two or more at least partly slightly decorrelated signals or of their transfer functions, wherein these signals or transfer functions appear to be completely random (such as for example audio signals), so that for example for two or more different signal sections it is possible to draw conclusions as to their properties (for example the sum of the transfer functions

f*[x(t)]=[x(t)/√ 2̅]*(−1+i)

g*[y(t)]=[y(t)/√ 2̅]*(1+i)

for a stereophonic audio signal x(t), y(t), where x(t) represents the function value of the left input signal at the point in time t, y(t) represents the function value of the right input signal at the point in time t), and thus for example devices or methods for obtaining, improving or optimizing stereophonic or pseudostereophonic audio signals can consequently be calibrated. Since the contents of this document have not been published at the time of the present application, their contents are reproduced in full hereafter.

### DISCLOSURE OF THE INVENTION

According to one aspect of the invention, a method for stereophonizing a mono signal resp. for obtaining pseudostereophonic signals is proposed, wherein calculated time differences are multiplied, prior to their being used on a mono signal to be rendered stereophonic, with a time parameter (s), which is greater than zero, and thus yield new time differences (L_{A}′=L_{A}*s, L_{B}′=L_{B}*s resp. L_{α}′=L_{α}*s, L_{β}′=L_{β}*s).

According to another aspect of the invention, a further time parameter s is introduced in addition to the parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, the attenuations λ or else ρ for forming the resulting stereo signal in the case of WO2009/138205 resp. the angle φ enclosed by the main axis and the sound source as well as the attenuation λ or else ρ for forming the resulting stereo signal in the case of EP1850639. This additional time parameter s, when multiplied with the time differences L_{α} and L_{β} (in the case of WO2009/138205) resp. with the time differences L_{A} and L_{B} (in the case of EP1850639), determines new time differences L_{α}′ and L_{β}′ (in the case of WO2009/138205) resp. new time differences L_{A}′ and L_{B}′ (in the case of EP1850639), which replace the former time differences L_{α} and L_{β} resp. L_{A} and L_{B}.

Therefore, to start with, for any s>0 the following is in principle true:

L_{α}′=L_{α}*s={−f(α)/(2 sin α)+√[f²(α)/(4 sin² α)+f²(φ)−(f(α)*f(φ)*sin φ)/sin α]}*s (1D)

and

L_{α}′=L_{β}*s={−f(β)/(2 sin β)+√[f²(β)/(4 sin² β)+f²(φ)+(f(β)*f(φ)*sin φ)/sin β]}*s (2D)

(in the case of WO2009/138205) resp.

L_{A}′=L_{A}*s=[√(5/4−sin φ)−1/2]*s (3D)

and

L_{B}′=L_{B}*s=[√(5/4+sin φ)−1/2]*s (4D)

(in the case of EP1850639).

The choice of s, as shown in practice, is not trivial. If s is chosen too small, the pseudostereophonic effect to be achieved disappears, if s is chosen too great, disturbing artifacts will result. If s is about 100 milliseconds, this will yield for a device or a method according to EP1850639 or WO2009/138205 or WO2011/009649 or WO2011/009650 or CH01264/10 resp. PCT/EP2011/063322 ideal pseudostereophonic signals that exhibit the same quality as with a classic MS recording technique.

Tests have altogether shown, that the ideal range for s is between 29 milliseconds and 146 milliseconds.

A variant embodiment of the invention that is advantageous for the user thus affords the possibility of freely selecting s>0. Similarly, the devices and methods or systems represented in EP1850639 or WO2009/138205 or WO2011/009649 or WO2011/009650 or CH01264/10 resp. PCT/EP2011/063322 allow the automatized or interactive determination of the new parameter s. For example, in FIG. 15D, in addition to f (resp. n), which describe the directional pattern of the signal that is to be rendered stereophonic, the angle φ—to be ascertained manually or by metrology—enclosed by the main axis and the sound source, the fictitious left opening angle α and the fictitious right opening angle β, in the same manner the new parameter s, which has a direct influence on the sum of the transfer functions

f*[x(t)]=[x(t)/√ 2̅]*(−1+i)

g*[y(t)]=[y(t)/√ 2̅]*(1+i)

for a stereophonic audio signal x(t), y(t) (where x(t) represents the function value of the left input signal at the point in time t, y(t) represents the function value of the right input signal at the point in time t), is optimized iteratively in the same fashion as f (resp. n), φ, α, β.

This means in particular automatically and optimally choosing such parameters which form the basis for the generation of stereophonic or pseudostereophonic signals, resp. a method and a device for optimally and automatically determining particularly the parameters (φ, λ, ρ resp. f (resp. n), α, β- and henceforth newly s) while generating said stereophonic or pseudostereophonic signals.

Such a method resp. such a device are intended to be used to select, from a plurality of decorrelated, in particular pseudostereophonic, signal variants, those whose decorrelation is found to be particularly advantageous.

In particular, it should be possible to influence the selection criteria themselves in a form as efficient and compact as possible in order to be able to convert signals of different nature (for example speech in contrast to music recordings) into the optimized reproduction thereof.

According to one aspect, WO2011/009650 proposes a device and a method for obtaining pseudostereophonic output signals x(t) and y(t) by using a stereo decoder, wherein x(t) is the function value of the resulting left output channel at the time t, and y(t) is the function value of the resulting right output channel at the time t, in which the obtainment is iteratively optimized until <x(t), y(t)> is within a predetermined definition range.

If there are dropouts or similar defects, however, an insignificant quantity of single points may lie outside the definition range. In this case, the obtainment is iteratively optimized until a portion of <x(t), y(t)> is within the predetermined definition range.

The desired definition range is preferably stipulated by a single numerical parameter a, where preferably 0≦a≦1. This parameter and hence the definition range can be usefully stipulated for example by the inequality

Re²{f*[x(t]+g*[y(t)]}*1/a²+Im²{f*[x(t]+g*[y(t)]}≦1

wherein the relations

f*[x(t)]=[x(t)/√ 2̅]*(−1+i)

and

g*[y(t)]=[y(t)/√ 2̅]*(1+i)

apply for the complex transfer functions f*[x(t)] and g*[y(t)]} of the output signal x(t), y(t).

The user can arbitrarily stipulate such a definition range, on the basis of the unit circle of the complex number plane resp. of the imaginary axis (if the maximum level of the output signal x(t), y(t) has been normalized on the unit circle), by using the parameter a, 0≦a≦1.

This principle also remains valid when a reference system other than the unit circle of the complex number plane is chosen and a different new definition range is defined. “Definition range” is therefore understood generally to mean an admissible range of values for <x(t), y(t)> of the output signal x(t), y(t), which, overall, is intended to contain <x(t), y(t)> in full or in part (for example in the case of defective sound recordings which show what are known as dropouts).

In a preferred variant embodiment, the degree of correlation of the output signals (x(t) and y(t)) is normalized. In a preferred variant embodiment, the level of the maximum of the resulting left and right channel is normalized. In this way, certain parameters can be iteratively optimized in order to attain the desired definition range, without said parameters affecting the degree of correlation or the level of the maximum of the resulting left channel and right channel.

It also makes sense if—for extremely different parameterizations for φ resp. f (resp. n), α, β and henceforth newly s—criteria which are dependent on |<x(t), y(t)>| are used for the stipulation. For this purpose, according to the invention, a corresponding range of values dependent on |<x(t), y(t)>| is normalized, so as to constitute a criterion for the optimization of the parameters.

In one embodiment, a method for obtaining pseudostereophonic output signals x(t) and y(t) by using a converter is therefore proposed, wherein x(t) is the function value of the resulting left output channel at the time t, wherein y(t) is the function value of the resulting right output channel at the time t, wherein the complex transfer functions f*[x(t)] and g*[y(t)] of the output signals are defined:

f*[x(t)]=[x(t)/√ 2̅]*(−1+i)

g*[y(t)]=[y(t)/√ 2̅]*(1+i),

in which the obtaining is iteratively optimized until the following criterion is satisfied:

Re²{f*[x(t]+g*[y(t)]}*1/a²+Im²{f*[x(t]+g*[y(t)]}≦1,

where 0≦a≦1 stipulates the desired definition range.

A remarkable aspect of the methods for obtaining pseudostereophonic signals according to WO/2009/138205 or according to EP1850639 is the fact that they always provide a perfect center signal. For this reason, the short time cross correlation

$$r = ( 1 / 2 T ) * {\int }_{- T}^{T} x ( t ) y ( t ) d t * ( 1 / {x ( t )}_{eff} {y ( t )}_{eff} ) \qquad ( 1 B )$$

is introduced here for the time interval [−T, T] and the output signals x(t) from the left channel and y(t) from the right channel.

As already mentioned, it makes sense if a uniform degree of correlation is attained for extremely different parameterizations for φ resp. f (resp. n), α, β and henceforth newly s. For this purpose, according to the invention, the degree of correlation between the output signals (x(t) and y(t)) is normalized. This normalization can preferably be stipulated by means of the specific variation of λ (left attenuation) or ρ (right attenuation).

On the basis of the uniform degree of correlation, the signal attained can now be systematically subjected to evaluation criteria that can be influenced by the user.

It also makes sense if a uniform level for the maximum of the resulting left and right channel is being attained for extremely different parameterizations for φ resp. f (resp. n), α, β and henceforth newly s. For this purpose, in the represented system, the level of the maximum of the resulting left and right channel is normalized, so that this level is not influenced by the optimization of the parameters.

It makes sense, for example, for the level control for the maximum of the left signal L and of the right signal R to initially be uniformly confined for example to 0 dB by means of a first logic element.

It also makes sense if—for extremely different parameterizations for φ resp. f (resp. n), α, β and henceforth newly s—criteria which are dependent on <x(t), y(t)> or |<x(t), y(t)>| are used for the stipulation. For this purpose, according to the invention, a corresponding range of values is normalized, so as to constitute a criterion for the optimization of the parameters.

x(t) and y(t) are mapped within the unit circle of the complex number plane. The function f*[x(t)]+g*[y(t)] can now be analyzed in more detail in order to draw conclusions concerning the quality of the respective output signal from a device according to WO/2009/138205 or EP1850639, for example. Any decorrelation between the two signals f*[x(t)] and g*[y(t)] is in this case equivalent to a deflection on the real axis when analyzing the function f*[x(t)]+g*[y(t)].

The stereo decoder is therefore optimized according to said criterion for example for |Re{f*[x(t)]+g*[y(t)]}| and for |Im{f*[x(t)]+g*[y(t)]}|, namely

Re²{f*[x(t]+g*[y(t)]}*1/a²+Im²{f*[x(t]+g*[y(t)]}≦1,

where 0≦a≦1 stipulates the desired definition range.

This method has proven itself to be particularly advantageous, since a single parameter, namely a, takes optimum account of, in particular, the different nature of the output signals from a device or a method according to WO/2009/138205 or EP1850639. The parameter may preferably be dependent on the type of the audio signal, for example in order to process speech or music differently on a manual or automatic basis. In the case of speech, unlike music recordings, the definition range determined by the parameter a preferably needs to be restricted significantly due to disturbing artifacts such as high frequency sidetones during the articulation.

In addition, given the limitation to a single parameter a, any optimum function range can be chosen for f*[x(t)]+g*[y(t)] based on the unit circle resp. the imaginary axis.

If the signals x(t), y(t) do not satisfy the aforementioned conditions, the invention involves optimization being carried out by re-determining the parameters φ or f (resp. n) or α or β or newly s—according to an iterative procedure that is matched with the function values x[t(φ, f, α, β, s)] and y[t(φ, f, α, β, s)] resp. x[t(φ, n, α, β, s)] and y[t(β, n, α, β, s)]—whilst executing steps described so far until x(t) and y(t) meet the aforementioned conditions.

In a further step, the relief of the function f*[x(t)]+g*[y(t)] for example is now analyzed for the purpose of maximizing the function values thereof. It is possible to show that this procedure is equivalent to the maximization of

$${\int }_{- T}^{T} \vert {f}^{*} [ x ( t ) ] + {g}^{*} [ y ( t ) ] \vert d t \qquad ( 6 B )$$

this expression, for its part, remains less than or equal to the value of

$${\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t . \qquad ( 7 aB )$$

In this case too, the user is provided with a tool insofar as he has a free choice of the limit value R* (or the deviation Δ defined by the inequality (8aB), see below) for this maximization within the context of (8aB). Overall, the following condition must be met for the total number of possible signal variants xⱼ(t), yⱼ(t):

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * sin 2 arg \{ {f}^{*} [ x ( t ) ] + {g}^{*} [ y ( t ) ] \} ] \} d t \qquad ( 8 aB )$$

R* and Δ are directly related to the loudness of the output signal that is to be attained (i.e. to those parameters which the listener also takes as a basis for assessing the validity of a stereophonic mapping).

If the neighborhood of the limit value R*, defined by Δ, or the maximum of all possible integrated reliefs is not reached, optimization in terms of the limit value R* and the deviation Δ or in terms of the aforementioned maximum—in accordance with an iterative procedure that is matched with the function values x[t(φ, f, α, β, s)] and y[t(φ, f, α, β, s)] resp. x[t(φ, n, α, β, s)] and y[t(φ, n, α, β, s)]—involves new parameters φ resp. f resp. α resp. β resp. newly s being determined, and all steps described so far being executed until signals x(t), y(t) resp. parameters φ resp. λ resp. ρ resp. f (resp. n) resp. α resp. β resp. newly s result, which correspond to optimum stereophonization.

With an appropriate choice of the degree of correlation r, of the parameter a—stipulating the desired respective definition range—and of the limit value R* and also deviation Δ thereof, it is possible to configure optimum systems for the respective area of application (for example speech or music reproduction) for the respective nature of the input signals.

On the basis of the algebraic invariants presented in PCT/EP2011/063322, see below, it is possible, as part of the invention, to define a new weighting as follows:

For this purpose, a first optimization according to WO2011/009650, FIG. 15D, 2B, 3B to 5B, is performed on a signal section of the length t₁. The outputs of FIG. 5B are connected for example to a module 6001 according to FIG. 16D and the invariants (constituted in the intersection points ξₕ₁ of the sum of the complex transfer functions f*[x(t₁)]=[x(t₁)/√ 2̅]*(−1+i) and g*[y(t₁)]=[y(t₁)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₁ with the total number k₁ are stored in a memory (“stack”) valid for all further described operation sequences; the mean value

$${ξ}_{1}^{∘} := ( {\sum }_{{h}_{1} = 1}^{{k}_{1}} {ξ}_{h 1} ) / {k}_{1}$$

is likewise calculated. The latter is stored together with the parameterization φ₁, f₁ (resp. n₁), α₁, β₁ and henceforth newly s₁, determined by means of said first optimization, in a further dictionary valid for all further described operation sequences.

According to the function command 6004, in a second step a second optimization according to WO2011/009650, FIG. 15D, 2B, 3B to 5B is then performed on a signal section t₂ of any length. The outputs of FIG. 5B are in turn connected to the module 6001 of FIG. 16D and the invariants (constituted in the intersection points ξₕ₂ of the sum of the complex transfer functions f*[x(t₂)]=[x(t₂)/√ 2̅]*(−1+i) and g*[y(t₂)]=[y(t₂)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₂ from the total number k₂ are stored in a memory (“stack”) valid for all further described operation sequences; the mean value

$${ξ}_{2}^{∘} := ( {\sum }_{{h}_{2} = 1}^{{k}_{2}} {ξ}_{h 2} ) / {k}_{2}$$

is likewise calculated. The latter is in turn added together with the parameterization φ₂, f₂ (resp. n₂), α₂, β₂ and henceforth newly s₂, determined by means of said second optimization, to the first mean value ξ^{o}₁ as well as its parameterization φ₁, f₁ (resp. n₁), α₁, β₁, s₁ in the dictionary valid for all further described operation sequences. Since the memory (“stack”) now contains more than one mean value, the module 6002 of FIG. 16D is then activated.

The latter calculates the mean value ξ*₂ of all intersection points ξₕ₁, ξₕ₂ stored in the stack:

$${ξ}_{2}^{*} := ( {\sum }_{{h}_{1} = 1}^{{k}_{1}} {ξ}_{h 1} + {\sum }_{{h}_{2} = 1}^{{k}_{2}} {ξ}_{h 2} ) / ( {k}_{1} + {k}_{2} )$$

and selects from the dictionary among the mean values ξ^{o}₁, ξ^{o}₂ with their associated parameterization the mean value closest to ξ*₂. If this is the case for both mean values ξ^{o}₁, ξ^{o}₂, ξ^{o}₁ resp. the parameterization φ₁, f₁ (resp. n₁), α₁, β₁, s₁ is selected from the dictionary.

The mean value selected from the dictionary is then transmitted together with ξ*₂ to the module 6003. The latter verifies whether the mean value selected by the module 6002 is within the interval [−σ+ξ*₂, ξ*₂+σ], where σ>0 represents the standard deviation, freely selectable by the user, of the Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)}

If the mean value selected by the module 6002 of FIG. 16D is within the interval [−σ+ξ*₂, ξ*₂+σ], the parameterization selected by the module 6002 according to 6010 in the arrangement of FIG. 6D resp. FIG. 15D (which shows again for the sake of clarity the amplifier 717 and the MS matrix, wherein both of which are to be passed through only once) resp. the outputs 6006 and 6007 of FIG. 15D are activated, likewise the outputs 6008 and 6009 of FIG. 2B. The output 6006 runs into the input 6006 of FIG. 16D, the output 6007 runs into the input 6007 of FIG. 16D, the output 6008 runs into the input 6008 of FIG. 16D and the output 6009 runs into the input 6009 of FIG. 16D. Reference 6006 of FIG. 16D directly represents the output signal x(t) from the module 6003 of FIG. 16D, reference 6007 of FIG. 16D directly represents the output signal y(t) from the module 6003 of FIG. 16D, 6008 of FIG. 16D directly represents the output signal Re f*[x(t)]+g*[y(t)] from the module 6003 of FIG. 16D, 6009 of FIG. 16D directly represents the output signal Im f*[x(t)]+g*[y(t)] from the module 6003 of FIG. 16D. These signals, in the signal processing described above, are to be treated as if they represented the output signals of FIG. 5B, which with FIG. 16D then constitutes, in this example of application, an inseparable unit.

If the mean value selected by the module 6002 is outside the interval [−σ+ξ*₂, ξ*₂+σ], in a q^{th} step a q^{th} optimization is performed according to the extention, described here, of WO2011/009650, FIG. 15D, 2B, 3B to 5B on a signal section t_{q} of any length. The outputs of FIG. 5B are in turn connected to the module 6001 of FIG. 16D and the invariants (constituted at the intersection points ξ_{hq} of the sum of the complex transfer functions f*[x(t_{q})]=[x(t_{q})/√ 2̅]*(−1+i) and g*[y(t_{q})]=[y(t_{q})/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξ_{hq} with the total number k_{q} are added to ξₕ₁, ξₕ₂, . . . , ξ_{hq-1} in a memory (“stack”) valid for all further described operation sequences; the mean value

$${ξ}_{q}^{∘} := ( {\sum }_{{h}_{q} = 1}^{{k}_{q}} {ξ}_{hq} ) / {k}_{q}$$

is likewise calculated. The latter is in turn added together with the parameterization φ_{q}, f_{q} (resp. n₁), α_{q}, β_{q}, and henceforth newly s_{q} determined by means of said q^{th} optimization, to the first mean values ξ^{o}₁, ξ^{o}₁, . . . , ξ^{o}_{q-1} as well as to their parameterizations φ₁, f₁ (resp. n₁), α₁, β₁, s₁; φ₂, f₂ (resp. n₂), α₂, β₂, s₂; . . . ; φ_{q-1}, f_{q-1} (resp. n_{q-1}), α_{q-1}, β_{q-1}, s_{q-1}, in the dictionary valid for all further described operation sequences. Since the memory (“stack”) now contains more than one mean value, the module 6002 of FIG. 16D is then activated.

The latter calculates the mean value ξ*_{q} of all intersection points ξₕ₁, ξₕ₂, . . . , ξ_{hq} stored in the stack:

$${ξ}_{q}^{*} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1}^{{k}_{q}} {ξ}_{hq} ) / ( {k}_{1} + {k}_{2} + … {k}_{q} )$$

and selects from the dictionary among the mean values ξ^{o}₁, ξ^{o}₂, . . . , ξ^{o}_{q} with their associated parameterization φ, f (resp. n), α, β, and henceforth newly s, the mean value closest to ξ*_{q}. If this is the case for different parameterizations, the parameterization that appears most often in the dictionary is selected. If several parameterizations appear the same number of times, the one that exhibits the widest scattering in the dictionary is selected, i.e. the one for which the difference d−c is maximum, where d represents the last and c the first index number of the optimization steps respectively undergone. If this too applies to several parameterizations, the first one that appears is selected. If two mean values from ξ^{o}₁, ξ^{o}₂, . . . , ξ^{o}_{q} are closest to ξ*_{q}, insofar as in a q−1^{th} step one of the two mean values resp. their associated parameterization is selected from the dictionary, the very same one resp. its associated parameterization is retained. The mean value selected from the dictionary is then transmitted together with ξ*_{q} to the module 6003 of FIG. 16D. The latter verifies whether the mean value selected by the module 6002 of FIG. 16D is within the interval [−σ+ξ*_{q}, ξ*_{q}+σ], where σ>0 represents the standard deviation, freely selectable by the user at the beginning of the entire process illustrated here, of the Gauss distribution fictitiously set as zero in ξ*_{q}:

f^{∪}(z_{q}*)=(1/(√(2π)*σ))e^{-(1/2)*(((z}^{_{q}}^{*-ξ*}^{_{q}}^{)̂2)/σ̂2)}

If the mean value selected by the module 6002 of FIG. 16D is within the interval [−σ+ξ*_{q}, ξ*_{q}+σ], the parameterization selected by the module 6002 according to 6010 in the arrangement of FIG. 6D resp. FIG. 15D resp. the outputs 6006 and 6007 of FIG. 15D are activated, likewise the outputs 6008 and 6009 of FIG. 2B as well as the corresponding inputs and outputs of FIG. 16D. Reference 6006 of FIG. 16D again directly represents the output signal x(t) from the module 6003 of FIG. 16D, reference 6007 of FIG. 16D directly represents the output signal y(t) from the module 6003 of FIG. 16D, 6008 of FIG. 16D directly represents the output signal Re f*[x(t)]+g*[y(t)] from the module 6003 of FIG. 16D, 6009 of FIG. 16D directly represents the output signal Im f*[x(t)]+g*[y(t)] from the module 6003 of FIG. 16D. These signals, in the signal processing described further below, are again to be treated as if they represented the output signals of FIG. 5B, which with FIG. 16D constitutes, in the present example of application, an inseparable unit.

If the mean value selected by the module 6002 of FIG. 16D is outside the interval [−σ+ξ*_{q}, ξ*_{q}+σ], in a q+1^{th} step a q+1^{th} optimization is performed in the same form as for the q^{th} step and for the q^{th} optimization. The process is repeated as long as necessary until one element of the dictionary fulfills the above requirements or a maximum number of allowed optimization steps has been reached.

FIG. 5C shows the convergence behavior of the just established weighting function for three optimization steps: 5001 represents in this case the first mean value ξ^{o}₁, 5002 the second mean value ξ^{o}₂, 5003 the first Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)},

where σ>0 represents the standard deviation, freely selectable by the user at the beginning of the entire process illustrated here, 5004 the third mean value ξ^{o}₃, which remains within the inflexion points defined by σ of the Gauss distribution 5005 of same standard deviation, fictitiously set as zero in ξ*₃, and thus fulfills the convergence criterion.

In each case, the result is a parameterization φ, f (resp. n), α, β and henceforth newly s which supplies a pseudostereophonic function that on average is optimum in relation to all algebraic invariants.

As the number of signal sections increases, the distribution of the intersection points ξ of the algebraic invariants on the half-plane respectively analyzed with the complex number plane approximates the Gauss distribution. The smaller the chosen standard deviation σ is selected, the closer to ideal the resulting parameterization will be. However, as an only finite number of signal sections are available, σ should not be chosen too small.

Nevertheless, the method presented in FIG. 16D in terms of its convergence is considerably faster for sufficiently long signal sections than mentioned simulation models, since algebraic invariants are available for the first time to serve as valid “points of reference” for a weighting of already determined parameterizations.

If in an inventive arrangement according to

EP1850639 or WO2009/138205 or WO2011/009649 or WO2011/009650 or CH01264/10 resp. PCT/EP2011/063322 only the special case φ=0 (for EP1850639, the parameters in the figures below are to be set as follows: f(φ)=f(α)=f(β)=1, sin φ=0, sin α=sin β=1) or the special case L_{α}=L_{β} (for WO2009/138205) or L_{A}=L_{B} (for EP1850639) are analyzed, this will yield the simplified circuits of the form of FIG. 17D resp. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D. In the case of EP1850639, the pseudostereophonic signal thus depends in terms of the time differences only on one constant (√5−1)/2 resp. on s resp. in terms of the amplifications of constants resp. of the attenuation λ resp. ρ (see below), in the case of WO2009/138205 it depends, in addition to newly on s, on L_{α}=L_{β} resp. in terms of the amplifications on P_{α} resp. P_{β} or also P_{M}′ resp. P_{β}′ or also P_{M}″ resp. P′_{α} (see WO2009/138205) resp. of the attenuation λ resp. ρ or the attenuation factors 1/λ or 1/τ resp. λ′ (see below).

For an inventive arrangement according to EP1850639 or WO2009/138205 or WO2011/009649 or WO2011/009650 or PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also the just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, alternative systems to WO2011/009649 or WO2011/009650 or CH01264/10 resp. PCT/EP2011/063322 for determining the optimum parameters φ resp. f (resp. n) resp. α resp. β resp. λ resp. ρ resp. s resp. the optimum time delay resp. combinations of these parameters can be obtained. If for example one sets φ=0 and thus α=β, and if furthermore one assumes λ=ρ, for given directional pattern f optimum values for α, β and λ can be determined as follows: define a weighting that ensures values for 0≦λ≦1 as low as possible (since the virtualization of several microphones should appear natural) and ensure with the same weighting likewise for delay times that are as short as possible (in order to avoid artifacts). Both criteria are mutually exclusive: low values of λ foster great fictitious opening angles α and β; and conversely short delay times correspond to small fictitious opening angles α and β.

Thus, a target correlation k, previously stipulated or chosen at will by the user, a weighting p previously stipulated or chosen at will by the user (for example 0≦p≦10) can be introduced for the size of the fictitious opening angles α and β as well as a variable g(α) which overall balance this antagonistic behavior. Thanks to the high stability of the total system, the fictitious opening angles α=β can for example be analyzed in steps of 5° each, which for an algorithm implemented accordingly results in considerably reduced computation times.

g(α) can be defined on the basis of the time differences L_{α}=L_{β} (see above) for example as follows:

g(α):=2̂(−20*(L_{α}+L_{β}))

A corresponding weighting function h(α) depending on α could then be stipulated for example as follows:

h(α):=λ(α)̂p*g(α)̂(10−p),

where λ(α) corresponds to the respective value determined for example according to the logic element 125 resp. to the feedback 126 of FIG. 1B and which supplies a stereo signal with the target correlation k for a specific fictitious opening angle α=β.

For p=0, it is exclusively g(α) that has an influence on the subsequent calculation of the optimum fictitious opening angle αₒₚₜ=βₒₚₜ determined on the basis of the weight p previously stipulated or chosen at will by the user; for p=10, it is exclusively λ(α) that has the same influence.

The optimum opening angles αₒₚₜ and βₒₚₜ are then calculated in the present example according to the following formula, wherein in the present practical example the integration is over the interval [5°; 90°] or in the radiant over the interval [π/36; λ/2] as follows (wherein for practical considerations the integrals mentioned below can be determined as sums calculated in 5° steps):

$${α}_{opt} = ( {\int }_{π / 36}^{π / 2} α * h ( α ) d α * π / 36 ) / {\int }_{π / 36}^{π / 2} h ( α ) d α$$

N.B. Due to the symmetry of α and β and because of the fact that φ is equal to 0, h(α) can be represented exclusively as a function of α.

Finally, for αₒₚₜ=βₒₚₜ, which can also take on an intermediate value, the value λ(αₒₚₜ) is again determined for example according to the logic element 125 resp. to the feedback 126 of FIG. 1B and which supplies a stereo signal with the exact target correlation k for αₒₚₜ=βₒₚₜ.

The same principle (which allows a host of possible defined weightings and thus cannot be represented comprehensively) can be extended with L_{α} and L_{β} resp. with L_{α}′ and L_{β}′ also to the parameter s, which determines in the overall system the optimum spaciality, and furthermore to other parameters in connection with an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or auch FIG. 21D resp. FIG. 23D or simplified FIG. 24D or auch FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D.

The interaction of the parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, the attenuations λ or else ρ for forming the resulting stereo signal in the case of WO2009/138205 resp. the angle φ enclosed by the main axis and the sound source as well as the attenuation λ or else ρ for forming the resulting stereo signal in the case of EP1850639 or also the parameters of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also the just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D and altogether of the time parameter s overall cause a spatial impression that on the one hand can be matched to the spatial impression (the acoustic parameters) of an existing stereophonic or pseudostereophonic signal, and on the other hand is to be stipulated with accuracy precisely on the basis of the spatial impression (the acoustic parameters). For example, this spatial impression depends on the 1^{st} resp. 2^{nd} main reflection resp. on the diffuse sound. In particular the parameter s is given in this context a vital importance.

Inverse problems as well as their solutions are known from the theory of mathematical filters, in particular in connection with so-called wavelets. These are systems that despite the noise of a measuring system (for example of an optical camera or of a magnetic resonance system for generating images) manage to obtain a high-resolution signal. The resulting measured signal can be written as follows:

Y[q]=Uf[q]+W[q]

The operator U in this case contains the specific transfer function of the measuring system, f represents our high-resolution signal, W the noise of the measured signal, q the time. If the number of available measurements is considerably below the dimension n of the analyzed complex space (whose element is the high-resolution signal to be obtained), this is called an ill-posed inverse problem.

Main reflections can be derived from the base signal, which in our case represents the input signal to be stereophonized. Interestingly, the theory of inverse problems, with a few elements changed, can be transposed to the problem mentioned above of determining the spatial parameters of a stereophonic function; in this case (as the base signal is known), it is not a new ill-posed inverse problem and therefore knows unambiguous solutions.

The above equation is first reframed in the equation:

Y[q]=UY[q−t*]+W[q]+D[q]

where Y[q] represents the resulting stereo signal at the point in time q, Y[q−t*] the same stereo signal at the point in time q−t*, t*≧0, wherein t* is the delay with which the 1^{st} main reflection occurs, W[q] is the signal without reverberation and D[q] is the reverberation without the 1^{st} main reflection, which can incidentally be easily estimated statistically. The operator U henceforth contains the specific transfer functions for the stereo signal Y[q−t*], so that the latter exhibits the acoustic properties of the 1^{st} main reflection.

This decomposition proves optimal, since the listener judges the acoustic parameters first and foremost on the basis of the 1^{st} main reflection.

Two application cases can now be distinguished:

The first case is an optimization problem wherein a pseudostereophonic signal Y*[q] is to be newly generated on the basis of the acoustic parameters of an already existing stereo signal Y[q]. In a first step, the specific t* is sought that maximises our “high-resolution” signal, in fact the 1^{st} main reflection of the signal Y[q], and subsequently that parameterization of f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, as well as the attenuations λ or else ρ for forming the resulting stereo signal in the case of WO2009/138205 resp. the angle φ enclosed by the main axis and the sound source as well as the attenuation λ or else ρ for forming the resulting stereo signal in the case of EP1850639 or also the parameterization of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also the just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D as overall the time coefficient s optimized according to the following consideration:

Y*[q]=U*Y*[q−t*]+W*[q]+D*[q]

represents our second unambiguously solvable inverse problem for the pseudostereophonic signal Y*[q] to be formed, wherein U* resp. D* is directly dependent functionally on said parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, as well as the attenuations λ or else ρ or the time parameter s for forming the resulting stereo signal in the case of WO2009/138205 resp. the angle φ enclosed by the main axis and the sound source as well as the attenuation λ or else ρ or the time parameter s for forming the resulting stereo signal in the case of EP1850639 or also the parameters of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A bzw. FIG. 14A resp. FIG. 13D resp. FIG. 14D resp. FIG. E1 or auch FIG. E2 or also the just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D. If one now substitutes in the original equation

Y[q]=UY[q−t*]+W[q]+D[q]

U by U* resp. D by D*, the sought optimized parameters parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, as well as the attenuations λ or else ρ or the time parameter s for forming the resulting stereo signal in the case of WO2009/138205 resp. the angle φ enclosed by the main axis and the sound source as well as the attenuation λ or else ρ or the time parameter s for forming the resulting stereo signal in the case of EP1850639 or also the parameters of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D bzw. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D can be determined ideally or approximately on the basis of the following equation:

Y[q]−U*Y[q−t*]−W[q]−D*[q]=0.

In the second case, no stereophonic signal Y[q] is available for optimizing the pseudostereophonic signal Y*[q]. Rather, the user is to be provided with a tool for directly optimizing the parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, as well as the attenuations λ or else ρ or the time parameter s for forming the resulting stereo signal in the case of WO2009/138205 resp. the angle φ enclosed by the main axis and the sound source as well as the attenuation λ or else ρ or the time parameter s for forming the resulting stereo signal in the case of EP1850639 or also the parameters of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, thus de facto to directly influence the spatial parameters of the pseudostereophonic mapping. This occurs by directly influencing the parameters t* resp. U* resp. D*, that are optimized according to the following equation:

Y*[q]−U*Y*[q−t*]−W*[q]−D*[q]=0

until an ideal or approximately satisfactory result is achieved. In particular, W*[q] can be expressed directly by the monophonic base signal to be rendered stereophonic.

If U* resp. D* are to be matched with an existing dictionary of available operators U bzw. D, we have again the described solvable first case of our optimization problem with the equation

Y*[q]−UY*[q−t*]−W*[q]−D[q]=0

A further criterion for the first case of the optimization problem, wherein a pseudostereophonic signal Y*[q] is to be newly formed on the basis of the acoustic parameters of an already existing signal Y[q], is supplied by the Spatial Audio Object Coding (SAOC) belonging to the state of the art. In this case, in addition to the spatial operators U,D bzw. U*, D*, the sinusoidal models of Y*[q] and Y[q] are compared, i.e. those spectral components that are responsible within SAOC for localization. In particular the deviation of these sinusoidal models from one another can be quantized. Those parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β, as well as the attenuations λ or else ρ or the time parameter s for forming the resulting stereo signal in the case of WO2009/138205 resp. the angle φ enclosed by the main axis and the sound source as well as the attenuation λ or else ρ or the time parameter s for forming the resulting stereo signal in the case of EP1850639 or also the parameters of the arrangements according to WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D bzw. FIG. 27D or simplified FIG. 28D resp. FIG. E9 or also FIG. E10 or simplified FIG. E11 resp. FIG. E12 bzw. FIG. E13 or simplified FIG. E14 resp. FIG. E15 or also FIG. E16 or simplified FIG. E17 resp. FIG. 18D resp. FIG. 22D resp. FIG. 26D are then selected for which on the one hand this deviation is minimal and for which on the other hand the following equation

Y[q]−U*Y[q−t*]−W[q]−D*[q]=0

is ideally or approximately solved.

In the prior art, so-called all-pass filters can be used for eliminating the mid sound sources amplified by 3 dB in a mono signal as well as for varying a stereophonic or pseudostereophonic sound image, by being connected downstream to the left and/or right channel of a stereophonic or pseudostereophonic output signal. In principle, see for example U.S. Pat. No. 5,671,287 (Gerzon), the output signals of such all-pass filters can be combined to new stereophonic or pseudostereophonic signals for example by means of addition or subtraction. Their use on stereophonic resp. pseudostereophonic signals with more than two channels is likewise possible. Such all-pass filters, which are described in literature as all-pass filters of first, second or n^{th} order and whose overall application on monophonic, stereophonic or pseudostereophonic signals is also state of the art, work outstandingly well with our systems described herein resp. cited herein. They can be used not only for post-processing of the stereophonic or pseudostereophonic signals obtained on the basis of own circuit schemata described herein resp. cited herein, but moreover enable their integration directly and in a versatile manner into the described or cited own circuit schemata and optimization processes, this being likewise according to the state of the art. The circuit principle of an all-pass filter of the first order is represented by way of example in FIG. 1F, the circuit principle of an all-pass filter of the second order is represented by way of example in FIG. 2F.

Similarly, phase regulators can be used that additionally enable the phase difference of the stereophonic or pseudostereophonic signal to be adjusted. Such phase regulators are also suitable not only for post-processing of the stereophonic or pseudostereophonic signals obtained on the basis of own circuit schemata described herein resp. cited herein, but moreover enable their integration directly and in a versatile manner into the described or cited own circuit schemata and optimization processes, this being likewise according to the state of the art. Their use on stereophonic resp. pseudostereophonic signals with more than two channels is likewise possible. The basic circuit principle of a phase regulator, here represented in a simplified manner for sinusoidal signals, is represented by way of example in FIG. 3F.

The simplest example of numerous possibilities is represented for example by FIG. 4F, wherein an all-pass filter is connected downstream for example in the left resp. in the right channel of a pseudostereophonic output signal of an inventive arrangement according to EP1850639 or WO2009/138205 or WO2011/009649 or WO2011/009650 or PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D bzw. FIG. 27D or simplified FIG. 28D resp. FIG. E9 or also FIG. E10 or simplified FIG. E11 resp. FIG. E12 bzw. FIG. E13 or simplified FIG. E14 resp. FIG. E15 or also FIG. E16 or simplified FIG. E17 resp. FIG. 18D resp. FIG. 22D resp. FIG. 26D. Whilst the pseudostereophonic output signal of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D bzw. FIG. 27D or simplified FIG. 28D resp. FIG. E9 or also FIG. E10 or simplified FIG. E11 resp. FIG. E12 bzw. FIG. E13 or simplified FIG. E14 resp. FIG. E15 or also FIG. E16 or simplified FIG. E17 resp. FIG. 18D resp. FIG. 22D resp. FIG. 26D exhibits a good emphasis of the mid sound sources, for example FIG. 4F provides for a corresponding dispersion with good source localization.

The simplest example of numerous possibilities for the use of phase shifters is represented for example by FIG. 5F, wherein a phase shifter is connected downstream for example in the left channel of the pseudostereophonic output signal of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 resp. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D bzw. FIG. 27D or simplified FIG. 28D resp. FIG. E9 or also FIG. E10 or simplified FIG. E11 resp. FIG. E12 bzw. FIG. E13 or simplified FIG. E14 resp. FIG. E15 or also FIG. E16 or simplified FIG. E17 resp. FIG. 18D resp. FIG. 22D resp. FIG. 26D and thus provides for an adjustable dispersion.

### SHORT DESCRIPTION OF THE FIGURES

Various embodiments of the present invention are described hereinafter by way of example, with reference being made to the following drawings:

FIG. 1A shows the circuit principle of a known panoramic potentiometer.

FIG. 1B shows an example of a circuit for two logic elements for normalizing the level and for normalizing the degree of correlation of the output signals from a stereo decoder (for example a stereo decoder according to WO2009/138205 or EP1850639), wherein the input signal M and S can (before passing through an amplifier upstream to the MS matrix) optionally be fed to a circuit according to FIG. 7B, which is optionally also connected downstream to FIG. 10B.

FIG. 1C shows the apolarity constraint for the functions S, S′ and Σ′.

FIG. 1D shows a circuit according to EP1850639 which according to the invention has been extended by the parameter s.

FIG. 1F shows the circuit schema of a prior art all-pass filter of first order.

FIG. 2A shows the attenuation curve for the left and right channels of a panoramic potentiometer without an extended stereo width range and corresponding mapping angles.

FIG. 2B shows an example of a circuit which maps given signals x(t), y(t), by using the transfer functions f*[x(t)] and g*[y(t)], on the complex number plane, resp. ascertains the argument of the sum thereof f*[x(t)]+g*[y(t)].

FIG. 2C shows the functions S, S′ and Σ′ for the Cartesian coordinate system x₁=u₁, x₂=u₂, x₃=u₃ from the perspective of the first quadrant of the corresponding complex number plane.

FIG. 2D shows a first circuit according to WO2009/138205 resp. WO2011/009649 which according to the invention has been extended by the parameter s.

FIG. 2F shows the circuit schema of a prior art all-pass filter of second order.

FIG. 3A shows a first embodiment of a device or of a method according to WO2011/009649, wherein the left channel L′ resp. right channel R′ resulting from the stereo decoding are each fed to a panoramic potentiometer for collective buses L and R.

FIG. 3B shows an example of a circuit for selecting the definition range by using the parameter a.

FIG. 3C shows the functions S, S′ and Σ′ for the Cartesian coordinate system x₁=u₁, x₂=u₂, x₃=u₃ likewise from the perspective of the first quadrant of the corresponding complex number plane.

FIG. 3D shows a second circuit according to WO2009/138205 resp. WO2011/009649 which according to the invention has been extended by the parameter s.

FIG. 3F shows the circuit schema of a prior art phase shifter.

FIG. 4A shows a second embodiment of a device or of a method according to WO2011/009649, wherein the left channel L′ resp. the right channel R′ resulting from the stereo decoding are each fed to a panoramic potentiometer for collective buses L and R.

FIG. 4B shows an example of a circuit for a third logic element which checks the signals, which are generated in FIG. 1B and which are mapped on the complex number plane as shown in FIG. 2B, in terms of the admissible definition range, defined in a new fashion according to FIG. 3B by the parameter a, according to the constraint Re²{f*[x(t]+g*[y(t)]}*1/a²+Im²{f*[x(t]+g*[y(t)]}≦1.

FIG. 4C shows the functions S, S′ and Σ′ for the Cartesian coordinate system x₁=u₁, x₂=u₂, x₃=u₃ from the perspective of the fourth quadrant of the corresponding complex number plane.

FIG. 4D shows a third circuit according to WO2009/138205 resp. WO2011/009649 which according to the invention has been extended by the parameter s.

FIG. 4F shows a simple example of the downstream connection of an all-pass filter each in the left resp. in the right channel of a stereophonic or pseudostereophonic output signal of an inventive arrangement according to EP1850639 or WO2009/138205 or WO2011/009649 or WO2011/009650 or CH01264/10 resp. PCT/EP2011/063322.

FIG. 5A shows a third embodiment of a device or of a method according to WO2011/009649, wherein the left channel L′ resp. right channel R′ resulting from the stereo decoding are each fed to a panoramic potentiometer for collective buses L and R.

FIG. 5B shows an example of a circuit for a fourth logic element which finally analyzes the relief of the function f*[x(t)]+g*[y(t)] for the purpose of maximizing the function values thereof, wherein the user has a free choice of the limit value R* defined by the inequality (8aB) (resp. by the deviation Δ likewise defined by the inequality (8aB)) for this maximization.

FIG. 5C shows the convergence behavior of a weighting function, which here optimizes the parameters φ, f (resp. n), α, β for example on the basis of the mean values of the inter-section points in the 1^{st} or also 3^{rd} quadrants of three pseudostereophonic signal sections of the same length mapped on the complex number plane with the plane spanned by the vectors (1, 1, −2) and (1, 1, 1) or also (−1, −1, 2) and (1, 1, 1).

FIG. 5D shows a first variant embodiment of the first circuit according to WO2009/138205 resp. WO2011/009649 which according to the invention has been extended by the parameter s.

FIG. 5F shows a simple example of the downstream connection of a phase shifter in the left channel of a stereophonic or pseudostereophonic output signal of an inventive arrangement according to EP1850639 or WO2009/138205 or WO2011/009649 or WO2011/009650 or CH01264/10 resp. PCT/EP2011/063322. The right input signal is retained without change as output signal. This results in a modified stereophonic or pseudostereophonic signal.

FIG. 6A shows a fourth embodiment of a device or of a method according to WO2011/009649 with a circuit that is equivalent to FIG. 3A having a slightly modified MS matrix, which renders superfluous a direct downstream connection of panoramic potentiometers.

FIG. 6B shows an input circuit for an already existing stereo signal prior to transfer to a circuit as shown in FIG. 10B for determining the localization of the signal.

FIG. 6C shows an example of the circuit described below for optimizing pseudostereophonic signals on the basis of algebraic invariants, which can be directly connected downstream of FIG. 5B, and with which it then constitutes in this example an inseparable unit. In this case, the outputs of FIG. 6C within the entire circuit schema are to be treated in such a way as if they were those of FIG. 5B. The circuit of FIG. 6C has the effect that the elements connected upstream thereto are now passed through for different sections of audio signals. The result is an optimized parameterization φ, f, α, β on the basis of the mean values of the intersection points in the 1^{st} or also 3^{rd} quadrant of these signal sections mapped on the complex number plane with the plane spanned by the vectors (1, 1, −2) and (1, 1, 1) or also (−1, −1, 2) and (1, 1, 1).

FIG. 6D shows a second variant embodiment of the first circuit according to WO2009/138205 resp. WO2011/009649 which according to the invention has been extended by the parameter s.

FIG. 6F shows the principle of the coding of a five-channel signal according to Rec. ITU-R BS.775-1, which after being downmixed to the stereo 2/0 format is approximately identical to the (amplified) signal L, R, and after being downmixed to the mono 1/0 format is approximately identical to the (amplified) signal M.

FIG. 7A shows a circuit which is equivalent to FIG. 3A resp. FIG. 6A, provided that the relation λ=ρ applies for the inversely proportional attenuations λ and ρ of the panoramic potentiometers shown in FIG. 3A.

FIG. 7B shows a further example of a circuit for normalizing stereophonic or pseudostereophonic signals which, when connected downstream to FIG. 10B, is activated as soon as the parameter z is present as an input signal. In this case, the initial value of the gain factor λ corresponds to the final value of the gain factor λ in FIG. 1B when the parameter z is transferred.

FIG. 7C shows an example of a circuit which, on the basis of the determination of the mean square energy of the input signals s₁(tᵢ), s₂(tᵢ), . . . , s_{δ} (tᵢ) and of the definable weightings G₁, G₂, . . . G_{δ}, performs a normalization of these input signals and subsequently determines the invariants of a combination f̂(t) or of several combinations f₁̂(t), f₂̂(t), . . . , fₚ̂(t) of these input signals.

FIG. 7D shows a circuit equivalent to FIG. 4A resp. FIG. 13A, provided that the relation λ=ρ applies for the inversely proportional attenuations λ and ρ of the panoramic potentiometers shown in FIG. 4A, extended according to the invention by the parameter s.

FIG. 7F shows the principle of the coding of a five-channel signal according to Rec. ITU-R BS.775-1, which after being downmixed to the stereo 2/0 format does not correspond to the (amplified) signal L, R, however, after being downmixed to the mono 1/0 format is exactly identical to the (amplified) signal M.

FIG. 8A shows an enhanced circuit based on FIG. 7A for normalizing the level of the output signals from the stereo decoder.

FIG. 8B shows an example of a circuit which maps given signals x(t), y(t) on the complex number plane by using the transfer functions f*[x(t)] and g*[y(t)].

FIG. 8D shows a circuit equivalent to FIG. 5A resp. FIG. 14A, provided that the relation λ=ρ applies for the inversely proportional attenuations λ and ρ of the panoramic potentiometers shown in FIG. 5A, extended according to the invention by the parameter s.

FIG. 8F shows the principle of the coding of a five-channel signal according to Rec. ITU-R BS.775-1, which after being downmixed to the stereo 2/0 format is approximately identical to the (amplified) signal L, R, and after being downmixed to the mono 1/0 format is approximately identical to the (amplified) signal L+R.

FIG. 9A shows an example of a circuit which, as an enhancement to FIG. 8A, maps given signals x(t), y(t) as the sum of the transfer functions f*[x(t)]=[x(t)/√Σ2]*(−1+i) and g*[y(t)]=[y(t)/√Σ2]*(1+i) on the complex number plane.

FIG. 9B shows an example of a circuit for adjusting the image width of an audio signal.

FIG. 9D shows a circuit equivalent to FIG. 7D, based on the equations (3AA) and (4AA) hereafter and which according to the invention has been extended by the parameter s.

FIG. 9F shows the loudspeaker array for a five-channel signal according to Rec. ITU-R BS.775-1.

FIG. 10A shows the example of a circuit that, as an enhancement to FIG. 9A, stipulates the image width of a stereo signal.

FIG. 10B shows a circuit for determining the localization of the signal, whose inputs are connected with the outputs of FIG. 5B resp. with the outputs of FIG. 6B.

FIG. 10D shows a circuit equivalent to FIG. 7D, based on the equations (3AAA) and (4AAA) hereafter and which according to the invention has been extended by the parameter s.

FIG. 10F shows the standardized mix ratio of a downmix for a five-channel signal according to Rec. ITU-R BS.775-1.

FIG. 11A shows an example of an input circuit for an already existing stereo signal L^{o}, R^{o} prior to transfer to a circuit as shown in FIG. 12A (for determining the localization of the signal) which maps L^{o}, i.e. l(t), and R^{o}, i.e. r(t), as the sum of the transfer functions f*[l(t)]=[l(t)/√ 2̅]*(−1+i) and g*[r(t)]=[r(t)/√ 2̅]*(1+i) on the complex number plane.

FIG. 11D shows a circuit equivalent to FIG. 8D, based on the equations (3AA) and (4AA) hereafter and which according to the invention has been extended by the parameter s.

FIG. 11F shows the total possible parameter combinations for the parameter f (resp. n) which describe the directional pattern of the signal that is to be rendered stereophonic, the angle φ—to be ascertained manually or by metrology—enclosed by the main axis of the signal that is to be rendered stereophonic and the sound source, the fictitious left opening angle α and the fictitious right opening angle β.

FIG. 12A shows a circuit for determining the localization of the signal, whose inputs can be connected to the outputs of FIG. 10A resp. to the outputs of FIG. 11A.

FIG. 12D shows a circuit equivalent to FIG. 8D, based on the equations (3AAA) and (4AAA) hereafter and which according to the invention has been extended by the parameter s.

FIG. 13A shows a fifth embodiment of a device or of a method according to WO2011/009649 with a circuit that is equivalent to FIG. 4A having a slightly modified MS matrix, which renders superfluous a direct downstream connection of panoramic potentiometers.

FIG. 13D shows the circuit according to FIG. 13A extended according to the invention by the parameter s.

FIG. 14A shows a sixth embodiment of a device or of a method according to WO2011/009649 with a circuit that is equivalent to FIG. 5A having a slightly modified MS matrix, which renders superfluous a direct downstream connection of panoramic potentiometers.

FIG. 14D shows the circuit according to FIG. 14A extended according to the invention by the parameter s.

FIG. 15D shows the example, henceforth extended according to the invention by the parameter s, of a circuit for two logic elements for normalizing the level and for normalizing the degree of correlation of the output signals from a stereo decoder (for example a stereo decoder according to WO2009/138205 or EP1850639), wherein the input signal M and S can (before passing through an amplifier upstream to the MS matrix) optionally be fed to a circuit according to FIG. 7B, which is optionally also connected downstream to FIG. 10B.

FIG. 16D shows an example, henceforth extended according to the invention by the parameter s, of the circuit described below for optimizing pseudostereophonic signals on the basis of algebraic invariants, which can be directly connected downstream of FIG. 5B, and with which it then constitutes in this example an inseparable unit. In this case, the outputs of FIG. 16D within the entire circuit schema are to be treated in such a way as if they were those of FIG. 5B. The circuit of FIG. 16D has the effect that the elements connected upstream thereto are now passed through for different sections of audio signals. The result is an optimized parameterization φ, f, α, β, s on the basis of the mean values of the intersection points in the 1^{st} or also 3^{rd} quadrant of these signal sections mapped on the complex number plane with the plane spanned by the vectors (1, 1, −2) and (1, 1, 1) or also (−1, −1, 2) and (1, 1, 1).

FIG. 17D shows the first simplification, extended according to the invention by the parameter s, of a circuit according to WO2009/138205 for uniform time differences L′_{α}=L′_{β}.

FIG. 18D shows a further simplification, extended according to the invention by the parameter s, of a circuit according to WO2009/138205 for uniform time differences L′_{α}=L′_{β}.

FIG. 19D shows the simplified first variant embodiment, extended according to the invention by the parameter s, of the circuit of FIG. 6D according to WO2009/138205 resp. WO2011/009649 for uniform time differences L′_{α}=L′_{β}.

FIG. 20D shows the second variant embodiment, extended according to the invention by the parameter s and further simplified by integrating the parameter λ, of the circuit of FIG. 6D according to WO2009/138205 resp. WO2011/009649 for uniform time differences L′_{α}=L′_{β}.

FIG. 21D shows the second simplification, extended according to the invention by the parameter s, of the circuit according to WO2009/138205 for uniform time differences L′_{α}=L′_{β}. For EP1850639, the parameters are to be set as follows: f(φ)=f(α)=f(β)=1, sin φ=0, sin α=sin β=1.

FIG. 22D shows a further simplification, extended according to the invention by the parameter s, of the circuit according to WO2009/138205 for uniform time differences L′_{α}=L′_{β}. For EP1850639, the parameters are to be set as follows: f(φ)=f(α)=f(β)=1, sin φ=0, sin α=sin β=1.

FIG. 23D shows the simplified first variant embodiment, extended according to the invention by the parameter s, of the circuit of FIG. 3D according to WO2009/138205 resp. WO2011/009649 for uniform time differences L′_{α}=L′_{α}. For EP1850639, the parameters are to be set as follows: f(φ)=f(α)=f(β)=1, sin φ=0, sin α=sin β=1.

FIG. 24D shows the second variant embodiment, extended according to the invention by the parameter s and further simplified by integrating the parameter λ, of the circuit of FIG. 3D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. 25D shows the third simplification, extended according to the invention by the parameter s, of a circuit according to WO2009/138205 for uniform time differences L′_{α}=L′_{β}.

FIG. 26D shows a further simplification, extended according to the invention by the parameter s, of a circuit according to WO2009/138205 for uniform time differences L′_{α}=L′_{β}.

FIG. 27D shows the simplified first variant embodiment, extended according to the invention by the parameter s, of the circuit of FIG. 4D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. 28D shows the second variant embodiment, extended according to the invention by the parameter s and further simplified by integrating the parameter λ, of the circuit of FIG. 4D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

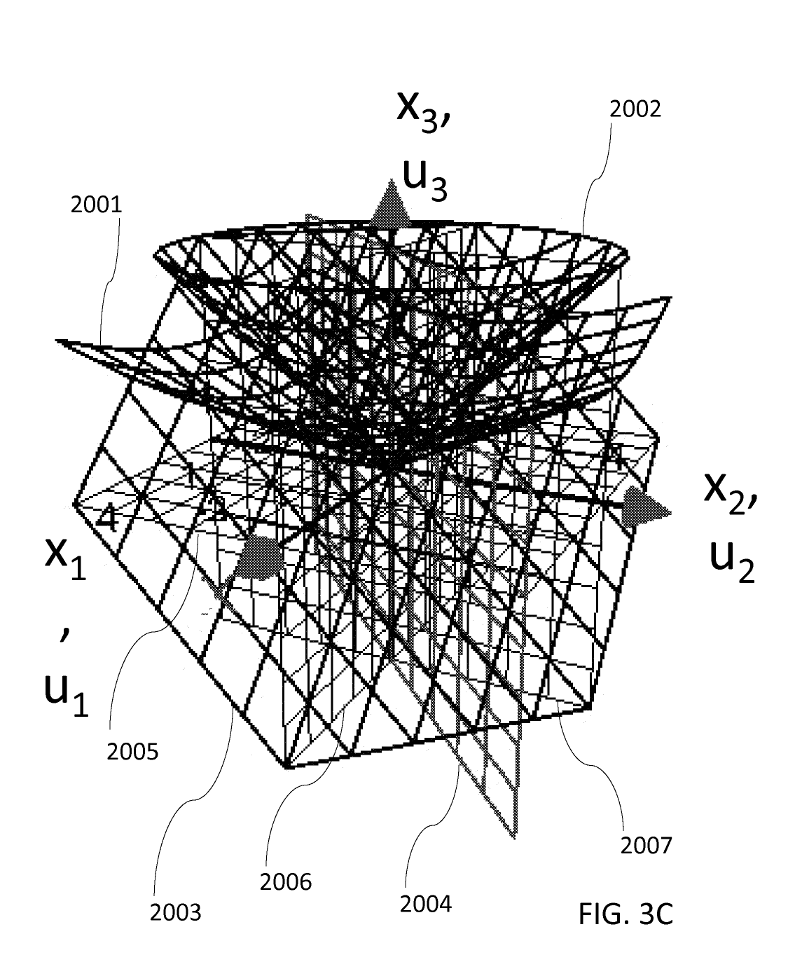

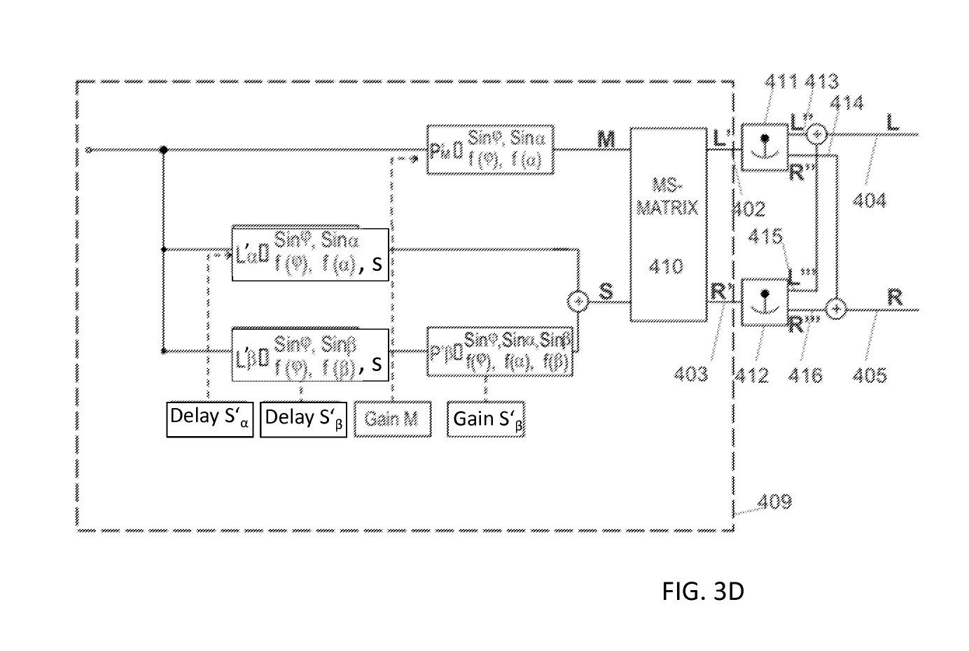

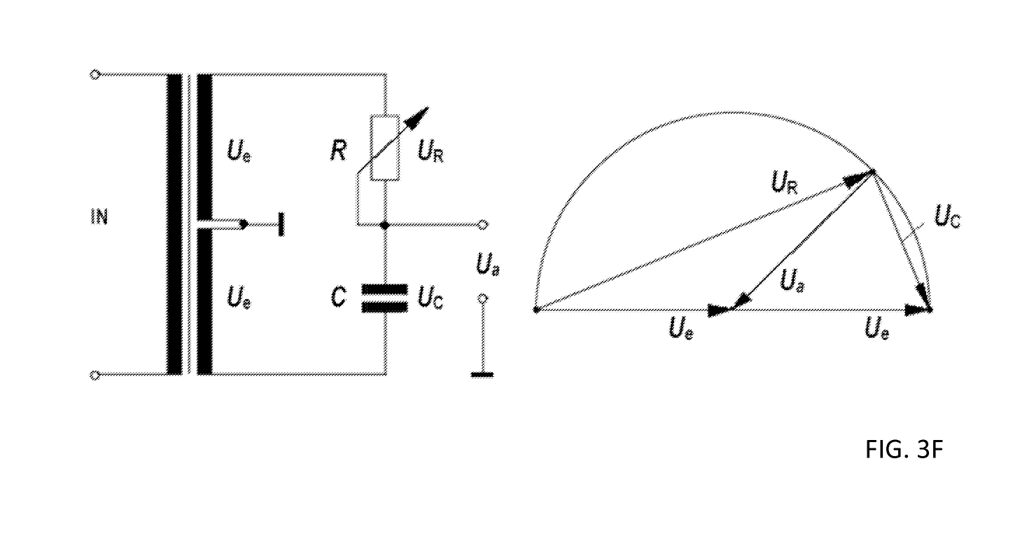

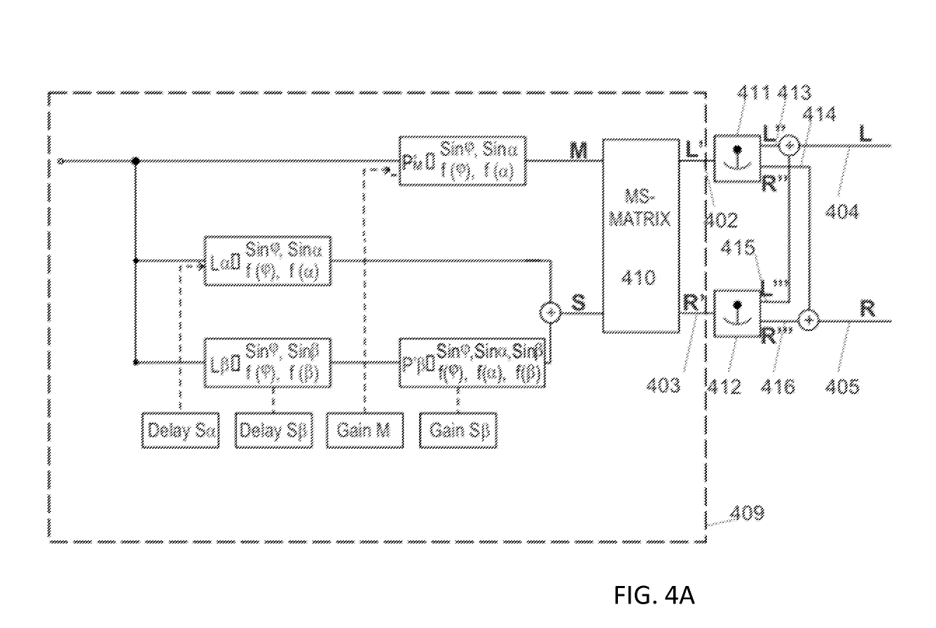

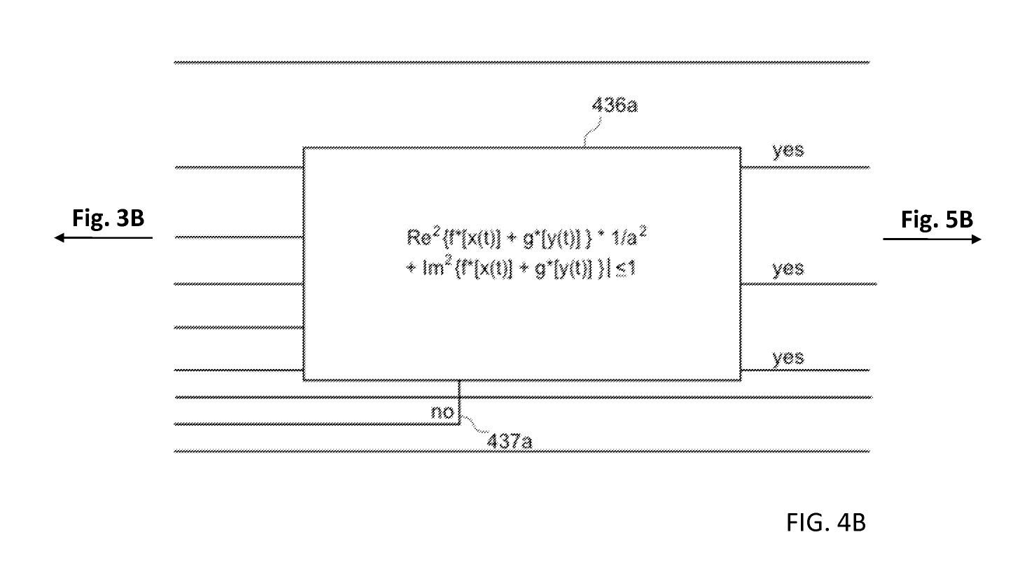

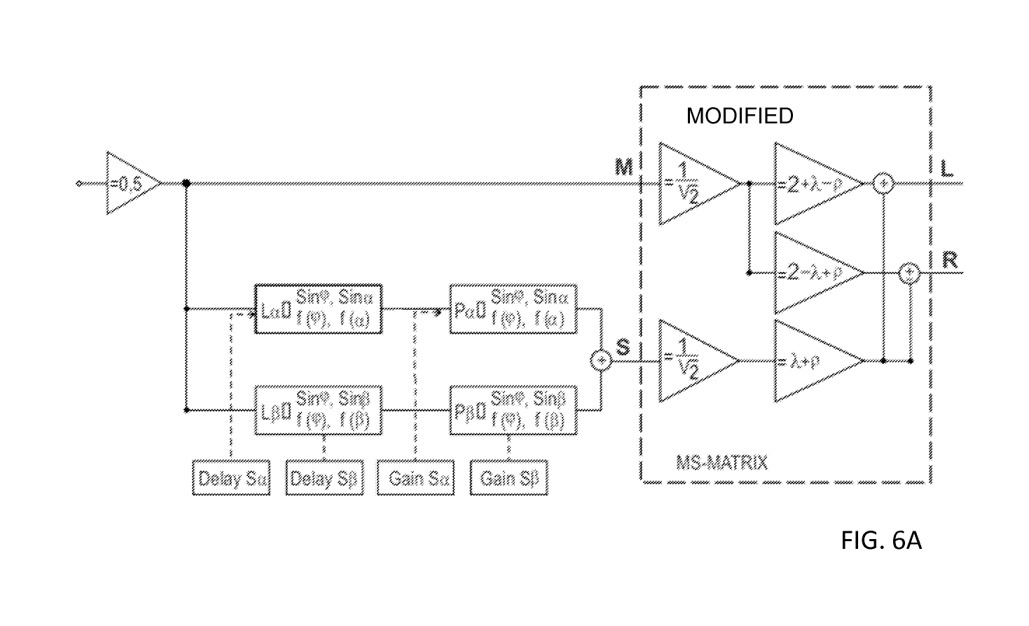

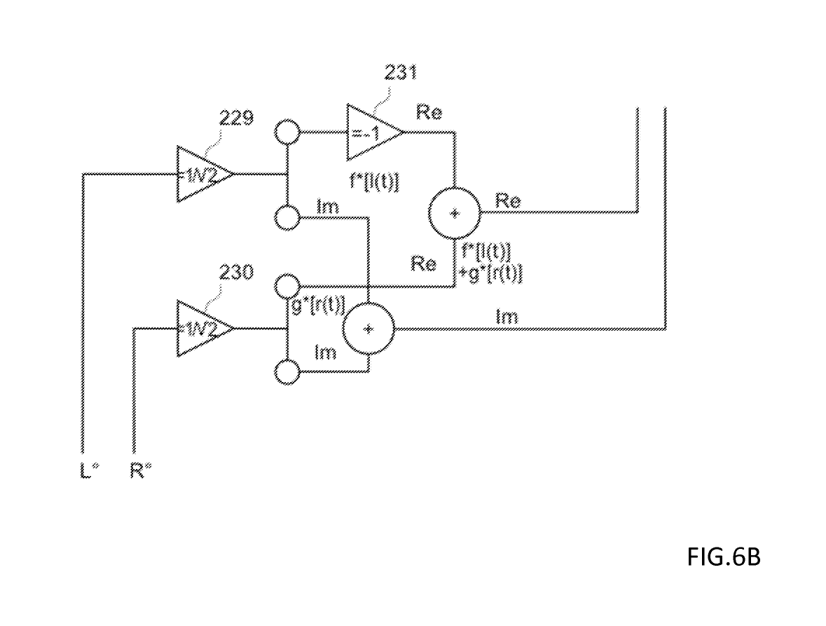

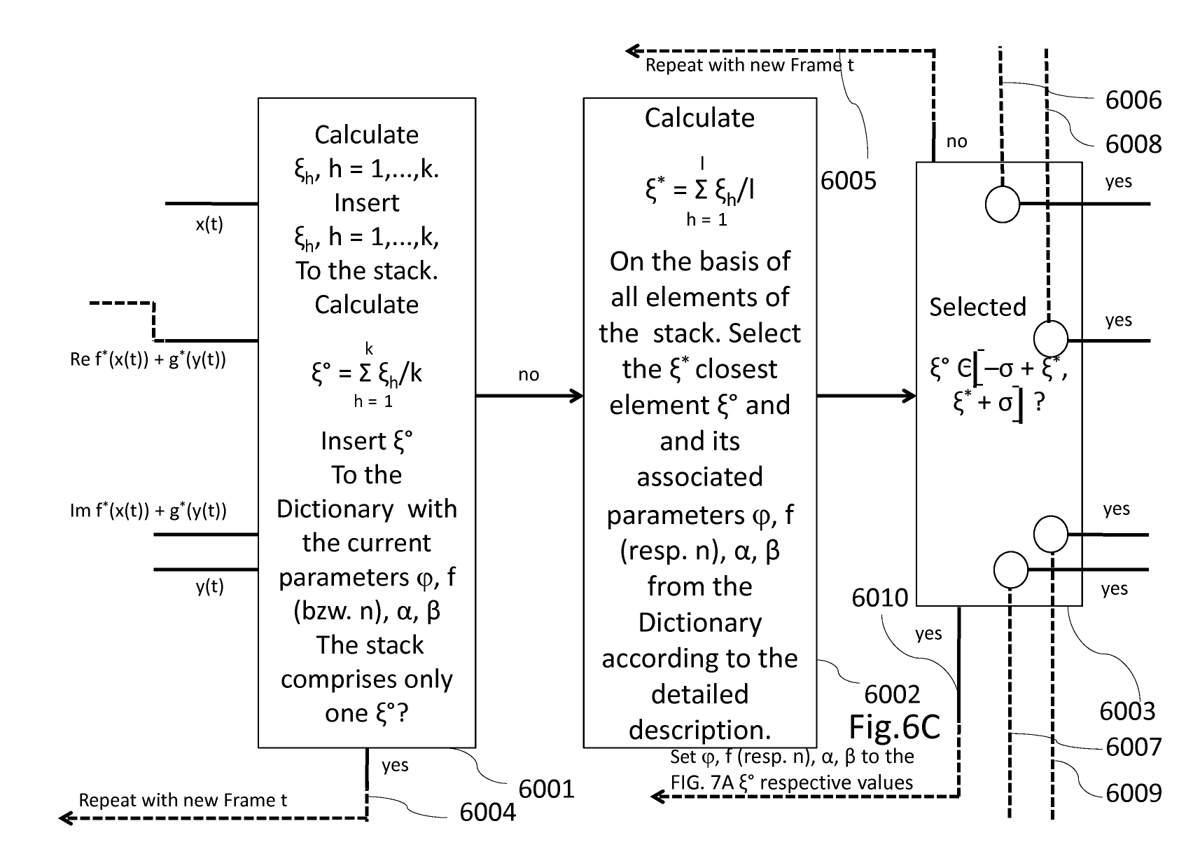

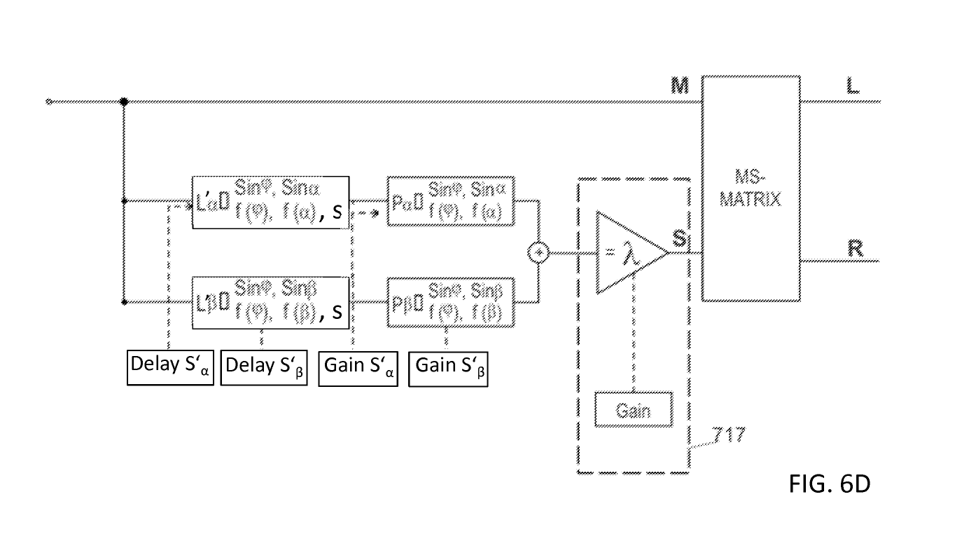

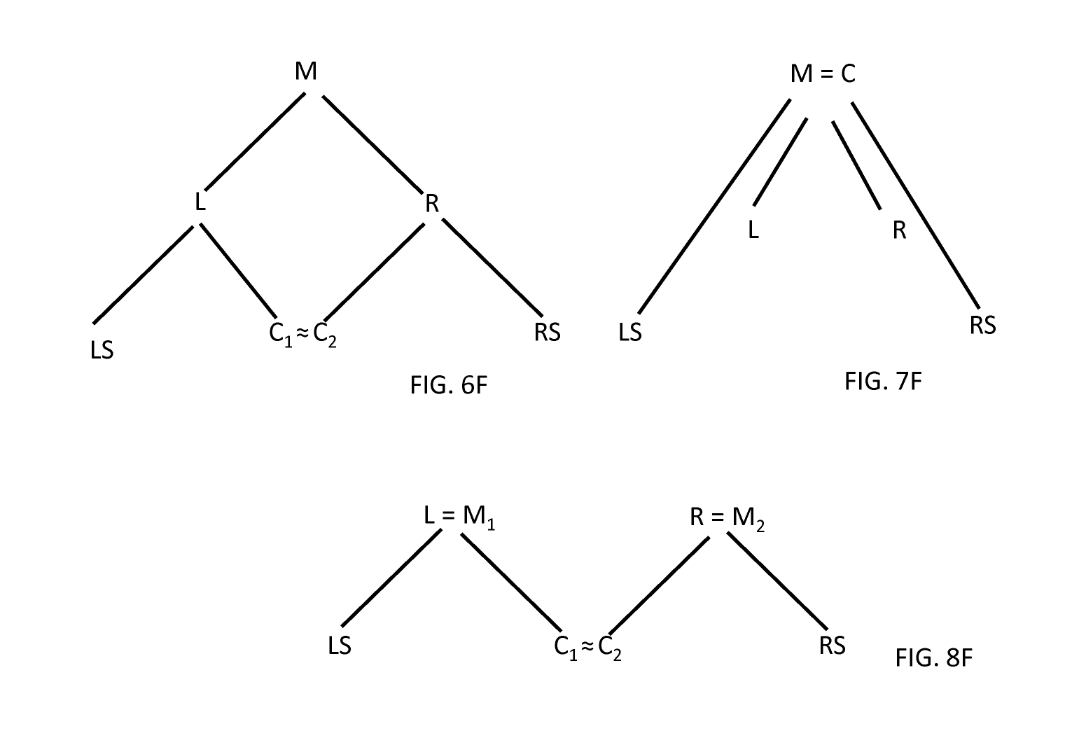

FIG. E1 shows a circuit which is equivalent to FIG. 3A resp. FIG. 6A, provided that the relation λ=ρ applies for the inversely proportional attenuations λ and ρ of the panoramic potentiometers shown in FIG. 3A.

FIG. E2 shows a circuit which is equivalent to FIG. 3A resp. FIG. 6A, provided that the relation λ=ρ applies for the inversely proportional attenuations λ and ρ of the panoramic potentiometers shown in FIG. 3A.

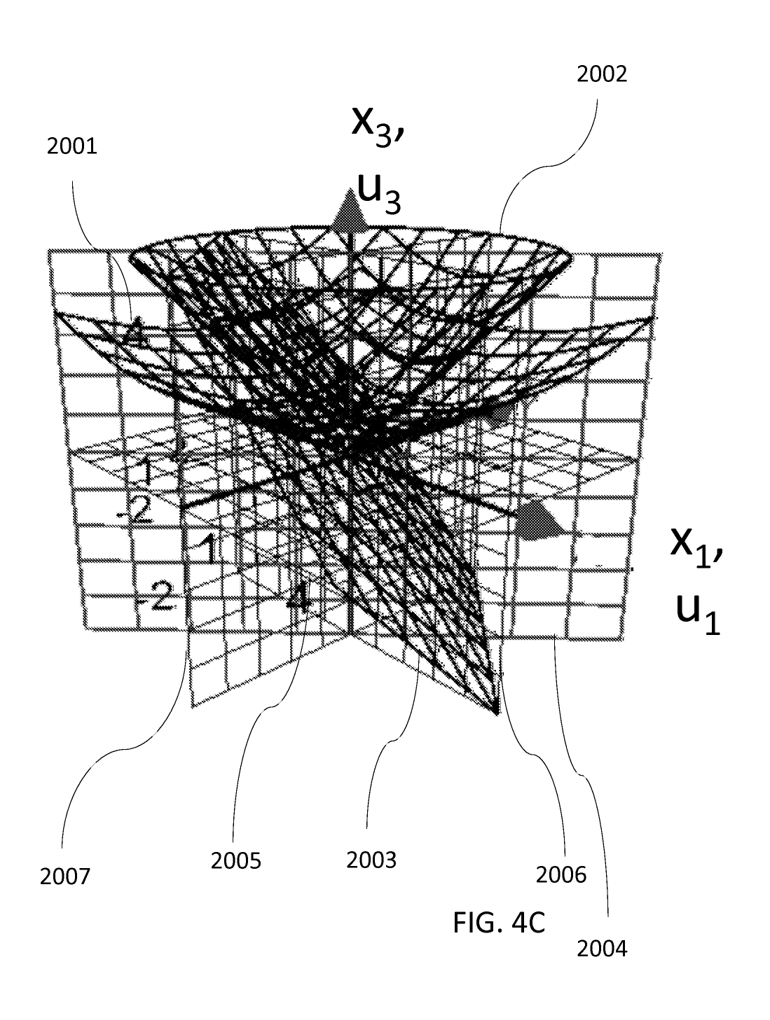

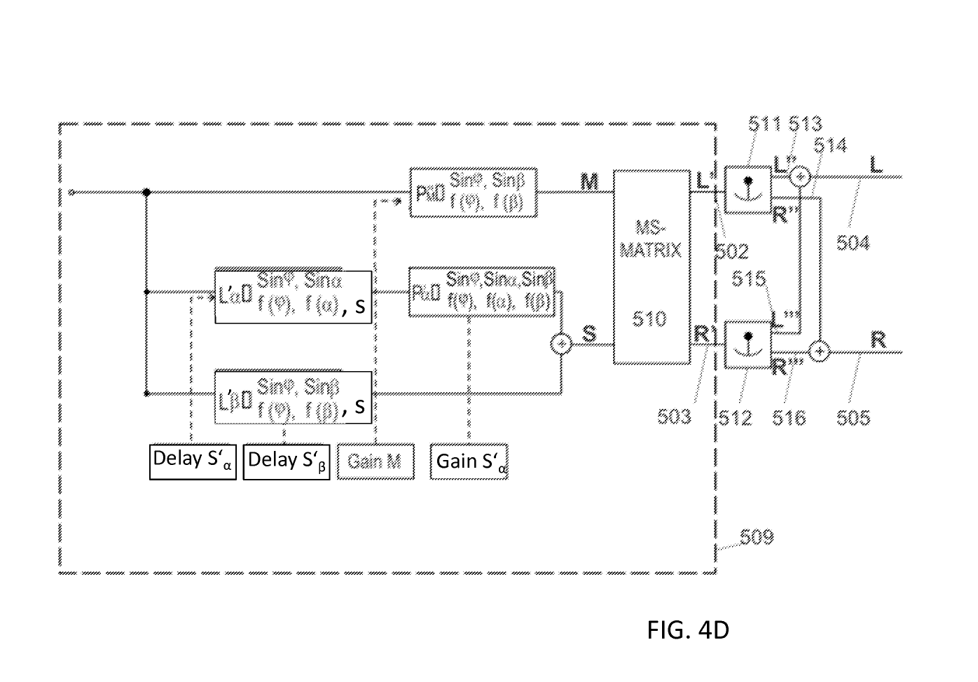

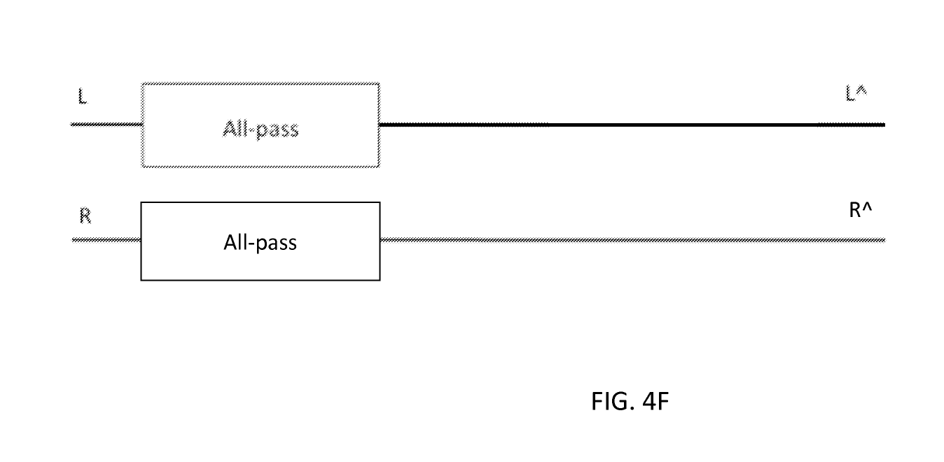

FIG. E3 shows a circuit which is equivalent to FIG. 4A, provided that the relation λ=ρ applies for the inversely proportional attenuations λ and ρ of the panoramic potentiometers shown in FIG. 4A.

FIG. E4 shows a circuit equivalent to FIG. 4A according to the equations (3AA) and (4AA), provided that the relation λ=ρ applies for the inversely proportional attenuations λ and ρ of the panoramic potentiometers shown in FIG. 4A.

FIG. E5 shows a circuit equivalent to FIG. 4A according to the equations (3AAA) and (4AAA), provided that the relation λ=ρ applies for the inversely proportional attenuations λ and ρ of the panoramic potentiometers shown in FIG. 4A.

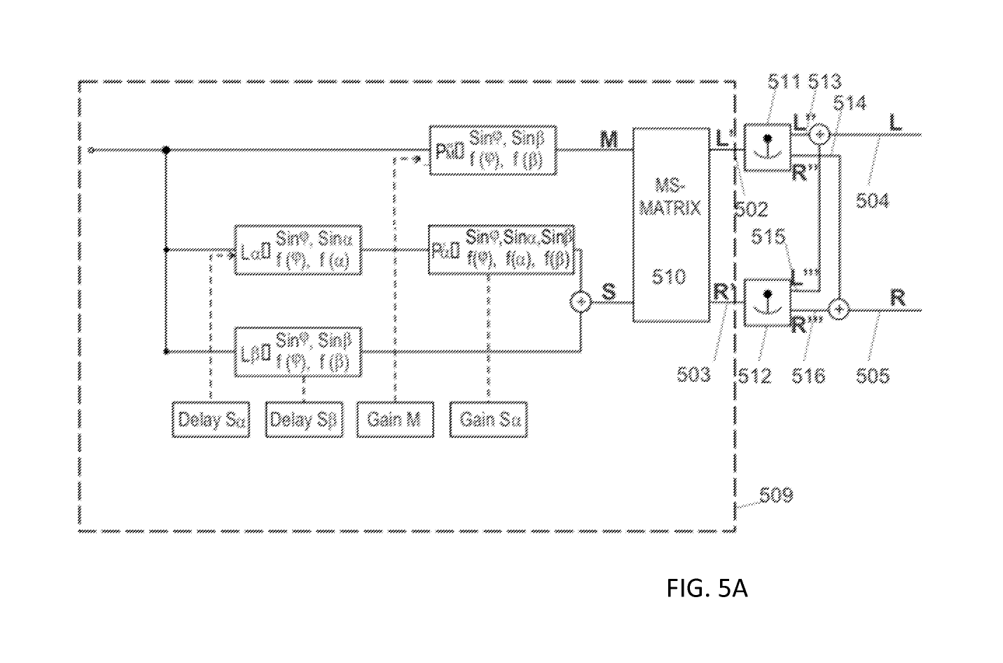

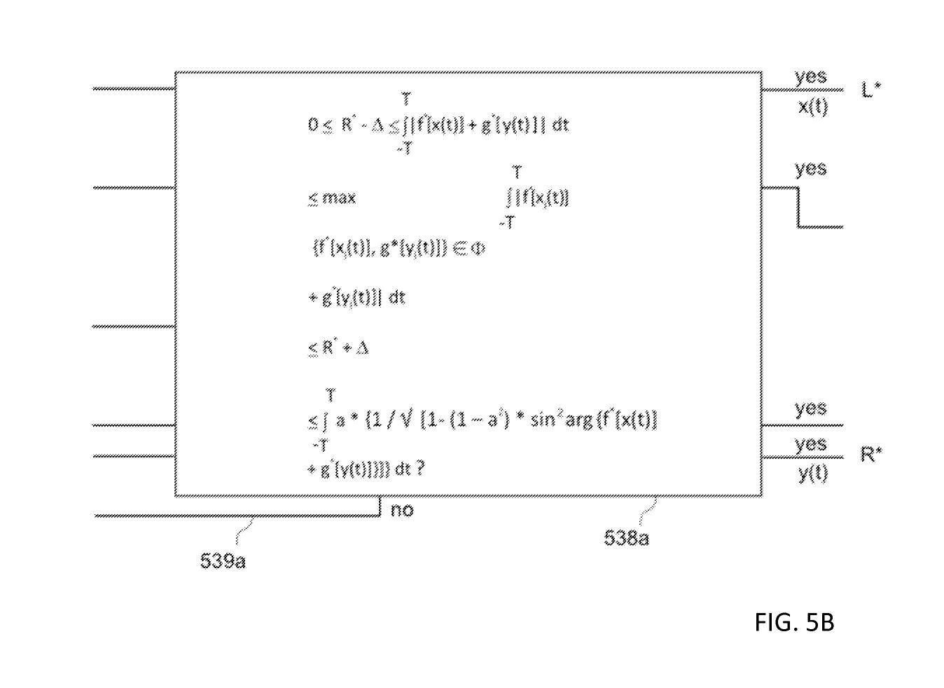

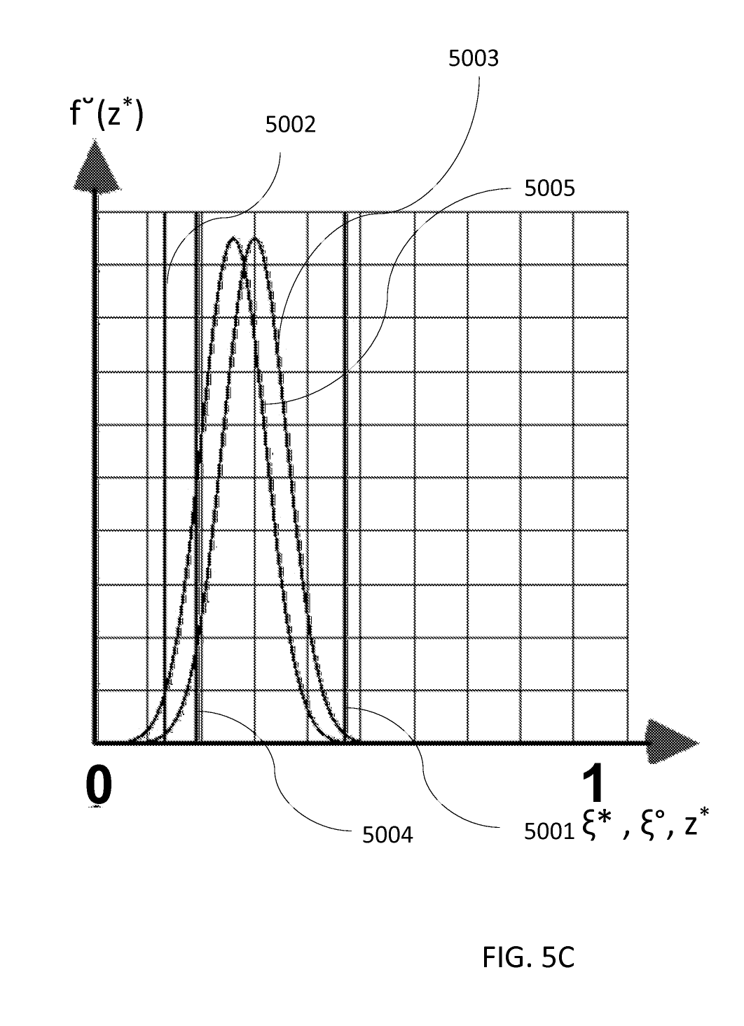

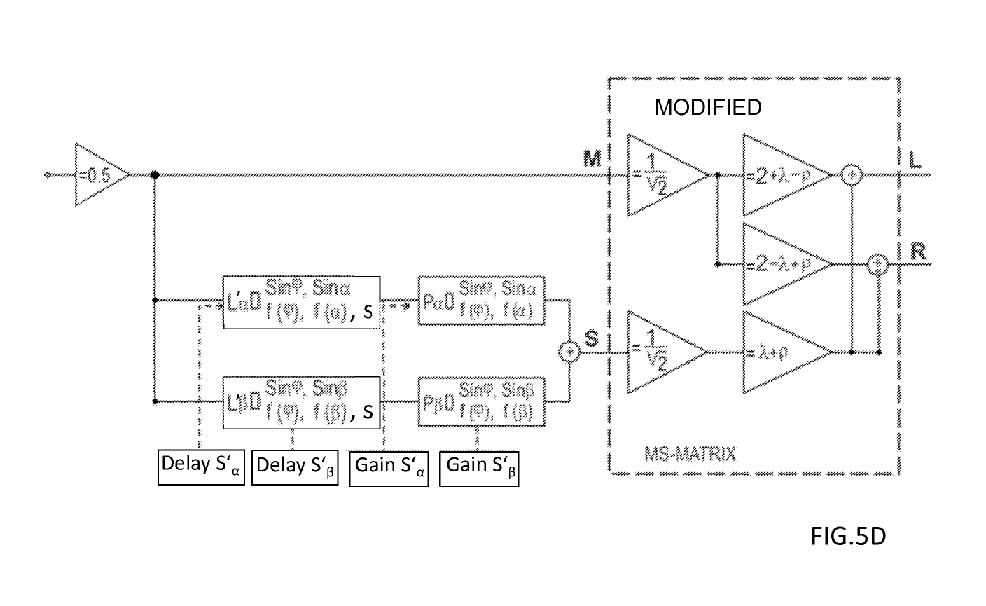

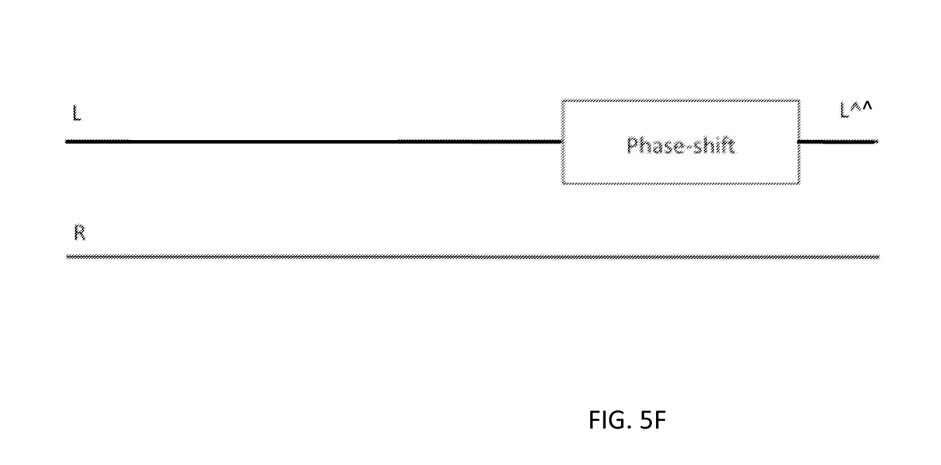

FIG. E6 shows a circuit equivalent to FIG. 5A, provided that the relation λ=ρ applies for the inversely proportional attenuations λ and ρ of the panoramic potentiometers shown in FIG. 5A.

FIG. E7 shows a circuit equivalent to FIG. 5A according to the equations (3AA) and (4AA), provided that the relation λ=ρ applies for the inversely proportional attenuations λ and ρ of the panoramic potentiometers shown in FIG. 5A.

FIG. E8 shows a circuit equivalent to FIG. 5A according to the equations (3AAA) and (4AAA), provided that the relation λ=ρ applies for the inversely proportional attenuations λ and ρ of the panoramic potentiometers shown in FIG. 5A.

FIG. E9 shows a new simplified variant embodiment, extended according to the invention by the parameter s, of the circuit of FIG. 6D according to WO2009/138205 resp. WO2011/009649 for uniform time differences L′_{α}=L′_{β}.

FIG. E10 shows a new simplified variant embodiment, extended according to the invention by the parameter s, of the circuit of FIG. 6D according to WO2009/138205 resp. WO2011/009649 for uniform time differences L′_{α}=L′_{β}.

FIG. E11 shows a simplified second variant embodiment, extended according to the invention by the parameter s and further simplified by integrating the parameter λ′, of the circuit of FIG. E10 according to WO2009/138205 resp. WO2011/009649 for uniform time differences L′_{α}=L′_{β}.

FIG. E12 shows a new simplified variant embodiment, extended according to the invention by the parameter s, of the circuit of FIG. 3D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. E13 shows a new simplified variant embodiment, extended according to the invention by the parameter s, of the circuit of FIG. 3D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. E14 shows a new variant embodiment, extended according to the invention by the parameter s and further simplified by integrating the parameter λ′, of the circuit of FIG. 3D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. E15 shows a new simplified variant embodiment, extended according to the invention by the parameter s, of the circuit of FIG. 4D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. E16 shows a new simplified variant embodiment, extended according to the invention by the parameter s, of the circuit of FIG. 4D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

FIG. E17 shows a new variant embodiment, extended according to the invention by the parameter s and further simplified by integrating the parameter λ′, of the circuit of FIG. 4D according to WO2009/138205 resp. WO2011/009649 for uniform time differences L′_{α}=L′_{β}. For EP1850639, the parameters are to be set as follows: f(φ)=f(α)=f(β)=1, sin φ=0, sin α=sin β=1.

### DETAILED DESCRIPTION

It is general knowledge that audio signals that are emitted via two or more loudspeakers provide the listener with a spatial impression, provided that they show different amplitudes, frequencies, time resp. phase differences or are reverberated appropriately

Such decorrelated signals can firstly be generated by differently positioned sound transducer systems, the signals from which are optionally post-processed, or can be generated by means of so-called pseudostereophonic techniques, which—on the basis of a mono signal—produce such suitable decorrelation.

Hereinafter, the contents of WO2011/009649 will be reproduced in full for a better understanding of the following examples of application of the present invention:

Some pseudostereophonic signals show increased “phasiness”, that is to say distinctly perceptible time differences between both channels. Frequently, the degree of correlation between both channels also is too low (lack of compatibility) or too high (undesirable convergence towards a mono sound). Pseudostereophonic signals, but also stereophonic signals, may therefore show deficiencies due to lacking or excessive decorrelations between the emitted signals.

It is thus an aim of WO2011/009649 to solve this problem and to align or inversely to differentiate more strongly stereophonic (including pseudostereophonic) signals.

It is another aim to improve, generate, transmit, convert and reproduce stereophonic and pseudostereophonic audio signals.

In WO2011/009649, these problems are solved inter alia by means of the ostensibly unprofitable downstream connection of a panoramic potentiometer in a device for pseudostereo conversion.

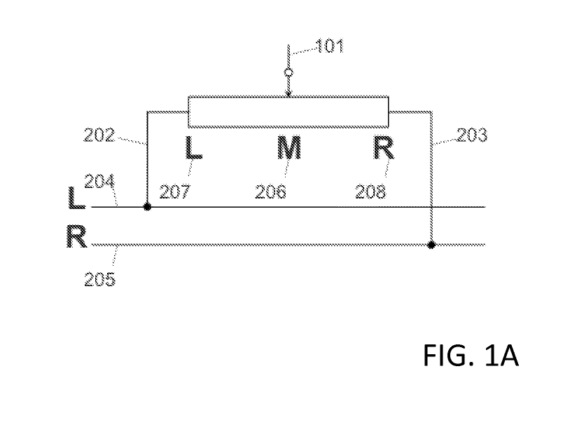

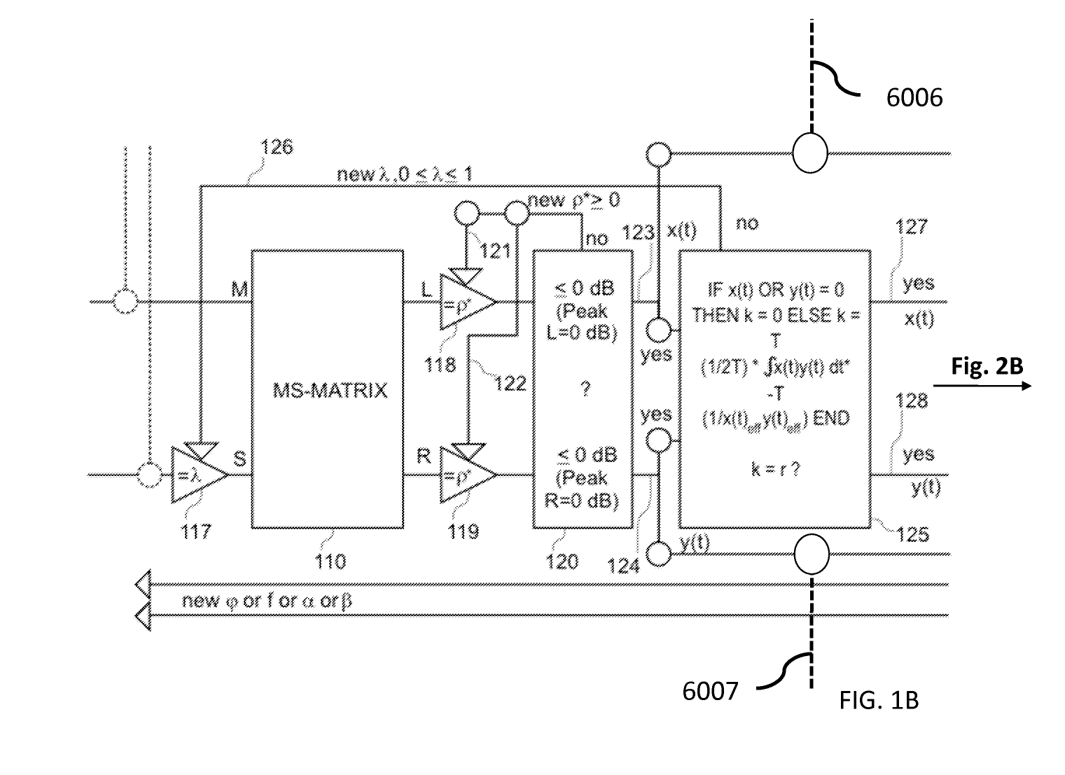

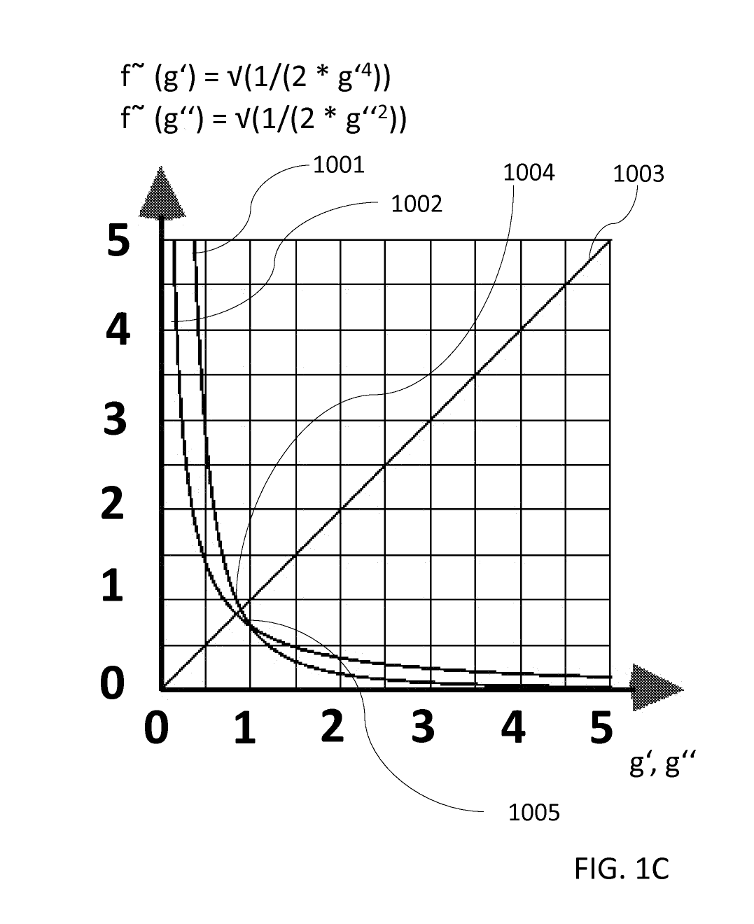

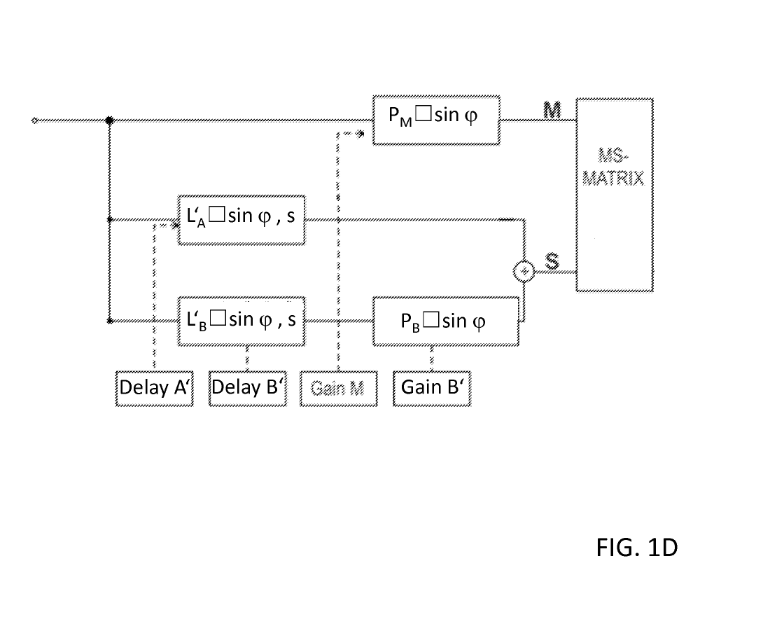

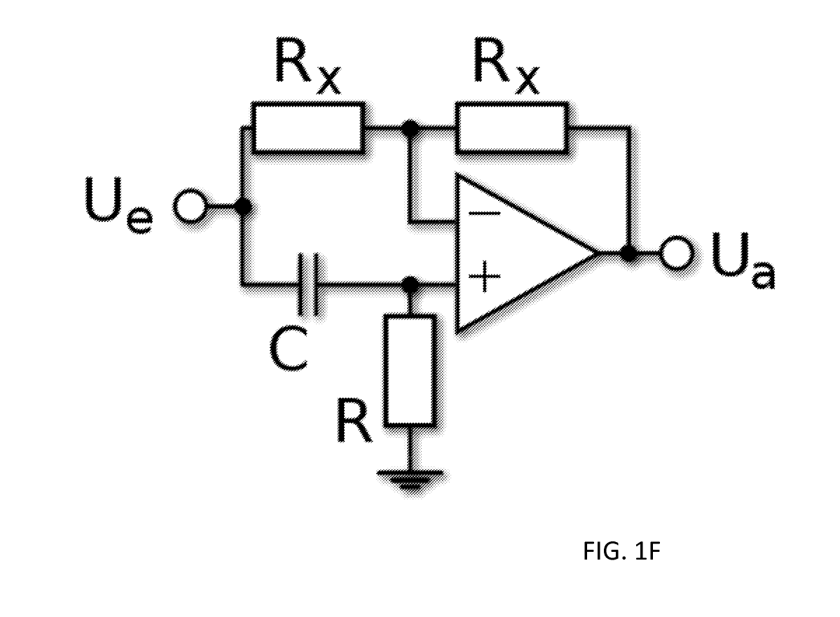

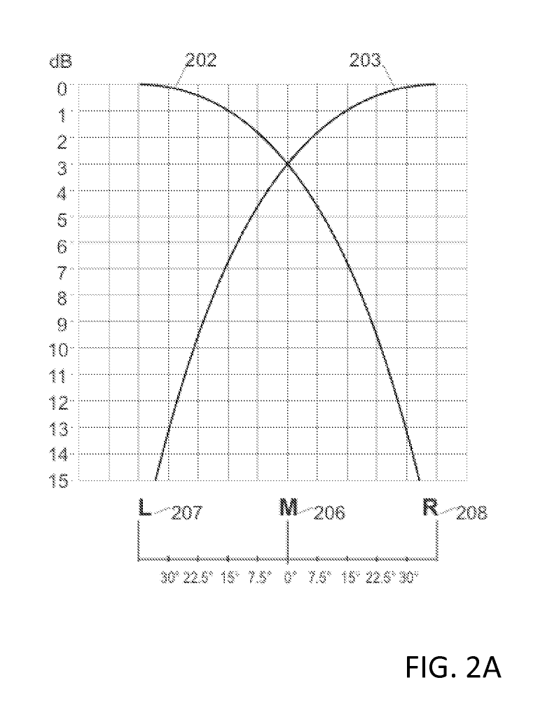

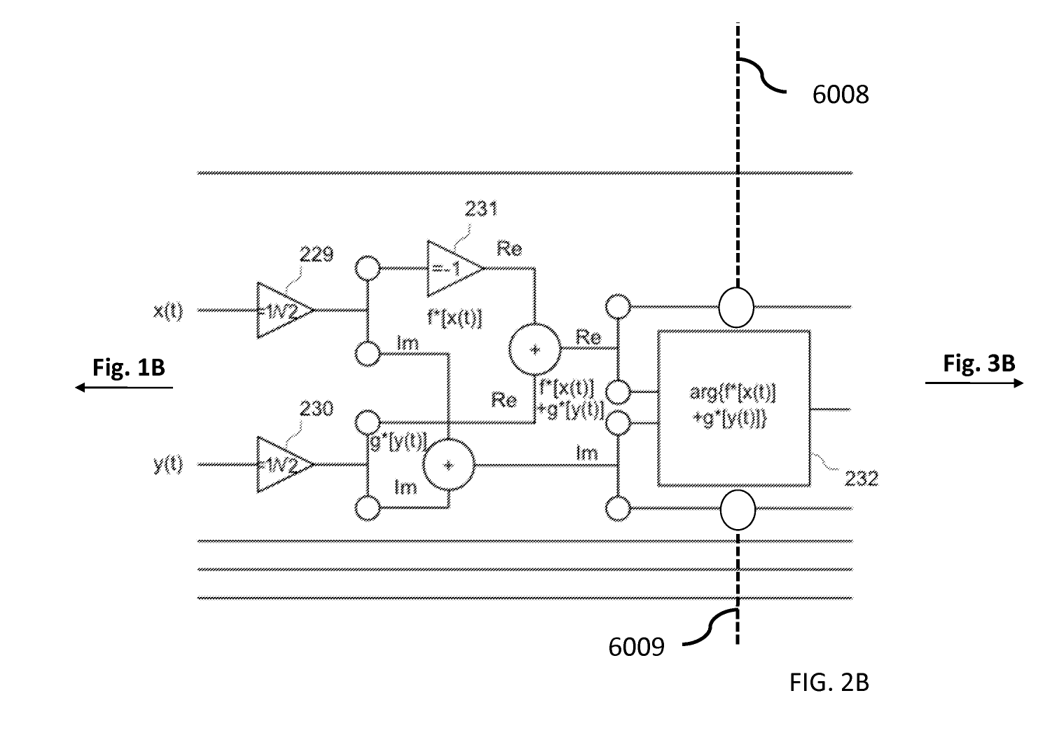

Panoramic potentiometers (also called pan pots or panoramic controls or panoramic dials) are known per se and are used for intensity stereophonic signals, i.e. for stereo signals that differ exclusively in terms of their levels but not in terms of timing resp. phase differences or different frequency spectra. The circuit principle of a known panoramic potentiometer is represented in FIG. 1A. The device has an input 101 and two outputs 202, 203 which are connected to the buses 204, 205 for the group channels L (left audio channel) and R (right audio channel). In the center position (M), both buses receive the same level; in the side positions to the left (L) and to the right (R), the signal is routed only to the left bus or to the right bus, respectively. In the intermediate positions, a panoramic potentiometer produces level differences corresponding to the different positions of the phantom source on the loudspeaker base.

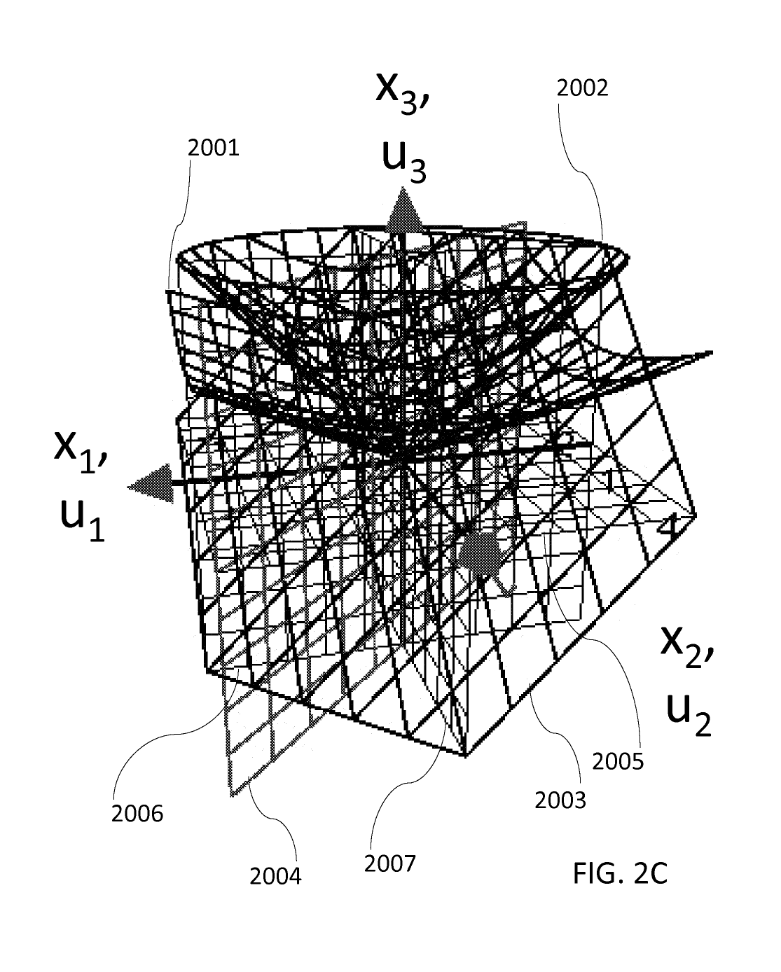

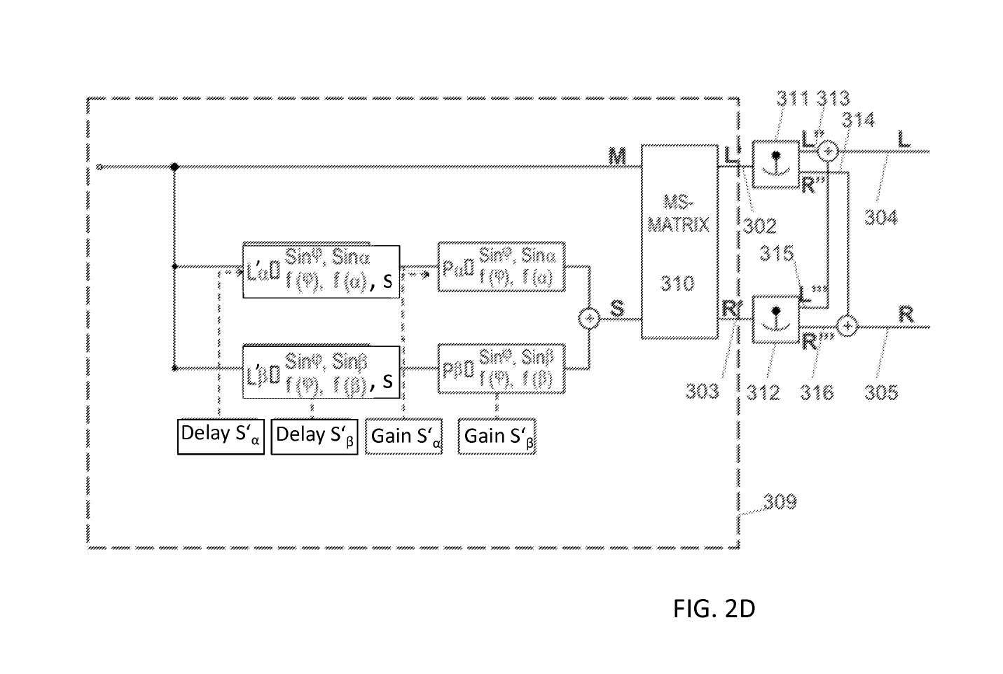

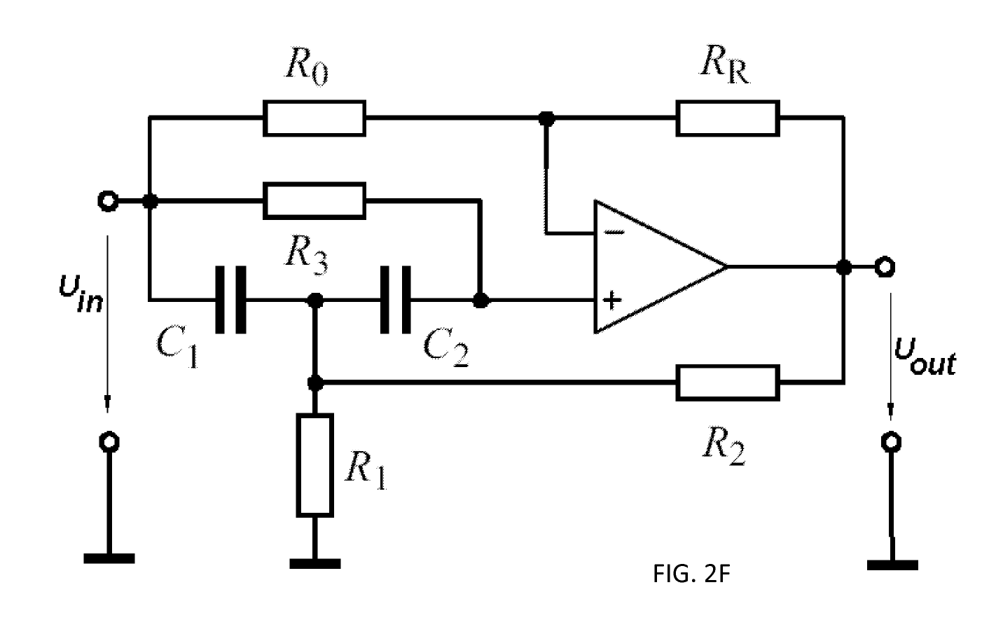

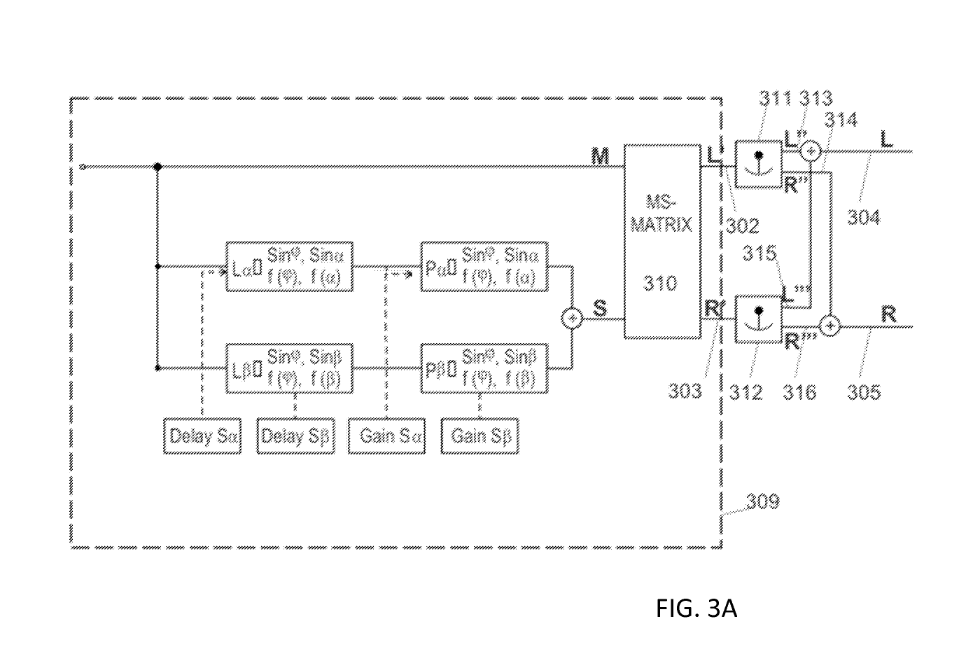

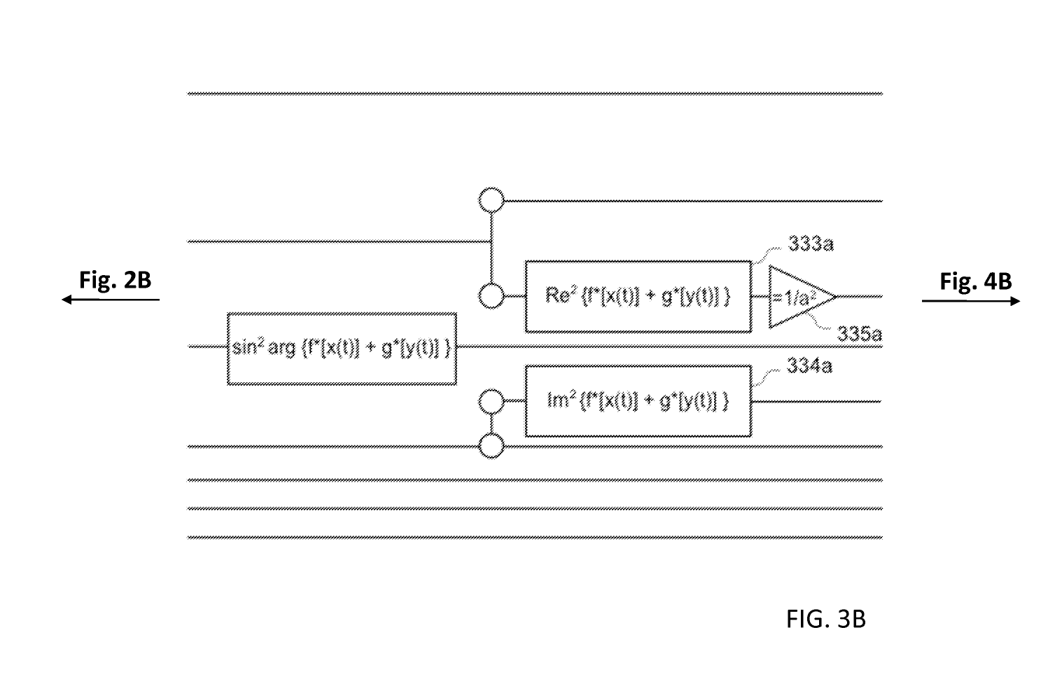

FIG. 2A shows the attenuation curve for the left channel and the right channel of a panoramic potentiometer without an extended stereo width range, and corresponding mapping angles. In the center position, the attenuation in each channel is 3 dB, the acoustic convolution thereby producing the same perception of volume as would be if there were only one channel in the L or R position.

Panoramic potentiometers are able as voltage dividers for example to distribute the left channel in a different, selectable ratio to the resulting left output resp. right output (these outputs are also called buses) or, in the same way, to distribute the right channel in a different, selectable ratio to the same left output resp. right output (the same buses). Therefore, in the case of intensity stereophonic signals, the image width can be narrowed and the direction of such signals can be shifted.

In the case of pseudostereophonic signals, which make use of timing resp. phase differences, different frequency spectra or reverberation (and also in the case of stereo signals of such kind in general), such narrowing of the image width resp. shifting of the localisation direction are not possible by using a panoramic potentiometer. The application of panoramic potentiometers to such signals is therefore deliberately abstained from.

However, as represented in WO2011/009649 it has been observed that the previously unknown downstream connection of a panoramic potentiometer downstream to a circuit for pseudostereo conversion affords unexpected advantages. Although such downstream connection cannot result in the aforementioned narrowing of the image width or in the shifting of the localisation direction of the stereo signals obtained, the degree of correlation between the left signal and the right signal can however be increased or also decreased in this way by using such a panoramic potentiometer.

In a preferred embodiment, a panoramic potentiometer is connected downstream respectively to the left output and to the right output of the circuit for obtaining a pseudostereophonic signal. In this case, the buses of both panoramic potentiometers are preferably used collectively and preferably identically.

In this arrangement, each panoramic potentiometer has an input and two outputs. The input of a first panoramic potentiometer is connected to a first output of the circuit, and the input of a second panoramic potentiometer is connected to a second output of this circuit. The first output of the first panoramic potentiometer is connected to the first output of the second panoramic potentiometer. The second output of the first panoramic potentiometer is connected to the second output of the second panoramic potentiometer.

Alternatively and equivalently, rather than using panoramic potentiometers, the degree of correlation can also be adjusted by using a first circuit for pseudostereo decoding with a stereo decoder and an amplifier connected upstream of the stereo decoder for amplifying an input signal of the stereo decoder, this being achieved without panoramic potentiometer. An equivalent adjustment of the degree of correlation can therefore be implemented with fewer components.

Alternatively and equivalently, rather than using a panoramic potentiometer, the degree of correlation can also be varied by using a second circuit, this being achieved with a modified stereo decoder which contains an adder and a subtractor in order to add respectively subtract input signals (M, S), which are respectively amplified by predetermined factors, in order to generate signals which are identical to the bus signals from the panoramic potentiometers. An equivalent adjustment of the degree of correlation can therefore be implemented with even fewer components.

The invention can also be applied to devices or methods that generate signals which are reproduced by more than two loudspeakers (for example surround sound systems belonging to the prior art).

FIGS. 3A to 5A show various embodiments of the circuit principle described above, in which a panoramic potentiometer 311 and 312, 411 and 412, 511 and 512, respectively, is connected directly downstream to a pseudo conversion circuit 309, 409 resp. 509. In each example shown here, the pseudo conversion circuit 309, 409 resp. 509 comprises a circuit having an MS matrix 310, 410 resp. 510, as described in WO2009/138205 as well as in EP1850639.

This panoramic potentiometer 311 and 312, 411 and 412, 511 and 512 can be used to increase or decrease the degree of correlation of the resulting buses L 304, 404, 504 and R 305, 405, 505. Accordingly, the left channel L′ 302, 402, 502 and the right channel R′ 303, 403, 503 resulting from the stereo decoding (after passing through the MS matrix) are fed each to a panoramic potentiometer for collectively used buses L and R.

If the attenuation λ for the left input signal L′ of the panoramic potentiometer 311, 411 or 511 and the attenuation ρ for the right input signal R′ of the panoramic potentiometer 312, 412, 512 for a stereo signal 302 and 303, 402 and 403, 502 and 503 resulting from a device 309, 409 or 509 is limited to the range between 0 and 3 dB, the inversely proportional relations

1≧λ≧0

and

1≧ρ≧0

may be introduced (where 1 corresponds to the value 0 dB and 0 corresponds to the value 3 dB).

λ and ρ therefore correspond to the inversely proportional attenuations of the panoramic potentiometers shown in FIG. 3A to FIG. 5A, limited to the range between 0 and 3 dB.

Therefore, the following relations are obtained for the resulting stereo signals (buses) L and R (304 and 305, 404 and 405, 504 and 505) resp. the output signals L″ 313, 413, 513 and R″ 314, 414, 514 from the panoramic potentiometer 311, 411, 511 and the output signals L′″ 315, 415, 515 and R′″ 316, 416, 516 from the panoramic potentiometer 312, 412, 512:

L=L″+L′″=1/2*L′ (1+λ)+1/2*R′(1−ρ) (1A)

and

R=R″+R′″=1/2*L′(1−λ)+1/2*R′(1+ρ) (2A)

FIG. 6A shows a further embodiment with a circuit equivalent to FIG. 3A having a slightly modified MS matrix, which renders direct downstream connection of panoramic potentiometers superfluous. Taking into account the equivalences of the stereo decoding (MS matrixing)

L′=(M+S)*1/√ 2̅

and

R′=(M−S)*1/√ 2̅

the following relations are obtained:

L=[M(2+λ−ρ)+S(λ+ρ)]*1/2√ 2̅ (1A)

R=[M(2−λ+ρ)−S(λ+ρ)]*1/2√ 2̅ (2A)

This allows the signals on the buses L and R to be also derived directly from the input signals M and S of the stereo decoding circuit.

If λ=ρ (same attenuation in the left channel and in the right channel), the following relations apply:

L=(M+λ*S)*1/√ 2̅ (3A)

R=(M−λ*S)*1√ 2̅ (4A)

i.e. the variation in the amplitude of the signal S is equivalent to the downstream connection of a respective panoramic potentiometer for identical attenuation in the left channel and in the right channel. Under these assumptions, the output signals L and R correspond to the bus signals L and R in FIG. 3A.

This will therefore yield a circuit or a method showing for example the form in FIG. 6A (trivial modifications being possible), which forms a composite signal from the M signal, amplified by the factor (2+λ−ρ), and the S signal, amplified by the factor (λ+ρ), as well as a difference signal which is compiled from the M signal, amplified by the factor (2−λ+ρ), minus the S signal, amplified by the factor (λ+ρ), with correction by the factor 1/2√Σ2 needing to be performed overall in order to obtain signals L and R equivalent to the formulae (1A) and (2B).

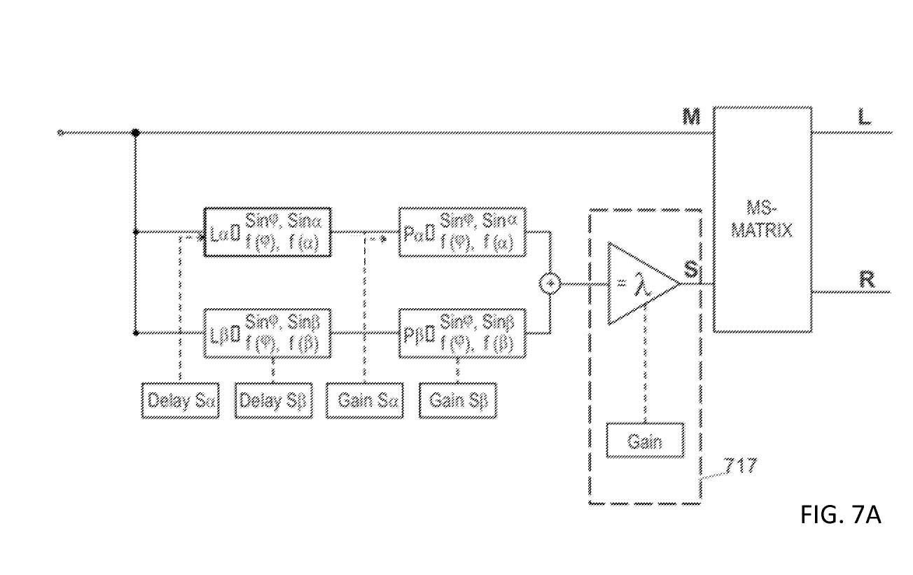

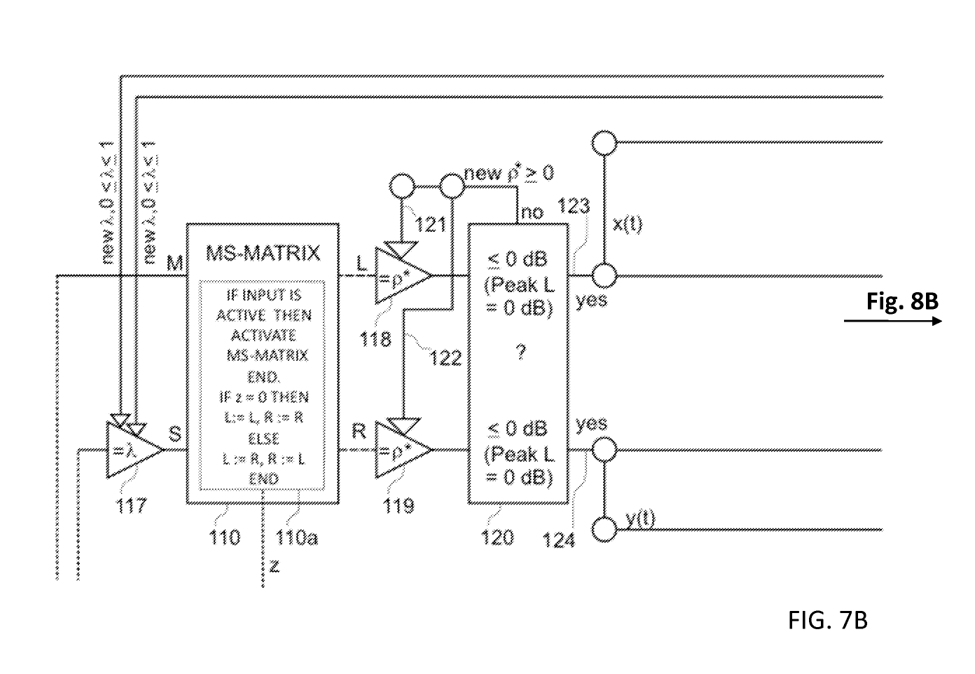

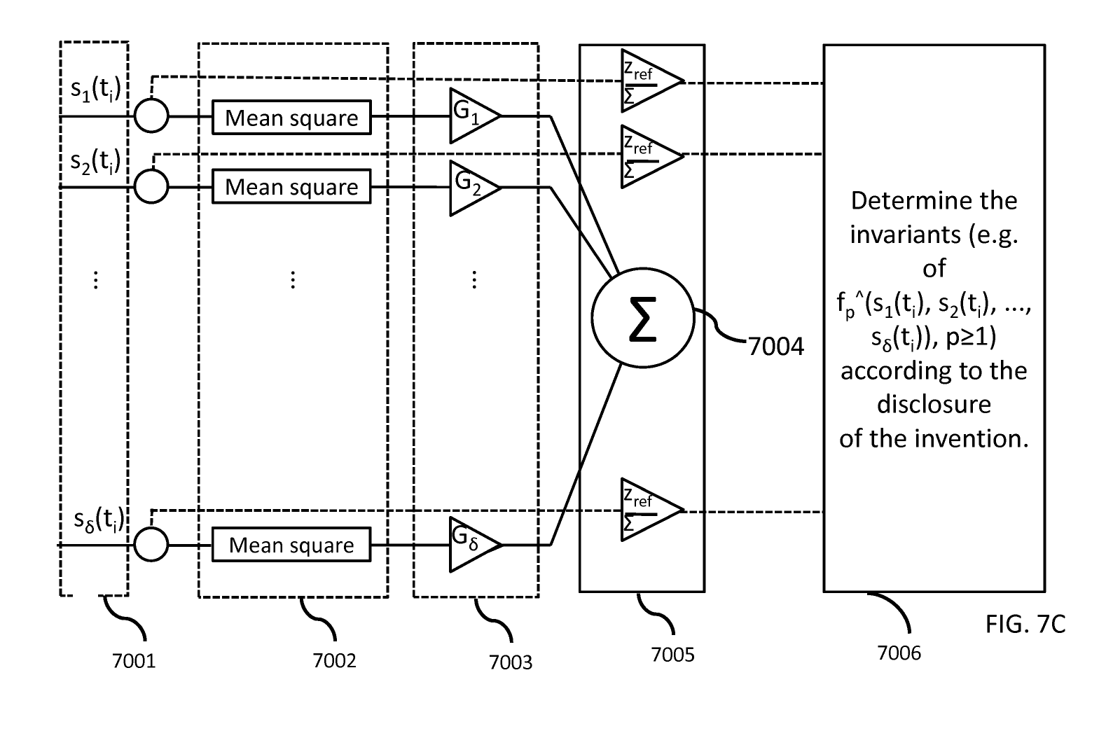

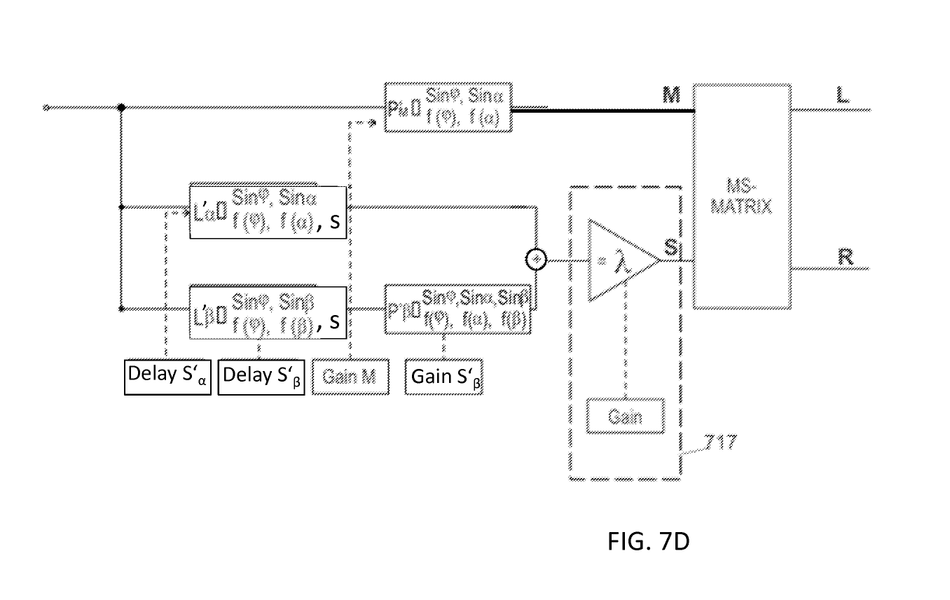

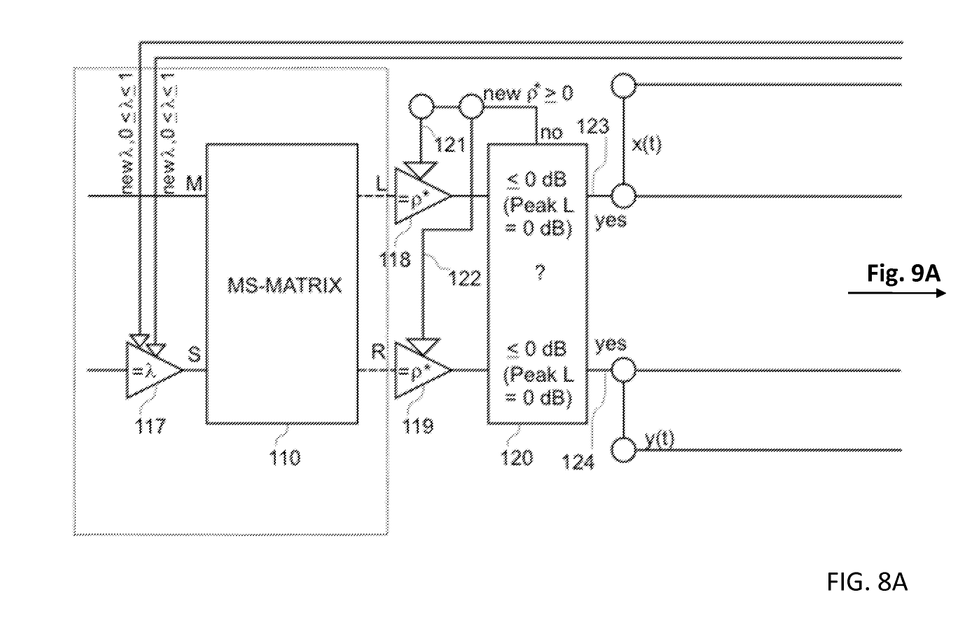

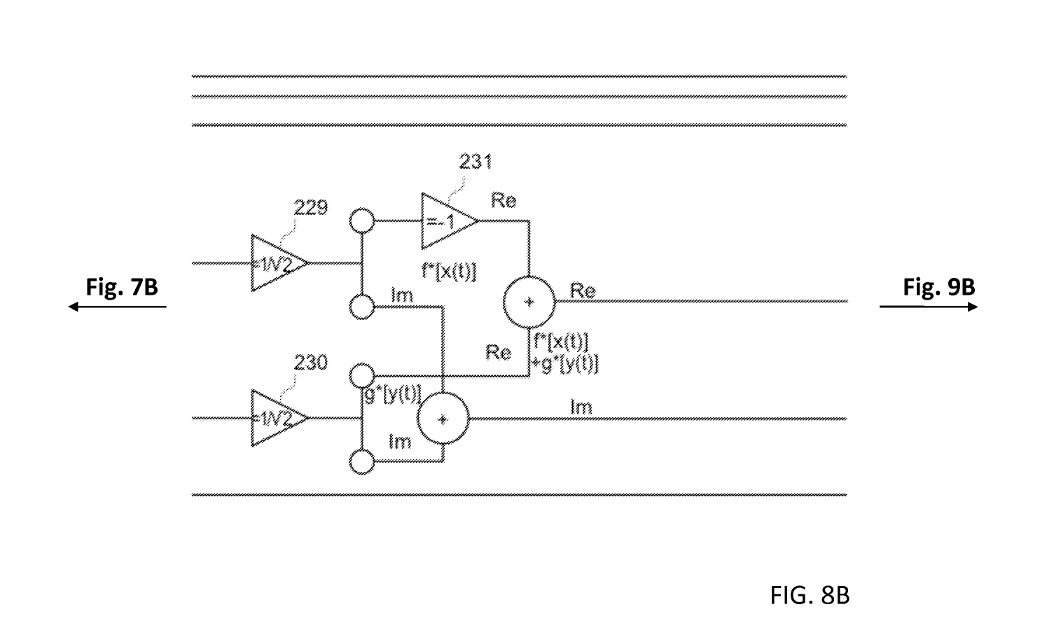

FIG. 7A shows a circuit equivalent to FIG. 3A resp. FIG. 6A, provided that the relation λ=ρ applies for the inversely proportional attenuations λ and ρ of the panoramic potentiometers shown in FIG. 3A. This circuit should not be confused with the arrangement known from intensity stereophony (MS microphone technique) for altering the pickup or aperture angle (which does not take place here!).

In this case, it is assumed that uniform attenuation for proposed panoramic potentiometers or modified MS matrix, as just illustrated, is frequently sufficient for levelling or differentiating stereo signals. When λ=ρ, the device just illustrated is then simplified on the basis of the above formulae (3A) and (4A) according to:

L=(M+λ*S)*1/√ 2̅ (3A)

R=(M−λ*S)*1/√ 2̅ (4A)

which is equivalent to a simple amplitude correction of the S signal (717).

Such an amplitude correction for the S signal has been known to date only for the classical MS microphone technique and in the ideal range results in the alteration of the pickup or aperture angle in that case, which does not take place here. A transfer of the same operating principle is not possible (and an application of the MS microphone technique to the present circuit is accordingly not obvious).

In FIG. 7A, the S signal is therefore additionally amplified by the factor λ(1≧λ≧0) prior to finally passing through the MS matrix. The resulting stereo signal is equivalent to the bus signals 304 and 305 in FIG. 3A, 404 and 405 in FIGS. 4A and 504 and 505 in FIG. 5A for uniform attenuation and also to the output signal L and R in FIG. 6A, provided that λ=ρ is true in that case.

In practice, this circuit resp. method can be used to exactly stipulate the degree of correlation, i.e. there is a direct functional relationship between the attenuation λ and the degree of correlation r, for which ideally

0.2≦r≦0.7

is true. For λ, a series of experiments has found

0.07≦λ≦0.46

to be favorable for most applications.

In particular, artifacts (such as disturbing timing differences, phase shifts, or the like) can be eliminated without difficulty by using this device or method, whether manually or automatically (algorithmically).

On the basis of the equivalence of downstream panoramic potentiometers with uniform attenuation and amplitude correction of the S signal by the factor λ (1≧λ≧0) prior to final MS matrixing, it is therefore possible to achieve convincing pseudostereophony which, on the basis of the original mono signal, grants the listener a comprehensive, albeit extremely simple, post-processing option, while fundamentally maintaining the compatibility and avoiding disturbing artifacts.

Alternatively, the M signal can also be amplified by the factor 1/λ. The equations (3A) and (4A) are then to be replaced by the equations

(1/λ)*L=[(1/λ)*M+S]*1/√ 2̅ (3AA)

resp.

(1/λ)*R=[(1/λ)*M−S]*1/√ 2̅ (4AA)

in order to obtain signals equivalent to (3A) resp. (4A). FIG. 7A in this case is to be replaced by FIG. E1, FIG. E3 described hereafter is to be replaced by FIG. E4, FIG. E6 described hereafter is to be replaced by FIG. E7.

If alternatively both the M signal as well as the S signal are amplified, the relations 1≧τ+λ′≧0 and λ=τ+λ′ result for the new amplification factor 1/τ for the M signal and for the new amplification factor λ′ for the S signal. The equations (3A) and (4A) are then to be replaced by the equations

(1/τ)*L=[(1/τ)*M+λ′*S]*1/√ 2̅ (3AAA)

resp.

(1/τ)*R=[(1/τ)*M−λ′*S]*1/√ 2̅ (4AAA)

in order to obtain signals equivalent to (3A) resp. (4A). FIG. 7A in this case is to be replaced by FIG. E2, FIG. E3 described hereafter is to be replaced by FIG. E5, FIG. E6 described hereafter is to be replaced by FIG. E8. Likewise, the new amplification factors 1/λ resp. 1/τ resp. λ′ can be used in a similar way as the inversely proportional attenuations λ or ρ for optimizing pseudostereophonic signals according to EP1850639 or WO2009/138205 or WO2011/009649 or WO2011/009650 or CH01264/10 resp. PCT/EP2011/063322 or also according to the present application.

Overall, these devices and methods or systems can be used for example in telephony, in the field of professional post-processing of audio signals or else in the area of high-quality electronic consumer goods, the aim of which is the most simple yet efficient handling.

For narrowing or expanding the image width:

For this application, the additional use of prior art compression algorithms or data reduction methods or the analysis of characteristic features, such as the minima or maxima for the pseudostereophonic signals obtained is recommended in order to speed up evaluation thereof in accordance with the invention.

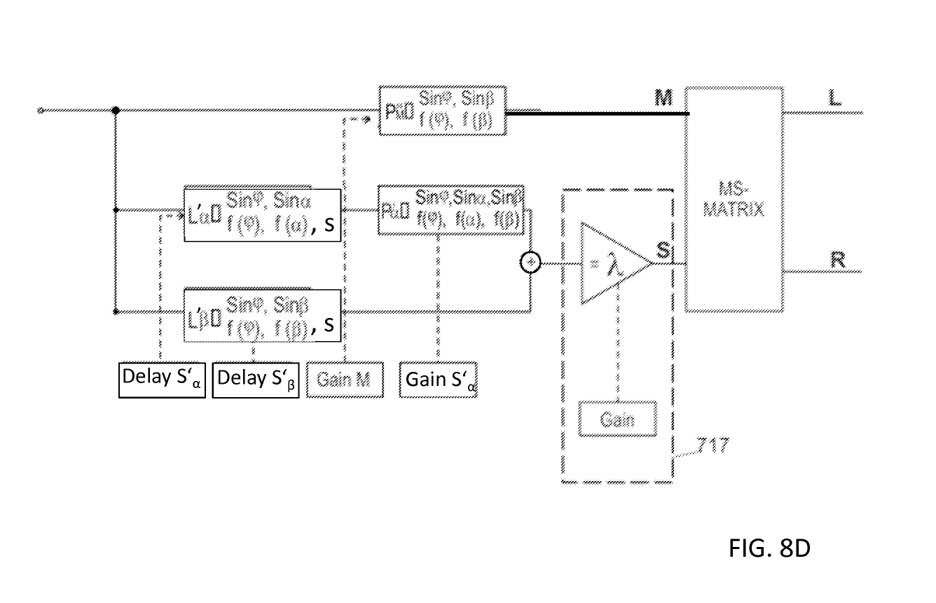

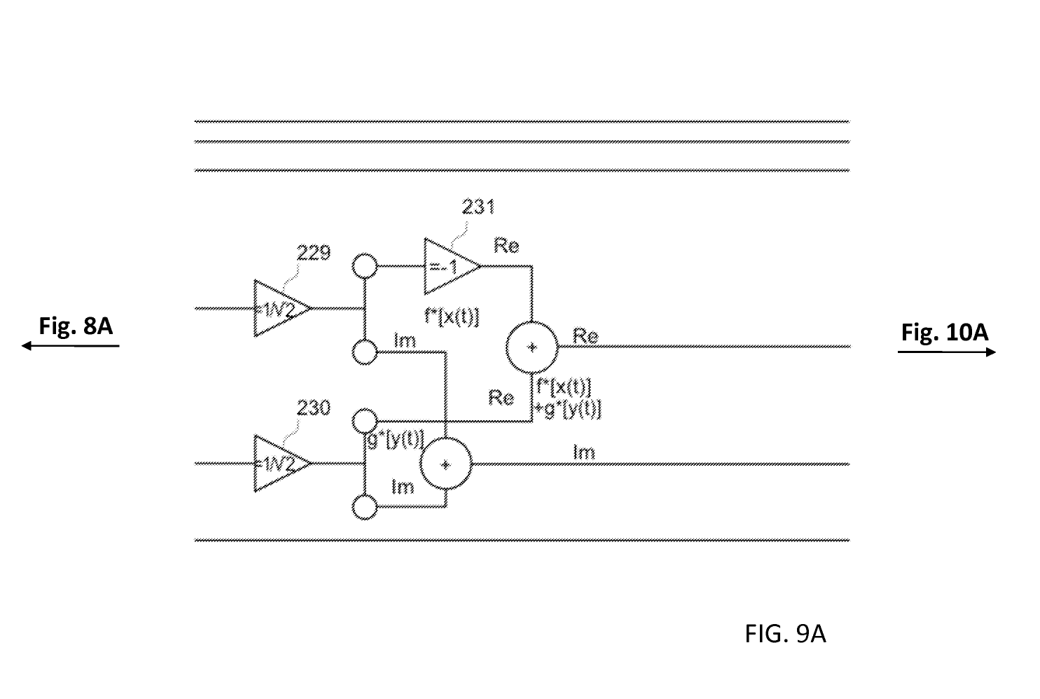

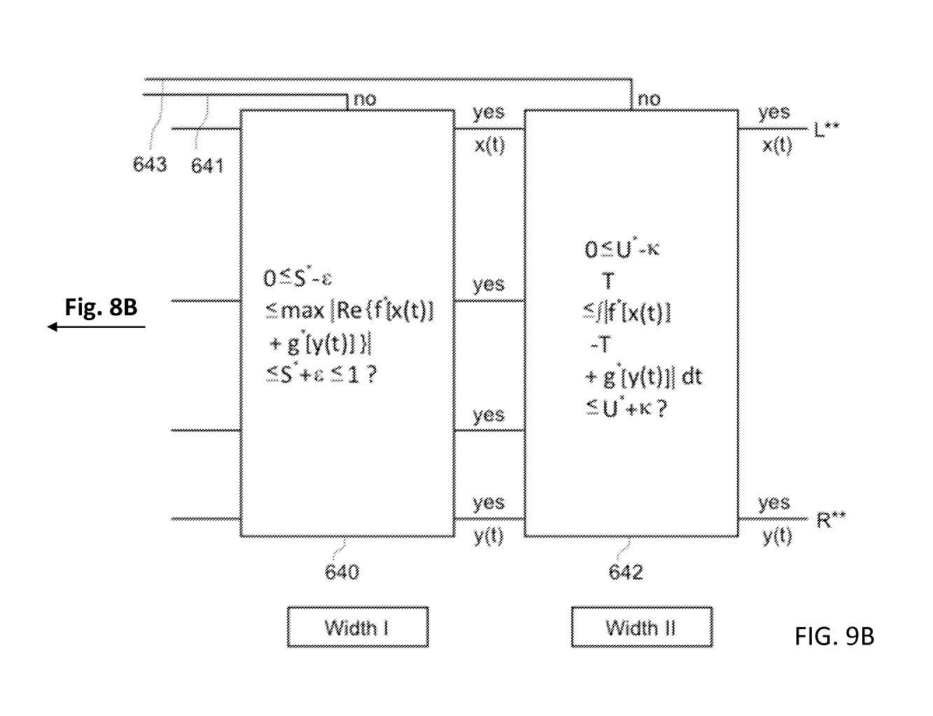

Of particular interest (for example for reproducing stereophonic signals in automobiles) is the subsequent narrowing or expanding of the image width of the stereo signal obtained by using the specific variation of the degree of correlation r of the resulting stereo signal resp. the attenuations λ or else ρ (for forming the resulting stereo signal). The previously determined parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β can be retained in this case, and it makes sense that now only a final amplitude correction is necessary, for example as per the logic element 120 in FIG. 8A, provided that this narrowing or expanding of the image width is performed manually.

If this is to be automated, series of psychoacoustic experiments show that a constant image width for stereophonic output signals x(t), y(t) resp. complex transfer functions thereof

f*[x(t)]=[x(t)/√ 2̅]*(−1+i) (5A)

g*[y(t)]=[y(t)/√ 2̅]*(1+i) (6A)

is essentially dependent on the criterion

0≦S*−ε≦max|Re [symbol] f*[x(t)]+g*[y(t)] [symbol] |≦S*+ε≦1 (7A)

and also on the criterion

$$0 \leq {U}^{*} - κ \leq {\int }_{- T}^{T} \vert \{ {f}^{*} [ x ( t ) ] + {g}^{*} [ y ( t ) ] \} \vert d t \leq {U}^{*} + κ \qquad ( 8 A )$$

(where S* and ε or, respectively, U* and κ need to be stipulated differently for telephone signals, for example, than for music recordings). Accordingly, it is now necessary to determine only suitable function values x(t), y(t) which are dependent on the degree of correlation r of the resulting stereo signal respectively on the attenuations λ or else ρ (for the generation of the resulting stereo signal) resp. on a logic element 120 in FIG. 8A, in accordance with an iterative operating principle which is based on feedback.

The represented arrangement can accordingly be enhanced as follows within the context of an arrangement for example in the form shown in FIG. 8A to 10A:

An output signal resulting from an arrangement as shown in FIG. 1A to 7A is in this case amplified uniformly by a factor ρ* (amplifiers 118, 119 in FIG. 8) such that the maximum of both signals has a level of exactly 0 dB (normalization on the unit circle of the complex number plane). By way of example, this is achieved by the downstream connection of a logic element 120 which varies or corrects the gain factor ρ* of the amplifiers 118 and 119 via the feedback loops 121 and 122 until the maximum level for the left channel resp. for the right channel is 0 dB.

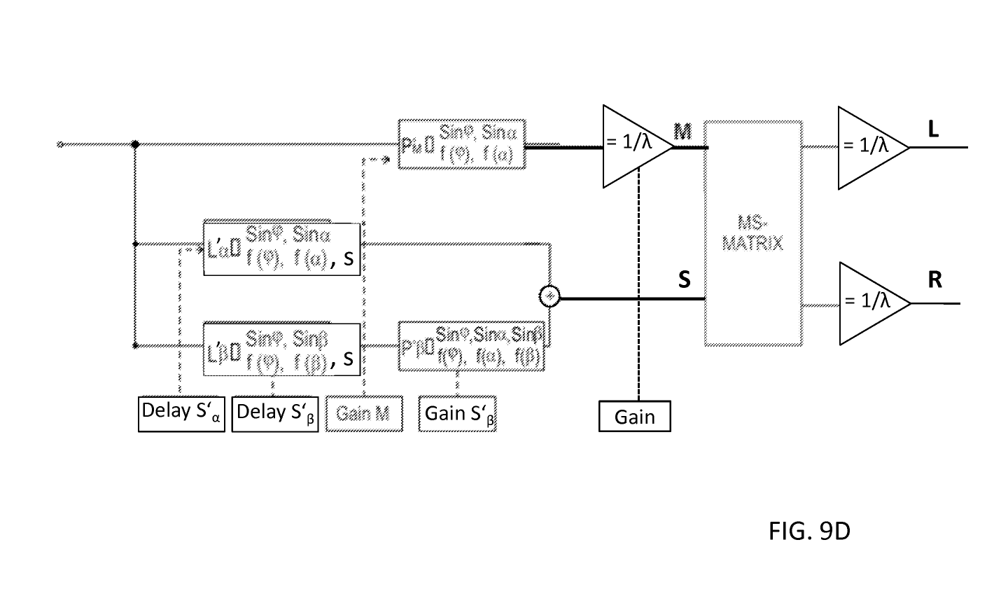

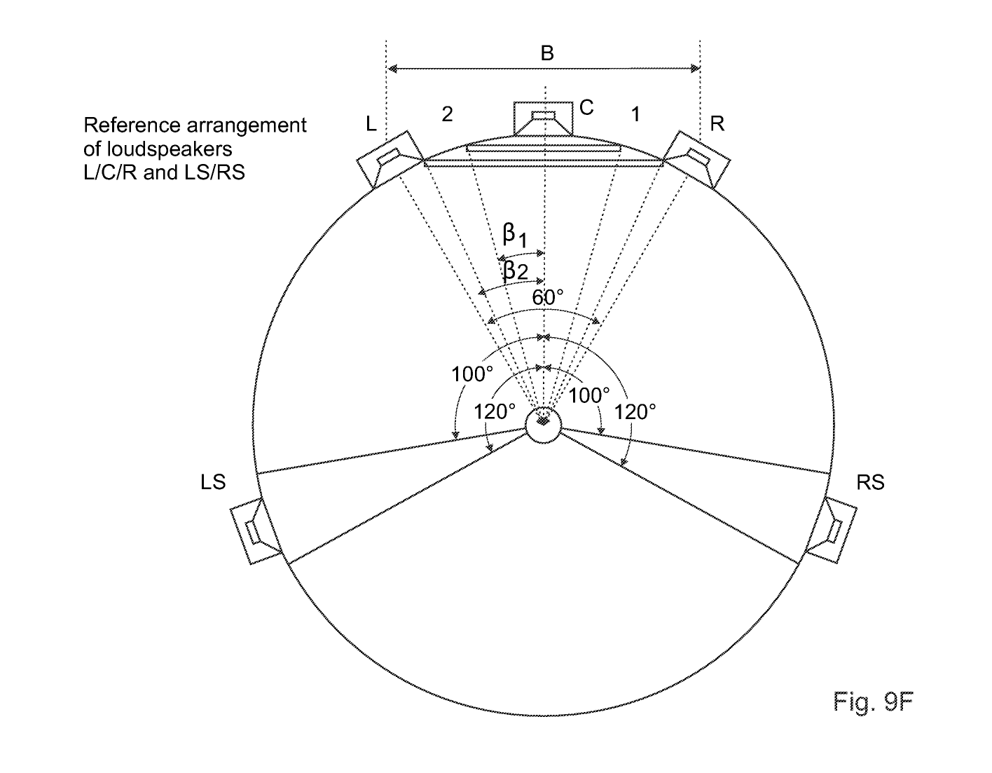

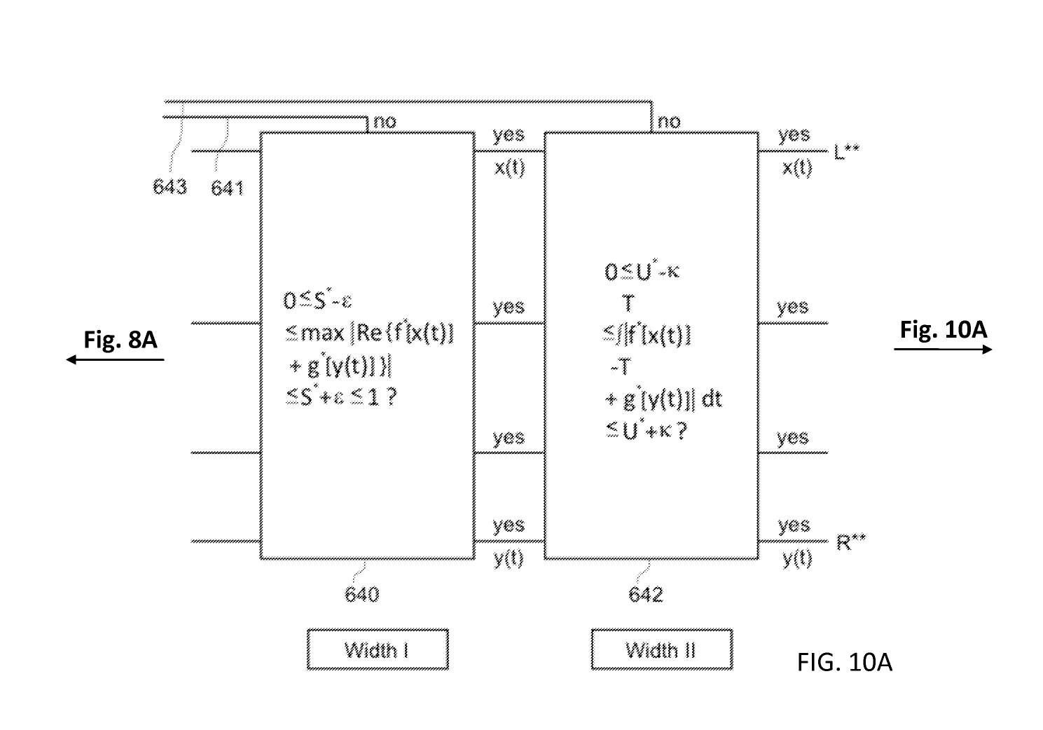

In a further step, the resulting signals x(t) (123) and y(t) (124) are now fed to a matrix in which, following respective amplification by the factor 1/√2 (amplifiers 229, 230 in FIG. 9A), they are split into a respective identical real and imaginary part, with the real part formed from the signal x(t), amplified by means of 229, additionally passing through the amplifier 231 with the gain factor −1. This therefore yields the transfer functions

f*[x(t)]=[x(t)/√2]*(−1+i) (5A)

and

g*[y(t)]=[y(t)/√2]*(1+i) (6A)

The respective real and imaginary parts are now summed and therefore produce the real part resp. the imaginary part of the sum of the transfer functions f*[x(t)]+g*[y(t)].

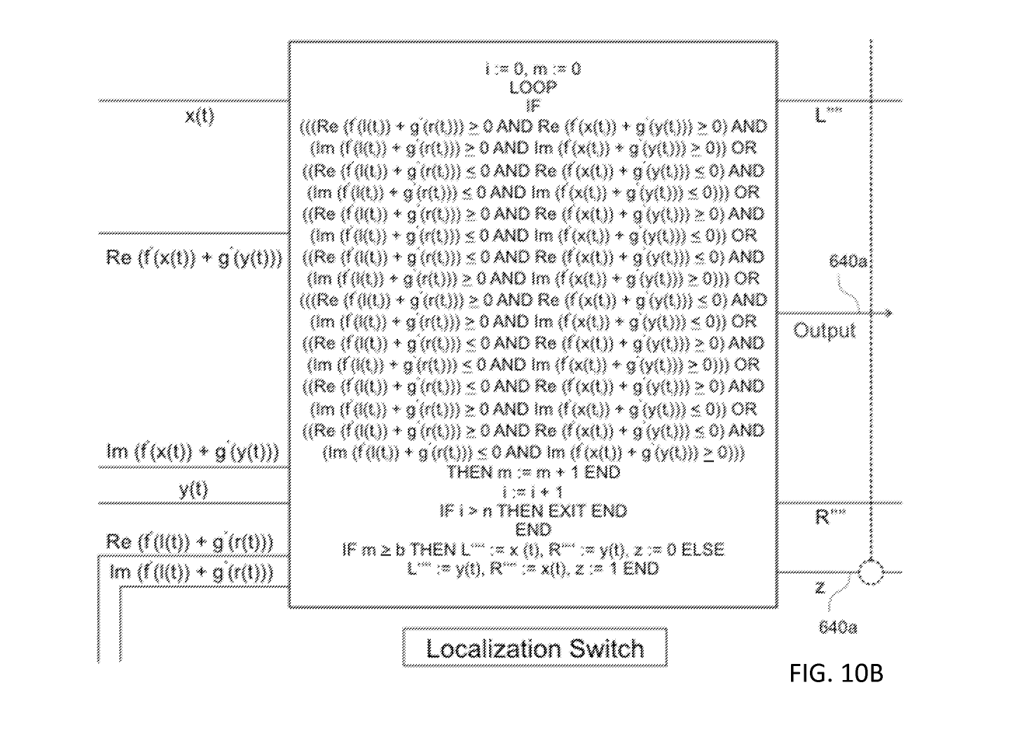

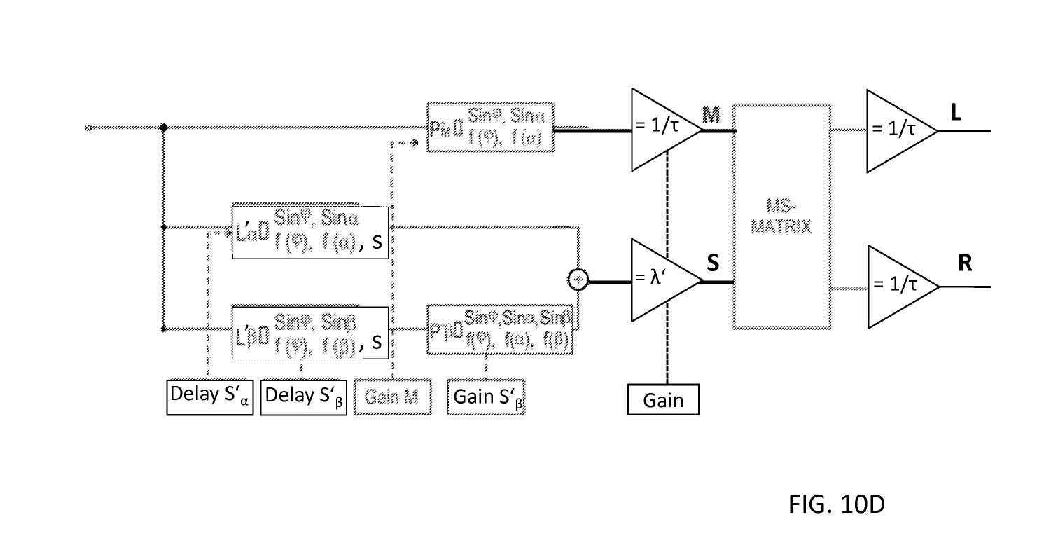

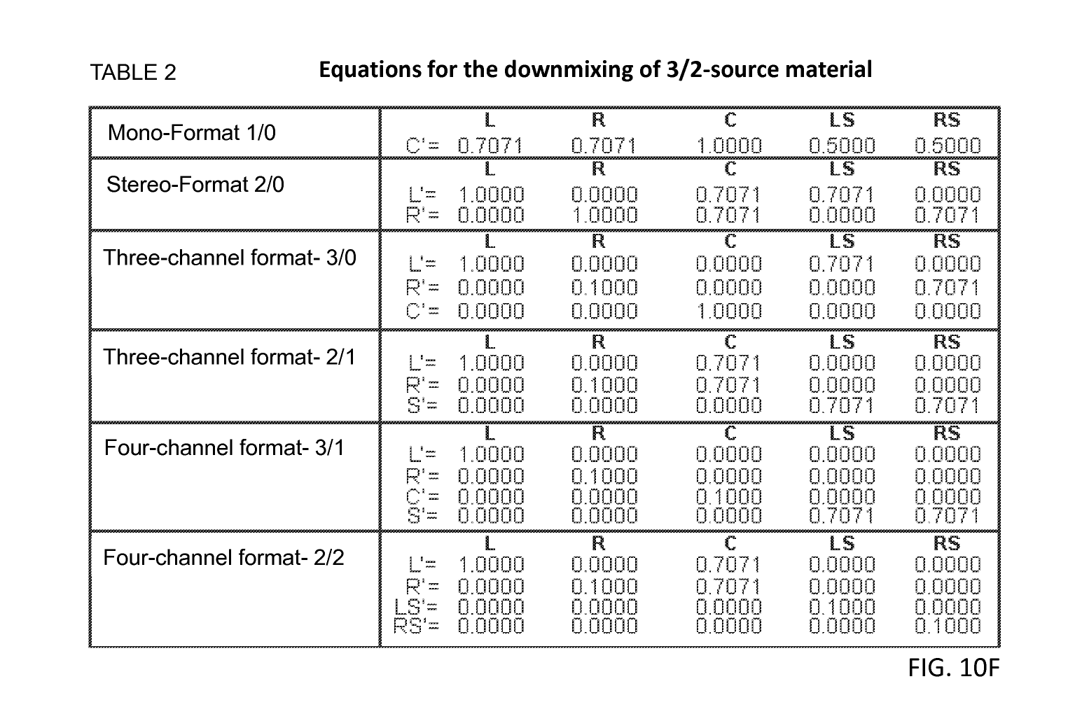

An arrangement, for example based on the logic element 640 in FIG. 10A, now needs to be connected downstream, which arrangement checks, for a limit value S*—suitably selected by the user with respect to the image width of the stereo signal that is to be achieved—or a suitably selected deviation ε—both defined by the inequality (7A)—whether the condition

0≦S*−εmax|Re [symbol] f*[x(t)]+g*[y(t)] [symbol] |≦S*+ε≦1 (7A)

is met. If this is not the case, a feedback loop 641 is used to determine a new optimized value for the degree of correlation r resp. for the attenuations λ or else ρ (for the generation of the resulting stereo signal), and the previous steps just described, as illustrated in FIG. 8A to 10A, are performed until the above condition (7A) is fulfilled.

The input signals for the logic element 640 are now transferred to an arrangement, for example based on the logic element 642 in FIG. 10A. Such arrangement finally analyzes the relief of the function f*[x(t)]+g*[y(t)] for the purpose of optimizing the function values in terms of the image width of the stereo signal that is to be achieved, the user being able to suitably select the limit value U* as well as the deviation κ, both defined by the inequality (8A), with respect to the image width of the stereo signal that is to be achieved. Overall, the condition

0≦U*−κ≦∫|f*[x(t)]+g*[y(t)]|dt≦U*+κ (8A)

must be met. If this is not the case, a feedback loop 643 is used to determine a new optimized value for the degree of correlation r resp. for the attenuations λ or else ρ (for the generation of the resulting stereo signal), and the previous steps just described, as illustrated in FIG. 8A to 10A, are performed until the relief of the function f*[x(t)]+g*[y(t)] satisfies the desired optimization of the function values with respect to the image width taking into account the limit value U* and the deviation κ, both suitably chosen by the user.

In terms of the image width—determined by the degree of correlation r resp. the attenuations λ or else ρ (for the generation of the resulting stereo signal)—the signals x(t) (123) and y(t) (124) therefore correspond to the specifications by the user and represent the output signals L** and R** from the arrangement which has just been described.

The present considerations remain valid as an entity even if a different reference system than the unit circle of the imaginary plane is chosen. By way of example, instead of normalizing function values, it is also possible to normalize the axis length in order to reduce the computation complexity accordingly.

Stipulation of the localisation direction:

Occasionally, it is also important to mirror the stereophonic mapping obtained about the main axis of the directional pattern on which the stereophonic rendition is based, since, for instance, mirror inverted mapping in relation to the main axis occurs. This can be achieved manually by swapping the left channel and the right channel.

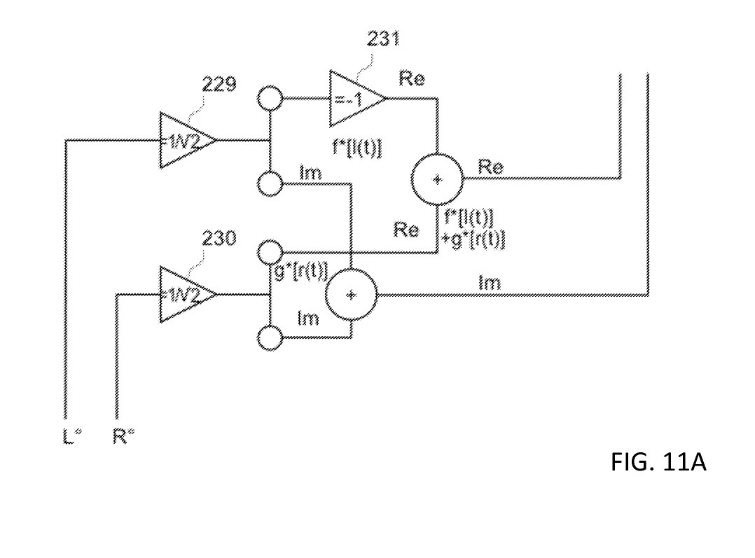

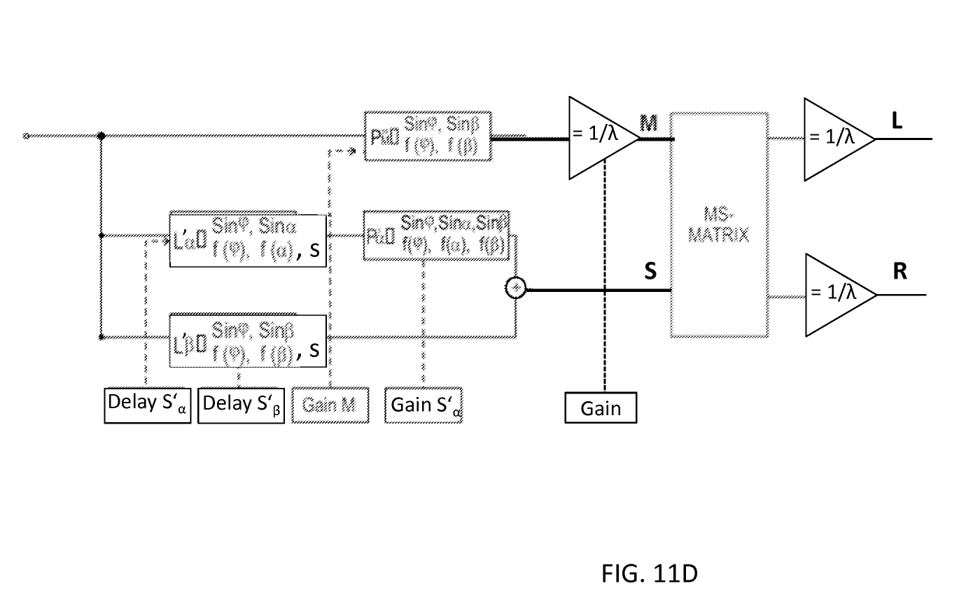

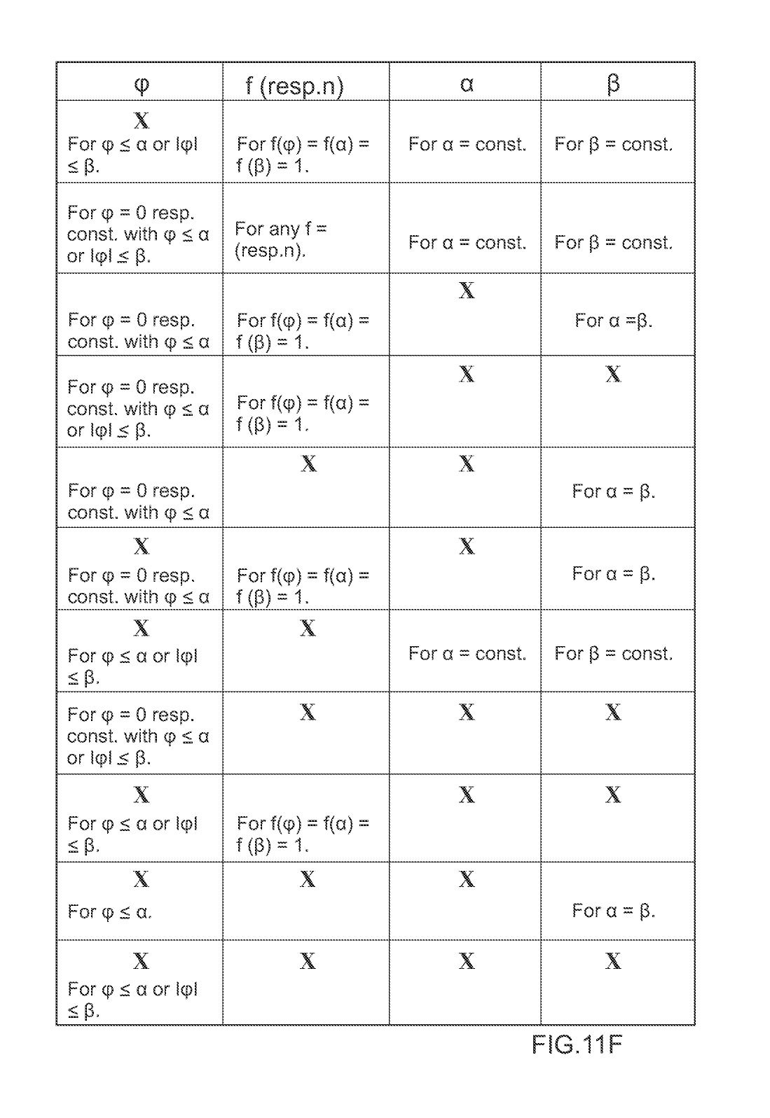

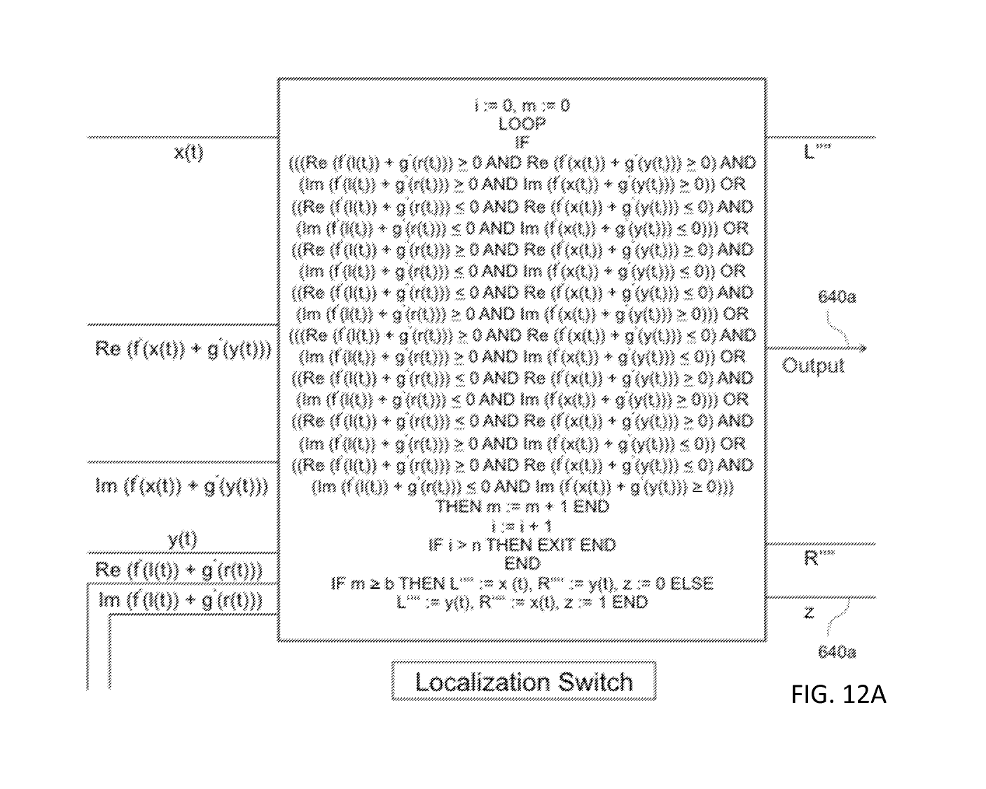

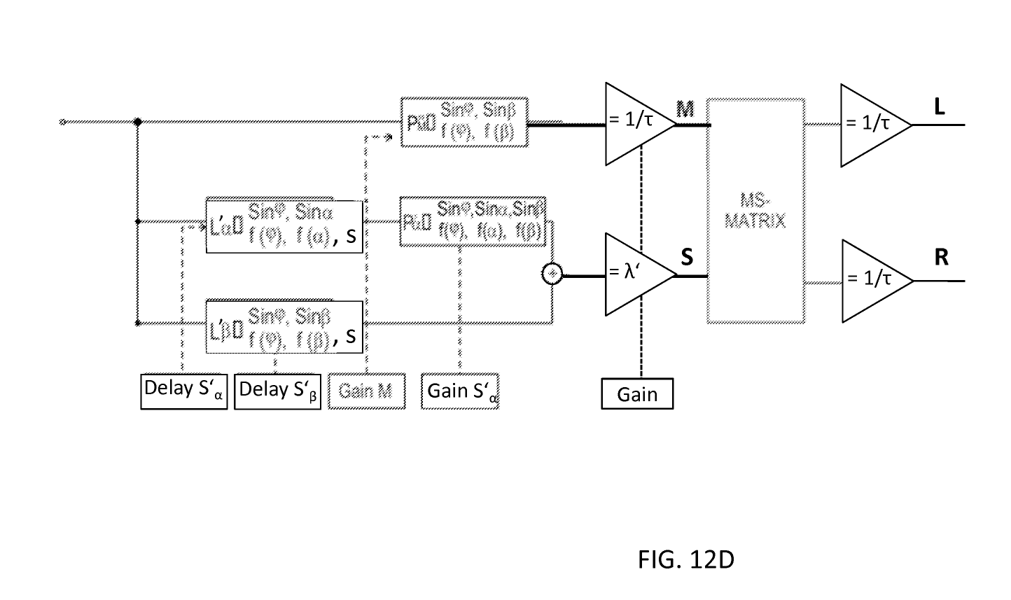

If an already existing stereo signal L^{o}, R^{o} is to be mapped by the present system, the correct localisation direction can also be ascertained automatically by means of the phantom sources generated using the illustrated pseudostereophonic methodology, as is shown by way of example in FIG. 12A (which is directly connected downstream with FIG. 10A, whereas FIG. 11A may likewise be added to FIG. 12A for determining the sum of the complex transfer functions f*(l(tᵢ))+g*(r(tᵢ)) for the already existing stereo signal L^{o}, R^{o}; cf. the explanations relating to FIG. 9A). In this case, at suitably chosen times tᵢ (for which not all of the subsequently cited correlating function values of the transfer functions f*(x(tᵢ))+g*(y(tᵢ) resp. f*(l(tᵢ))+g*(r(tᵢ)) may be equal to zero for at least one case), the already ascertained transfer function f*(x(tᵢ))+g*(y(t_{I})) as shown in FIG. 9A is compared with the transfer function f*(l(tᵢ))+g*(r(tᵢ)) of the left signal l(t) resp. right signal r(t) of the original stereo signal L^{o}, R^{o}. If these transfer functions range in the same quadrant or in the diagonally opposite quadrant of the complex number plane, the total number m of function values from said transfer functions which are located in the same quadrant or in the diagonally opposite quadrant of the complex number plane is increased by 1 in each case.

An empirically (or statistically determined) specifiable number b, which should be less than or equal to the number of correlating function values of the transfer functions f*(x(tᵢ))+g*(y(t_{I}) resp. f*(l(tᵢ))+g*(r(tᵢ)) unequal to zero, now stipulates the number of necessary matches. Below this number, the left channel x(t) and the right channel y(t) of the stereo signal resulting, for example, from an arrangement as shown in FIG. 8A-10A are swapped.

If an originally stereophonic signal is to be encoded into a mono signal plus the function f describing the directional pattern (resp. the simplifying parameter n of said function) and likewise plus the parameters φ, α, β, λ or ρ (for example for the purpose of data compression) (for an exemplary output 640a which may be extended by the parameter z, see below), it makes sense to jointly encode the information regarding whether the resulting left channel and the resulting right channel need to be swapped (for example expressed by the parameter z, which takes the value 0 or 1).

With slight modifications, similar circuits to the circuits shown in FIGS. 11A and 12A can be constructed which can be connected directly downstream with FIG. 3A or 4A or 5A or 6A or 7A or else can be used at another location within the electrical circuit or algorithm.

For obtaining stable FM stereo signals by using WO2011/009649 by way of example for the evaluation of an existing stereo signal which can be reproduced by two or more loudspeakers:

WO2011/009649 is also of particular importance in connection with obtaining stable FM stereo signals under bad reception conditions (for example in automobiles). In this case, it is possible to achieve stable stereophony by simply using the main channel signal (L+R) as an input signal, which is the sum of the left and right channel of the original stereo signal. The complete or incomplete sub-channel signal (L−R), which is the result of subtracting the right channel from the left channel of the original stereo signal, can also be used in this case in order to form a useable S signal or in order to determine or optimize the parameters f (resp. n), which describe the directional pattern of the signal that is to be rendered stereophonic as well as the angle φ that is to be ascertained manually or by metrology and is enclosed by the main axis and the sound source, the fictitious left opening angle α, the fictitious right opening angle β, the attenuations λ or else ρ for the generation of the resulting stereo signal or, resulting therefrom, the gain factor ρ*for normalizing the left channel and the right channel, resulting from the MS matrixing (for example determined in a similar fashion to the logic element 120 as shown in FIG. 8A) or from another arrangement according to the invention on the unit circle (in this case 1 corresponds to the maximum level of 0 dB which has been normalized by using ρ*, where x(t) is the left output signal resulting from this normalization and y(t) is the right output signal resulting from this normalization) or the degree of correlation r of the resulting stereo signal or the parameter a, for example defined by the inequality (9aA) below for defining the admissible range of values for the sum of the transfer functions of the resulting output signals (for example said complex transfer functions

f*[x(t)]=[x(t)/√ 2̅]*(−1+i) (5A)

and

g*[y(t)]=[y(t)/√ 2̅]*(1+i) (6A)

where, for 0≦a≦1 for example the following is true:

Re²{f*[x(t]+g*[y(t)]}*1/a²+Im²{f*[x(t]+g*[y(t)]}≦1) (9aA)

or the limit value R*, defined by the inequality (11aA) below, or the deviation Δ, likewise defined by the inequality (11aA) below for stipulating or maximizing the absolute value of the function values of the sum of these transfer functions (where, for this stipulation or maximization and for the time interval [−T, T] resp. the total number of possible output signals xⱼ(t), yⱼ(t), the following for example is true:

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ xj ( t ) ] \{ {f}^{*} [ xj ( t ) ] , {g}^{*} [ yj ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] - T + {g}^{*} [ y ( t ) ] \} ] \} d t ) \qquad ( 11 aA )$$

or the limit value S* defined above or the deviation 8 defined above (for which, by way of example, it must be true that

0≦S*−εmax|Re [symbol] f*[x(t)]+g*[y(t)] [symbol] |≦S*+ε≦1) (7A)

or the limit value U* defined above or the deviation κ defined above (for which, by way of example, it must be true that

$$0 \leq {U}^{*} - κ \leq {\int }_{- T}^{T} \vert {f}^{*} [ x ( t ) ] + {g}^{*} [ y ( t ) ] \vert d t \leq {U}^{*} + κ ) , \qquad ( 8 A )$$

all for determining the image width of the stereo signal to be achieved, or the localisation direction of the reproduced sound sources in accordance with the arrangement described above. In any case, the result is stereophonic mapping which is constant in respect of the FM signal.

In particular, the use of compression algorithms or data reduction methods which belong to the prior art resp. the analysis of characteristic features, such as the minima or maxima, is also recommended in this case in order to speed up the evaluation of stereophonic or pseudostereophonic signals according to the criteria described above.

Hereinafter, the contents of WO2011/009650 will be reproduced in full for a better understanding of the following examples of application of the present invention:

In the case of the configuration according to WO2009/138205, according to EP1850639 and/or according to WO2011/009649, different parameters may be chosen in the stereo decoder and which are used to generate pseudostereophonic signals. Though often several parameters or several sets of parameters may be used in order to obtain pseudostereophonic audio signals, the choice of such parameters has an impact on the perceived spatial sound image. The choice of the parameters which are optimum in a certain condition or for a particular audio signal is however not trivial.

Furthermore, the adjustment of the parameters also frequently has an impact on the degree of correlation between the left channel and the right channel. In the context of WO2011/009650, however, it has been found that it would make sense to stipulate a uniform degree of correlation for the evaluation of different parameterizations for φ resp. f (resp. the simplifying parameter n), α, β.

An aim therein is to provide a new method and a new device for obtaining pseudostereophonic signals resp. a new method and a new device for automatically and optimally choosing such parameters which form the basis for the generation of stereophonic or pseudostereophonic signals, resp. a method and a device for optimally and automatically determining particularly the parameters (φ, λ, ρ resp. f (resp. n), α, β) while generating said stereophonic or pseudostereophonic signals.

Such a method resp. such a device are intended to be used to select, from a plurality of decorrelated, in particular pseudostereophonic, signal variants, those whose decorrelation is found to be particularly advantageous.

In particular, it should be possible to influence the selection criteria themselves in a form as efficient and compact as possible in order to be able to convert signals of different nature (for example speech in contrast to music recordings) into the optimized reproduction thereof.

According to one aspect, WO2011/009650 proposes a device and a method for obtaining pseudostereophonic output signals x(t) and y(t) by using a stereo decoder, wherein x(t) is the function value of the resulting left output channel at the time t, and y(t) is the function value of the resulting right output channel at the time t, in which the obtainment is iteratively optimized until <x(t), y(t)> is within a predetermined definition range.

If there are dropouts or similar defects, however, an insignificant quantity of single points may lie outside the definition range. In this case, the obtainment is iteratively optimized until a portion of <x(t), y(t)> is within the predetermined definition range.

The desired definition range is preferably stipulated by a single numerical parameter a, where preferably 0≦a≦1. This parameter and hence the definition range can be usefully stipulated for example by the inequality

Re²{f*[x(t]+g*[y(t)]}*1/a²+Im²{f*[x(t]+g*[y(t)]}≦1

wherein the relations

f*[x(t)]=[x(t)/√ 2̅]*(−1+i)

and

g*[y(t)]=[y(t)/√ 2̅]*(1+i)

apply for the complex transfer functions f*[x(t)] and g*[y(t)]} of the output signal x(t), y(t).)

The user can arbitrarily stipulate such a definition range, on the basis of the unit circle of the complex number plane resp. of the imaginary axis (if the maximum level of the output signal x(t), y(t) has been normalized on the unit circle), by using the parameter a, 0≦a≦1.

This principle also remains valid when a reference system other than the unit circle of the complex number plane is chosen and a different new definition range is defined. “Definition range” is therefore understood generally to mean an admissible range of values for <x(t), y(t)> of the output signal x(t), y(t), which, overall, is intended to contain <x(t), y(t)> in full or in part (for example in the case of defective sound recordings which show what are known as dropouts).

In a preferred variant embodiment, the degree of correlation of the output signals (x(t) and y(t)) is normalized. In a preferred variant embodiment, the level of the maximum of the resulting left and right channel is normalized. In this way, certain parameters can be iteratively optimized in order to attain the desired definition range, without said parameters affecting the degree of correlation or the level of the maximum of the resulting left channel and right channel.

It also makes sense if—for extremely different parameterizations for φ resp. f (resp. n), α, β—criteria which are dependent on |<x(t), y(t)>| are used for the stipulation. For this purpose, according to the invention, a corresponding range of values dependent on |<x(t), y(t)>| is normalized, so as to constitute a criterion for the optimization of the parameters.

In one embodiment, a method for obtaining pseudostereophonic output signals x(t) and y(t) by using a converter is therefore proposed, wherein x(t) is the function value of the resulting left output channel at the time t, wherein y(t) is the function value of the resulting right output channel at the time t, wherein the complex transfer functions f*[x(t)] and g*[y(t)] of the output signals are defined:

f*[x(t)]=[x(t)/√ 2̅]*(−1+i)

g*[y(t)]=[y(t)/√ 2̅]*(1+i)

in which the obtaining is iteratively optimized until the following criterion is satisfied:

Re²{f*[x(t]+g/[y(t)]}*1/a²+Im²{f*[x(t]+g*[y(t)]}≦1,

where 0≦a≦1 stipulates the desired definition range.

A remarkable aspect of the methods for obtaining pseudostereophonic signals according to WO2009/138205 or according to EP1850639 is the fact that they always provide a perfect center signal. For this reason, the short time cross correlation

$$r = ( 1 / 2 T ) * {\int }_{- T}^{T} x ( t ) y ( t ) d t * ( 1 / {x ( t )}_{eff} {y ( t )}_{eff} ) \qquad ( 1 B )$$

is introduced here for the time interval [−T, T] and the output signals x(t) from the left channel and y(t) from the right channel.

As already mentioned, it makes sense if a uniform degree of correlation is attained for extremely different parameterizations for φ resp. f (resp. n), α, β. For this purpose, according to the invention, the degree of correlation between the output signals (x(t) and y(t)) is normalized. This normalization can preferably be stipulated by means of the specific variation of λ (left attenuation) or ρ (right attenuation).

On the basis of the uniform degree of correlation, the signal attained can now be systematically subjected to evaluation criteria that can be influenced by the user.

It also makes sense if a uniform level for the maximum of the resulting left and right channel is being attained for extremely different parameterizations for φ resp. f (resp. n), α, β. For this purpose, in the represented system, the level of the maximum of the resulting left and right channel is normalized, so that this level is not influenced by the optimization of the parameters.

It makes sense, for example, for the level control for the maximum of the left signal L and of the right signal R to initially be uniformly confined for example to 0 dB by means of a first logic element.

It also makes sense if—for extremely different parameterizations for φ resp. f (resp. n), α, β—criteria which are dependent on |<x(t), y(t)>| are used for the stipulation. For this purpose, according to the invention, a corresponding range of values is normalized, so as to constitute a criterion for the optimization of the parameters.

x(t) and y(t) are mapped within the unit circle of the complex number plane. The function f*[x(t)]+g*[y(t)] can now be analyzed in more detail in order to draw conclusions concerning the quality of the respective output signal from a device according to WO2009/138205 or EP1850639, for example. Any decorrelation between the two signals f*[x(t)] and g*[y(t)] is in this case equivalent to a deflection on the real axis when analyzing the function f*[x(t)]+g*[y(t)].

The stereo decoder is therefore optimized according to said criteria for example for |Re{f*[x(t)]+g*[y(t)]}| and for |Im{f*[x(t)]+g*[y(t)]}|.

This method has proven itself to be particularly advantageous, since a single parameter, namely a, takes optimum account of, in particular, the different nature of the output signals from a device or a method according to WO/2009/138205 or EP1850639. The parameter may preferably be dependent on the type of the audio signal, for example in order to process speech or music differently on a manual or automatic basis. In the case of speech, unlike music recordings, the definition range determined by the parameter a preferably needs to be restricted significantly due to disturbing artifacts such as high frequency sidetones during the articulation.

In addition, given the limitation to a single parameter a, any optimum function range can be chosen for f*[x(t)]+g*[y(t)] based on the unit circle resp. the imaginary axis.

If the signals x(t), y(t) do not satisfy the aforementioned conditions, the invention involves optimization being carried out by re-determining the parameters φ or f (resp. n) or α or β—according to an iterative procedure that is matched with the function values x[t(φ, f, α, β)] and y[t(φ, f, α, β)] resp. x[t(φ, n, α, β)] and y[t(φ, n, α, β)]—whilst executing steps described so far until x(t) and y(t) meet the aforementioned conditions.

In a further step, the relief of the function f*[x(t)]+g*[y(t)] for example is now analyzed for the purpose of maximizing the function values thereof. It is possible to show that this procedure is equivalent to the maximization of

$${\int }_{- T}^{T} \vert {f}^{*} [ x ( t ) ] + {g}^{*} [ y ( t ) ] \vert d t \qquad ( 6 B )$$

this expression, for its part, remains less than or equal to the value of

$${\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t . \qquad ( 7 aB )$$

In this case too, the user is provided with a tool insofar as he has a free choice of the limit value R* (or the deviation Δ defined by the inequality (8aB), see below) for this maximization within the context of (8aB). Overall, the following condition must be met for the total number of possible signal variants xⱼ(t), yⱼ(t):

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * sin 2 arg \{ {f}^{*} [ x ( t ) ] + {g}^{*} [ y ( t ) ] \} ] \} d t \qquad ( 8 aB )$$

R* and Δ are directly related to the loudness of the output signal that is to be attained (i.e. to those parameters which the listener also takes as a basis for assessing the validity of a stereophonic function).

If the neighborhood of the limit value R*, defined by Δ, or the maximum of all possible integrated reliefs is not reached, optimization in terms of the limit value R* and the deviation Δ or in terms of the aforementioned maximum—in accordance with an iterative procedure that is matched with the function values x[t(φ, f, α, β)] and y[t(φ, f, α, β)] resp. x[t(φ, n, α, β)] and y[t(φ, n, α, β)]—involves new parameters φ resp. f resp. α resp. β being determined, and all steps described so far being executed until signals x(t), y(t) resp. parameters φ resp. λ resp. ρ resp. f (resp. n) resp. α resp. β result, which correspond to optimum stereophonization.

With an appropriate choice of the degree of correlation r, of the parameter a—stipulating the desired respective definition range—and of the limit value R* and also the deviation Δ thereof, it is possible to configure optimum systems for the respective area of application (for example speech or music reproduction) for the respective nature of the input signals.

The present considerations remain valid as an entity even if a different reference system than the unit circle of the imaginary plane is chosen. By way of example, instead of normalizing individual function values, it is also possible to normalize the axis length in order to reduce the computing time accordingly.

According to one aspect, it is recommended practice to use (inherently known) compression algorithms or data reduction methods or to analyze characteristic features such as the minima or maxima for the pseudostereophonic signals obtained according to WO2009/138205 or EP1850639, for the purpose of speeding up the evaluation thereof.

Instead of the proposed analysis of |<x(t), y(t)>|, it is also possible to use |<x(t), y(t)>|² for optimizing the stereophonization. The computational complexity is significantly reduced as a result.

WO2011/009650 can incidentally be applied to devices or methods that generate stereophonic signals which are reproduced by more than two loudspeakers (for example surround sound systems belonging to the prior art).

According to one aspect, WO2011/009650 proposes the cascaded downstream connection of a plurality of means (for example logic elements), some of the parameters of which can be aligned, with a stereo decoder (for example according to WO/2009/138205 resp. EP2124486 or EP1850639), wherein feedback for said devices or methods involves the parameters φ resp. λ resp. ρ resp. f (resp. n) esp. α resp. β being changed in an optimized way until all conditions of the logic elements are met.

These means (logic elements) can incidentally be arranged differently, and can even—with restrictions—be omitted completely or in part.

For a stereo decoder, for example in a device according to WO/2009/138205 or EP1850639—for the case of identical inversely proportional attenuations λ and ρ—optimized parameters φ, λ, f (resp. the simplifying parameter n), α, β are to be determined in order to convert a mono signal into corresponding pseudostereophonic signals which have optimum decorrelation and loudness (the two criteria according to which the listener assesses the quality of a stereo signal). The intent is to achieve such determination with as few technical means as possible.

FIG. 1B shows the circuit principle for the first two logic elements, as described, for normalizing the level and for normalizing the degree of correlation of the output signals from a stereo decoder with an MS matrix 110 (for example a stereo decoder according to WO/2009/138205 or EP1850639), wherein the input signal M and S can (prior to passing through an amplifier connected upstream to the MS matrix) optionally be fed to a circuit according to FIG. 7B, which is optionally and ideally connected downstream to FIG. 10B, and is activated as soon as the parameter z resulting from FIG. 10B has been determined (see below).

The first logic element 120 for normalizing the level is in this case coupled to two identical amplifiers having the gain factor ρ* and ensures a level control, showing the maximum of 0 dB, of the left channel L and the right channel R.

The signals L and R resulting from the arrangement 110 (for example an MS matrix according to WO/2009/138205 or EP1850639) are amplified uniformly by the factor ρ* (amplifiers 118, 119) in such a way that the maximum of both signals has a level of exactly 0 dB (normalization on the unit circle of the complex number plane). This is achieved for example by the downstream connection of a logic element 120 which uses the feedbacks 121 and 122 and variation or correction of the gain factor ρ* of the amplifiers 118 and 119 to cause a level control of the maximum value of L and R to reach 0 dB.

The resulting stereo signals x(t) (123) and y(t) (124), the amplitudes of which are directly proportional to L and R, are fed in a second step to a further logic element 125 which determines the degree of correlation r by using the short time cross relation:

$$r = ( 1 / 2 T ) * {\int }_{- T}^{T} x ( t ) y ( t ) d t * ( 1 / {x ( t )}_{eff} {y ( t )}_{eff} {y ( t )}_{eff} ) \qquad ( 1 B )$$

r can be stipulated by the user in the interval −1≦r≦1 and ideally ranges in the interval 0.2≦r≦0.7.

Any deviation from r results in optimized adjustment of the gain factor λ of the amplifier 117 for the S signal via the feedback 126.

The resulting signals L and R again pass through the amplifiers 118 and 119 and also the logic element 120, which in turn causes a fresh level control of the maximum value of L and R to reach 0 dB again via the feedbacks 121 and 122, and said signals are then fed to the logic element 125 again.

This procedure is performed in an optimized way until the degree of correlation r stipulated by the user has been attained.

The result is a stereo signal x(t), y(t) normalized in relation to the unit circle of the complex number plane.

FIG. 2B clarifies the circuit principle which maps the input signals x(t), y(t) on the complex number plane resp. determines the argument of the sum thereof f*[x(t)]+g*[y(t)]. With this circuit, the resulting signals x(t) and y(t) from the output of FIG. 1B are fed to a matrix in which, following respective amplification by the factor 1/√ 2̅ (amplifiers 229, 230), said signals are broken down into respective identical real and imaginary parts, with the real part formed from the signal x(t), amplified by means of 229, additionally passing through the amplifier 231 with the gain factor −1. Therefore, the transfer functions:

f*[x(t)]=[x(t)/√ 2̅]*(−1+i) (2B)

and

g*[y(t)]=[y(t)/√ 2̅]*(1+i). (3B)

are obtained.

The respective real and imaginary parts are now summed and therefore produce the real part and the imaginary part of the sum of the transfer functions f*[x(t)]+g*[y(t)].

The element 232 determines the argument for f*[x(t)]+g*[y(t)].

FIG. 3B enables the definition range to be selected by means of the parameter a, 0≦a≦1, wherein continuous regulation is made possible by means of the parameter a, on the basis of the unit circle of the complex number plane resp. of the imaginary axis. The user can therefore freely determine the definition range determined by the parameter a on the complex number plane within the unit circle. For this, the squared real part (333a) and the squared imaginary part (334a) of f*[x(t)]+g*[y(t)] are calculated. The signal resulting from 333a is then fed to an amplifier 335a and is amplified by the gain factor 1/a² freely selectable by the user. Additionally, the squared sine of the argument of the sum of the transfer functions f*[x(t]+g*[y(t)] is calculated.

FIG. 4B, which is to be connected downstream at the output of FIG. 3B, shows the circuit principle for a new third logic element, which checks the signals generated in FIG. 1B and mapped on the complex number plane according to FIG. 2B, according to the condition

Re²{f*[x(t]+g*[y(t)]}*1/a²+Im²{f*[x(t]+g*[y(t)]}≦1 (4aB)

The squared real part and squared imaginary part of the sum of the transfer functions f*[x(t)]+g*[y(t)] and the signals resulting from 334a and 335a are in this case fed to a further logic element 436a, which checks whether the above criterion is satisfied, hence whether the values of the sum of the transfer functions f*[x(t)]+g*[y(t)] are within the new range of values defined by the user by means of a.

If this is not the case, a feedback 437a is used to determine new optimized values φ resp. f (resp. n) resp. α resp. β, and the entire system described so far is passed through again until the values of the sum of the transfer functions f*[x(t)]+g*[y(t)] are within the new range of values defined by the user by means of a. The output signals for the logic element 436a are now transferred to the last logic element 538a (FIG. 5B).

The latter finally analyzes the relief of the function f*[x(t)]+g*[y(t)] for the purpose of maximizing the function values, wherein the user has a free choice of limit value R* determined by the inequality (8aB) (and of deviation Δ, likewise determined by the inequality (8aB)) for this maximization. Overall, the condition:

$$0 \leq {R}^{*} - Δ \leq {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t \qquad ( 8 aB )$$

must be met. If this is not the case, a feedback 539a is used to iteratively determine new optimized values φ resp. f (resp. n) resp. α resp. β, and the entire system described so far is passed through again until the relief of the function f*[x(t)]+g*[y(t)] satisfies the desired maximization of the function values taking into account the limit value R* resp. the deviation Δ, both defined by the user.

Hence, the original pseudostereo decoder, for example according to one of the embodiments in WO/2009/138205 or EP1850639 (in this case assuming the instance of identical inversely proportional attenuations λ and ρ), is used to iteratively determine new parameters φ resp. f (resp. n) resp. α resp. β until x(t) and y(t) meet the aforementioned conditions (4aB) and (8aB).

In terms of compatibility (determined by the selectable degree of correlation r), definition range (determined by the selectable gain factor a) and loudness (determined by the selectable limit value R* resp. the selectable deviation Δ), the signals x(t) (123) and y(t) (124) therefore correspond to the selections by the user and are the output signals L and R*from the arrangement described.

Stipulation of the localisation direction:

Occasionally, it is also important to mirror the stereophonic function obtained about the main axis of the directional pattern on which the stereophonic processing is based, since for example mirror inverted mapping in relation to the main axis occurs. This can be achieved manually by swapping the left channel and the right channel.

If an already existing stereo signal L^{o}, R^{o} is to be mapped by the present system, the correct localisation direction can also be ascertained automatically by means of the phantom sources generated using the illustrated pseudostereophonic methodology, as is shown by way of example in FIG. 10B (which is directly connected downstream to FIG. 5B, wherein FIG. 6B may likewise be added to FIG. 10B for determining the sum of the complex transfer functions f*(l(tᵢ))+g*(r(tᵢ)) for the already existing stereo signal L^{o}, R^{o}). In this case, at suitably chosen times tᵢ (for which not all of the subsequently cited correlating function values of the transfer functions f*(x(tᵢ))+g*(y(tᵢ) resp. f*(l(tᵢ))+g*(r(tᵢ)) may be equal to zero for at least one case), the already ascertained transfer function f*(x(tᵢ))+g*(y(t_{I})) as shown in FIG. 2B is compared with the transfer function f*(l(tᵢ))+g*(r(tᵢ)) of the left signal l(t) resp. of the right signal r(t) of the original stereo signal L^{o}, R^{o} (which transfer function is ascertained by using the circuit shown in FIG. 6B, the design of which corresponds to the first part of the circuit for the input signals x(t), y(t) in FIG. 2B). If these transfer functions range in the same quadrant or in the diagonally opposite quadrant of the complex number plane, the total number m of the function values from the cited transfer functions which are located in the same quadrant or in the diagonally opposite quadrant of the complex number plane is increased by 1 in each case.

An empirically (or statistically determined) specifiable number b, which should be less than or equal to the number of correlating function values of the transfer functions f*(x(tᵢ))+g*(y(t₁) resp. f*(l(tᵢ))+g*(r(tᵢ)) unequal to zero, now stipulates the number of necessary matches. Below this number, the left channel x(t) and the right channel y(t) of the stereo signal resulting for example from an arrangement as shown in FIG. 1B, 2B, 3B to 5B are swapped.

If an originally stereophonic signal is to be encoded into a mono signal plus the function f describing the directional pattern (resp. the simplifying parameter n of said function) and likewise the parameters φ, α, β, λ or ρ (for example for the purpose of data compression) (for an exemplary output 640a which may be enhanced by the parameter z, see below), it makes sense to jointly encode the information regarding whether the resulting left channel is to be swapped with the resulting right channel (for example expressed by the parameter z, which takes the value 0 or 1, and, if desired, can simultaneously activate a circuit as shown in FIG. 7B).

With slight modifications, similar circuits to the circuits shown in FIGS. 6B and 10B can be constructed which can also be used at another location within the electrical circuit or algorithm.

For narrowing or expanding the image width:

For this application too, the additional use of prior art compression algorithms or data reduction methods or the analysis of characteristic features, such as the minima or maxima for the pseudostereophonic signals obtained is recommended in order to speed up evaluation thereof in accordance with the invention.

Of particular interest (for example for reproducing stereophonic signals in automobiles) is the subsequent narrowing or expanding of the image width of the stereo signal obtained by using the specific variation of the degree of correlation r of the resulting stereo signal resp. the attenuations λ or else ρ (for forming the resulting stereo signal). The previously determined parameters f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β can be retained in this case, and it makes sense that now only a final amplitude correction is necessary, for example as per the logic element 120 in FIG. 1B, provided that this narrowing or expanding of the image width is performed manually.

If this is to be automated, series of psychoacoustic experiments show that a constant image width is essentially dependent on the criterion

0≦S*−ε≦max|Re [symbol] f*[x(t)]+g*[y(t)] [symbol] |≦S*+ε≦1 (9B)

as well as on the criterion

$$0 \leq {U}^{*} - κ \leq {\int }_{- T}^{T} \vert \{ {f}^{*} [ x ( t ) ] + {g}^{*} [ y ( t ) ] \} \vert d t \leq {U}^{*} + κ \qquad ( 10 B )$$

(where S* and ε resp. U* and κ need to be stipulated differently for telephone signals, for example, than for music recordings). Accordingly, it is now necessary to determine only suitable function values x(t), y(t) which are dependent on the degree of correlation r of the resulting stereo signal respectively on the attenuations λ or else ρ (for the generation of the resulting stereo signal) or, where necessary, on a logic element which is identical to the logic element 120 in FIG. 1B, in accordance with an iterative operating principle which is based on feedback.

The arrangement according to FIG. 1B, 2B, 3B to 5B, 6B, 10B can accordingly be enhanced within the context of an arrangement, for instance, of the form shown in FIG. 7B, 8B and/or 9B. FIG. 7B in this case shows a further example of a circuit for normalizing stereophonic or pseudostereophonic signals which, when connected downstream to FIG. 10B, is activated as soon as the parameter z is present as an input signal. In this case, the initial value of the gain factor λ corresponds to the final value of the gain factor λ in FIG. 1B when the parameter z is transferred, and the input signals in FIG. 1B are transferred directly as input signals to FIG. 7B at the time of this transfer.

The circuits shown in FIG. 7B to 9B can incidentally also be used autonomously in other circuits or algorithms.

In the present arrangement, the left channel and the right channel are swapped in the MS matrix 110 by using a logic element 110a (which also activates this MS matrix as soon as the parameter z is present as an input signal), provided that the parameter z is equal to 1, otherwise such a swap does not take place.

The resulting output signals L and R from the MS matrix 110 are now amplified (amplifiers 118, 119) uniformly by the factor ρ* such that the maximum of both signals has a level of exactly 0 dB (normalization on the unit circle of the complex number plane). This is achieved for example by the downstream connection of a logic element 120 which uses the feedbacks 121 and 122 and variation resp. correction of the gain factor ρ* of the amplifiers 118 and 119 to cause a level control of the maximum value of L and R to reach 0 dB.

In a further step, the resulting signals x(t) (123) and y(t) (124) are now fed to a matrix as shown in FIG. 8B in which, following respective amplification by the factor 1/√2 (amplifiers 229, 230), they are split into respective identical real and imaginary parts, with the real part formed from the signal x(t), amplified by means of 229, additionally passing through the amplifier 231 with the gain factor −1. The complex transfer functions f*[x(t)]+g*[y(t)] already mentioned in connection with FIG. 2B are thus obtained. The respective real and imaginary parts are now summed and thus result in the real part and the imaginary part of the sum of the transfer functions f*[x(t)]+g*[y(t)].

An arrangement, for example based on the logic element 640 in FIG. 9B, now needs to be connected downstream, which arrangement checks, for a limit value S*—suitably chosen by the user with respect to the image width of the stereo signal that is to be attained—or a suitably chosen deviation ε—both defined by the inequality (9B)—whether the condition

0≦S*−ε≦max|Re [symbol] f*[x(t)]+g*[y(t)] [symbol] |≦S*+ε≦1 (9B)

is met. If this is not the case, a feedback 641 is used to determine a new optimized value for the degree of correlation r resp. for the attenuations λ or else ρ (for the generation of the resulting stereo signal), and the previous steps just described, as illustrated in FIGS. 7B to 9B, are performed until the above condition (9B) is fulfilled.

The output signals for the logic element 640 are now transferred to an arrangement, for example based on the logic element 642 in FIG. 9B. This arrangement finally analyzes the relief of the function f*[x(t)]+g*[y(t)] for the purpose of optimizing the function values in terms of the image width of the stereo signal that is to be achieved, the user being able to suitably select the limit value U* and the deviation κ, both defined by the inequality (10B), with respect to the image width of the stereo signal that is to be achieved. Overall, the condition:

0≦U*−κ≦∫|f*[x(t)]+g*[y(t)]|dt≦U*+κ (10B)

must be met. If this is not the case, a feedback 643 is used to determine a new optimized value for the degree of correlation r resp. for the attenuations λ or else ρ (for the generation of the resulting stereo signal), and the previous steps just described, as illustrated in FIGS. 7B to 9B, are performed until the relief of the function f*[x(t)]+g*[y(t)] satisfies the desired optimization of the function values with respect to the image width taking into account the limit value U* and the deviation κ, both suitably chosen by the user.

In terms of the image width—determined by the degree of correlation r resp. the attenuations λ or else ρ (for the generation of the resulting stereo signal)—the signals x(t) (123) and y(t) (124) therefore correspond to the selections by the user and represent the output signals L** and R** from the arrangement which has just been described.

The arrangement just described, or portions of this arrangement, can be used as an encoder for a full-fledged stereo signal that is limited to a mono signal plus the parameters φ, f (resp. the simplifying parameter n), α, β, λ resp. ρ).

An already existing stereo signal can be evaluated in respect of r resp. a resp. R* resp. Δ resp. the localisation direction (resp. parameters S* resp. ε resp. U* resp. κ described below) and can then likewise be encoded anew as a mono signal by using the parameters φ, f (resp. n), α, β, λ resp. ρ in view of a device or a method according to WO/2009/138205 or EP1850639.

Similarly, the arrangement just described, to which the elements below may possibly be added, can be used as a decoder for mono signals. If φ, f (resp. n), α, β, λ resp. ρ resp. the localisation direction (for example expressed by the parameter z, which can assume the value 0 or 1) are known, such a decoder is reduced to an arrangement according to WO2009/138205 or EP1850639 or WO2011/009649 or WO2011/009650.

Overall, such encoders or decoders can be used wherever audio signals are recorded, transduced/converted, transmitted or reproduced. They provide an excellent alternative to multichannel stereophonic techniques.

Specific areas of application are telecommunications (hands-free devices), global networks, computer systems, broadcasting and transmission devices, particularly satellite transmission devices, professional audio technology, television, film and broadcasting and also electronic consumer goods.

The invention is also of particular importance in connection with the obtaining of stable FM stereo signals under bad reception conditions (for example in automobiles). In this case, it is possible to achieve stable stereophony by simply using the main channel signal (L+R) as an input signal, which is the sum of the left channel and of the right channel of the original stereo signal. The complete or incomplete sub-channel signal (L−R), which is the result of subtracting the right channel from the left channel of the original stereo signal, can also be used in this case in order to form a useable S signal resp. in order to determine or optimize the parameters f (resp. n), which describe the directional pattern of the signal that is to be rendered stereophonic, the angle φ—to be ascertained manually or by metrology—enclosed by the main axis and the sound source, the fictitious left opening angle α, the fictitious right opening angle β, the attenuations λ or else ρ for the generation of the resulting stereo signal or, resulting therefrom, the gain factor ρ* of FIG. 1B for normalizing the left and right channel, resulting from the MS matrixing or from another arrangement according to the invention, on the unit circle (in this case 1, for example, corresponds to the maximum level of 0 dB which has been normalized by using ρ*, where x(t) is the left output signal resulting from this normalization and y(t) is the right output signal resulting from this normalization) or the degree of correlation r of the resulting stereo signal or the gain factor a for defining the admissible range of values for the sum of the transfer functions of the resulting output signals (for example the complex transfer functions

f*[x(t)]=[x(t)/√ 2̅]*(−1+i) (2B)

and

g*[y(t)]=[y(t)/√ 2̅]*(1+i), (3B)

where, for 0≦a≦1, for example, the following is true:

Re²{f*[x(t]+g*[y(t)]}*1/a²+Im²{f*[x(t]+g*[y(t)]}≦1) (4aB)

or the limit value R* or the deviation Δ for stipulating or maximizing the absolute value of the function values of the sum of these transfer functions (where, for this stipulation or maximization and for the time interval [−T, T] resp. the total number of possible output signals xⱼ(t), yⱼ(t), the following for example is true:

$$0 \leq {R}^{*} - Δ {\int }_{- T}^{T} \vert {f}^{*} [ x ( t ) ] + {g}^{*} [ y ( t ) ] \vert d t \leq max {\int }_{- T}^{T} \vert {f}^{*} [ {x}_{j} ( t ) ] \{ {f}^{*} [ {x}_{j} ( t ) ] , {g}^{*} [ {y}_{j} ( t ) ] \} ∈ Φ + {g}^{*} [ {y}_{j} ( t ) ] \vert d t \leq {R}^{*} + Δ \leq {\int }_{- T}^{T} a * \{ 1 / √ [ 1 - ( 1 - {a}^{2} ) * {sin}^{2} arg \{ {f}^{*} [ x ( t ) ] + {g}^{*} [ y ( t ) ] \} ] \} d t ) \qquad ( 8 aB )$$

or the localisation direction of the reproduced sound sources, for example by determining the corresponding quadrants for the function values of the sum, determined for example according to FIG. 6B, of the transfer functions for the left and right channel of the original stereo signal (which can be optimized for example by virtue of subsequent swapping of the resulting left resp. right channel, see above), or the limit value S* or the deviation ε (for which, by way of example, it must be true that

0≦S*−ε≦max|Re [symbol] f*[x(t)]+g*[y(t)] [symbol] |≦S*+ε≦1) (9B)

or the limit value U* or the deviation κ (for which, by way of example, it must be true that

$$0 \leq {U}^{*} - κ \leq {\int }_{- T}^{T} \vert {f}^{*} [ x ( t ) ] + {g}^{*} [ y ( t ) ] \vert d t \leq {U}^{*} + κ ) , \qquad ( 10 B )$$

all for determining resp. optimizing the image width of the stereo signal to be attained. In any case, the result is stereophonic function which is constant in respect of the FM signal.

In this case too, it is additionally possible to use prior art compression algorithms, data reduction methods or the analysis of characteristic features, such as the minima and maxima, in order to speed up the evaluation of existing or obtained signals or signal components.

In each embodiment and in each figure resp. each element, the circuits, converters, arrangements or logic elements described can be implemented for example by equivalent software programs and programmed processors or DSP or FPGA solutions.

### List of Symbols Used

φ (phi) angle of incidence
α (alpha) left fictitious opening angle
β (beta) right fictitious opening angle
λ attenuation for the left input signal
ρ attenuation for the right input signal
   The attenuations λ and ρ can be used to adjust the degree of correlation of the stereo signal.
ψ polar angle
f polar distance, which describes the directional pattern of the M signal
P_{α}, P_{β} gain factor for α resp. β
L_{α}, L_{β} time difference for α resp. β s,
S_{α} simulated left signal component of the S signal
S_{β} simulated right signal component of the S signal
x(t) left output signal
y(t) right output signal
f*[x(t)] complex transfer function
g*[y(t)] complex transfer function
a gain factor for the definition of the admissible range of values for the sum of the transfer functions of the resulting output signals x(t), y(t)
r degree of correlation, derived from the short-time cross correlation
R* limit value for the loudness of the resulting output signals x(t), y(t)
Δ deviation
S* 1^{st} limit value for the image width of the resulting output signals x(t), y(t)
ε deviation
U* 2^{nd} limit value for the image width of the resulting output signals x(t), y(t)
κ deviation

CH01264/10 resp. PCT/EP2011/063322, at the time of the present application, have not been published. Hereinafter, their contents will therefore be reproduced in full for a better understanding of the following examples of application of the present invention:

CH01264/10 resp. PCT/EP2011/063322 also relate to signals (for example audio signals) and devices or methods for generating, transmitting, processing, converting and reproducing them—and relate in particular to a method and a device or a system allowing conclusions to be drawn on the basis of any mapping or mappings of one or more signals or also of a combination or combinations of two or more signals. In the exemplary case of a stereophonic audio signal x(t), y(t), where x(t) represents the function value of the left input signal at the point in time t, y(t) represents the function value of the right input signal at the point in time t, it is possible to observe for example the sum of the transfer functions

f*[x(t)]=[x(t)/√ 2̅]*(−1+i)

g*[y(t)]=[y(t)/√ 2̅]*(1+i)

in order to be able to draw conclusions as to the properties of the signals.

These conclusions should be reachable in particular on the basis of common properties of two different signals that appear to be completely random (such as for example audio signals).

Methods so far have attempted—with comparably great difficulty—to simulate this randomization principle and thus make it useful for the signals being analyzed. For example in the case of DAB (Digital Audio Broadcasting), a Gaussian process is simulated with a so-called Tapped Delay Line model or a Monte Carlo method (colored, complex Gaussian noise in two dimensions) is also used for the simulation of the mobile radio channel.

Altogether, it can be said about the state of the art that algebraic invariants so far, given the lack of corresponding basis, have never been used for analyzing or optimizing sound events or similar processes.

Although it has been generally presumed for over 100 years since David Hilbert's groundbreaking work on algebraic invariants that such algebraic invariants exist in particular for Gaussian processes (an in particular for audio signals), it was never successfully proven.

Not only do CH01264/10 resp. PCT/EP2011/063322 demonstrate such algebraic invariants, the latter are thus made practically usable commercially for signal technology, for example for calibrating devices or methods for obtaining, improving or optimizing stereophonic or pseudostereophonic audio signals.

In CH01264/10 resp. PCT/EP2011/063322, one first analyzes a combination f̂(t) or several combinations f₁̂(t), f₂̂(t), . . . , fₚ̂(t) of at least two signals s₁(t), s₂(t), . . . , sₙ(t) resp. of their transfer functions t₁(s₁(t)), t₂(s₂(t)), . . . , tₘ(sₘ(t))—or also the freely definable function f₁^{#}(t) or the freely definable functions f₁^{#}(t), f₂^{#}(t), . . . , f_{μ}^{#}(t) of one signal s^{#}(t) or several signals s₁^{#}(t), s₂^{#}(t), . . . , s_{Ω}^{#}(t)—on the complex number plane resp. their projection on the relief defined by the norm of all points of the complex number plane (the standard cone whose tip lies in the origin of the complex number plane and whose axis of symmetry is perpendicular to the complex number plane).

The real axis, the imaginary axis and the axis of symmetry of the cone are henceforth represented as a Cartesian coordinate system with coordinates (x₁, x₂, x₃). The change in the opening angle of the circle yields the cone equation

x₁²+x₂²−(1/g*²)*x₃=0

resp. the coefficients [1 1 −1/g*²]. Two cone equations are now analyzed:

S:=aₓ²:=1*x₁²+1*x₂²−(1/g²)*xⱼ²=0

and

S′:=a′ₓ²=1*x₁²+1*x₂²−(1/g′)*xⱼ²=0.

As known, one invariant is thus

a_{a′}²:=1*1²+1*1²−(1/g²)*(1/g′⁴).

Both cones S, S′ are non polar if

(1/g²)*(1/g′⁴)=2.

S is then inscribed harmonically in S′.

If, for example, one analyzes the above combination f̂(t) or several combinations f₁̂(t), f₂̂(t), . . . , fₚ̂(t) of two or more signals s₁(t), s₂(t), . . . , sₘ(t) resp. of their transfer functions t₁(s₁(t)), t₂(s₂(t)), . . . , tₘ(sₘ(t)) for two time intervals t₁, t₂—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for two time intervals t₁, t₂—as well as the functions S, S′ and Σ′ with

$${Σ}^{′} := {u}_{{a}^{′}}^{2} := {A}^{′} {u}_{1}^{2} + {B}^{′} {u}_{2}^{2} + {C}^{′} {u}_{3} 2 + 2 {F}^{′} {u}_{2} {u}_{3} + 2 {G}^{′} {u}_{3} {u}_{1} + 2 {H}^{′} {u}_{1} {u}_{2} = 1 * {u}_{1}^{2} + 1 * {u}_{2}^{2} + ( 1 / {g}^{″ 2} ) * {u}_{3}^{2} + 2 * 1 * {u}_{2} {u}_{3} + 2 * 1 * {u}_{3} {u}_{1} + 2 * 1 * {u}_{1} {u}_{2} = 0.$$

The following is true

aA′+bB′+cC′+2fF′+2gG′+2hH′=0,

and S and Σ′ should be non polar:

1*1+1*1−(1/g²)*(1/g″²)=0

or

(1/g²)*(1/g″²)=2.

Thus, provided g′=g″=1 and g=1/√2 applies, the non-polarity of S with S′ and Σ′ is ensured.

Considering the standard cone

S′=1*x₁²+1*x₂²−1*x₃²=0

thus simultaneously enables the analysis of identical vanishing invariants relative to S

S=1*x₁²+1*x₂²−2*x₃²=0

resp.

$${Σ}^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

The relation

a_{a′}²:=1*1²+1*1²−2*1²=0

is thus linear in the coefficients of the equations

S=1*x₁²+1*x₂²−2*x₃²=0

and

$${Σ}^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

According to Hilbert's famous theorem on invariants (Hilbert, page 291, §2), in our system, the linear combination

φ[1,1,2]*[1,1,−1]²+Θ[1,1,−2]*[1,1,1]²=0

in turn represents an invariant. Thus, for example, any piercing straight lines of f̂(t₁) and f̂(t₂), considered on the plane spanned by the vectors (1, 1, −2) and (1, 1, 1), ξ₁ and ξ₂, correspond to an infinite number of invariants of S and S′ resp. of S and Σ′.

When considering the standard cone reflected on the complex number plane, the change of opening angle of the cone yields the cone equation

−x₁²−x₂²+(1/g*²)*x₃

resp. the coefficients [−1 −1 1/g*²]. Two cone equations are then considered:

S:=aₓ²:=−1*x₁²−1*x₂²+(1/g²)*x₃²=0

and

S′:=a′ₓ²:=−1*x₁²−1*x₂²+(1/g′²)*x₃²=0.

It is well known that one invariant is thus:

a_{a′}²:=−1*(−1)²−1*(−1)²+(1/g²)* (1/g″).

Both cones S, S′ are non polar if

(1/g²)*(1/g″)=2.

S is then inscribed harmonically in S′.

If, for example, one analyzes the above combination f̂(t) or several combinations f₁̂(t), f₂̂(t), . . . , fₚ̂(t) or two or more signals s₁(t), s₂(t), . . . , sₘ(t) resp. of their transfer functions t₁(s₁(t)), t₂(s₂(t)), . . . , tₘ(sₘ(t)) for two time intervals t₁, t₂- or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for two time intervals t₁, t₂—as well as the functions S, S′ and Σ′ with

$${Σ}^{′} := {u}_{{a}^{′}}^{2} := {A}^{′} {u}_{1}^{2} + {B}^{′} {u}_{2}^{2} + {C}^{′} {u}_{3} 2 + 2 {F}^{′} {u}_{2} {u}_{3} + 2 {G}^{′} {u}_{3} {u}_{1} + 2 {H}^{′} {u}_{1} {u}_{2} = 1 * {u}_{1}^{2} + 1 * {u}_{2}^{2} + ( 1 / {g}^{″2} ) * {u}_{3}^{2} + 2 * 1 * {u}_{2} {u}_{3} + 2 * 1 * {u}_{3} {u}_{1} + 2 * 1 * {u}_{1} {u}_{2} = 0.$$

The following is true

aA′+bB′+cC′+2fF′+2gG′+2hH′=0,

and S and Σ′ should be non polar:

−1*1−1*1+(1/g²)*(1/g″²)=0

or

(1/g²)*(1/g″²)=2.

Thus, again provided g′=g″=1 and g=1/√2 applies, the non-polarity of S with S′ and Σ′ is ensured.

Considering the standard cone

S′=−1*x₁²−1*x₂²+1*x₃²=0

thus simultaneously enables the consideration of identical vanishing invariants relative to S

S=−1*x₁²−1*x₂²+2*x₃²=0

resp.

$${Σ}^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

The relation

a_{a′}²:=−1*(−1)²−1*(−1)²+2*1²=−1*1−1*1+2*1=0

is thus linear in the coefficients of the equations

S=−1*x₁²−1*x₂²+2*x₃²=0

and

$${Σ}^{′} = 1 * {u}_{1}^{2} + 1 * {u}_{2}^{2} + 1 * {u}_{3}^{2} + 2 * 1 * {u}_{2} {u}_{3} + 2 * 1 * {u}_{3} {u}_{1} + 2 * 1 * {u}_{1} {u}_{2} = 0.$$

According to Hilbert's theorem on invariants (Hilbert, page 291, §2), in our system, the linear combination

φ[−1,−1,2]*[−1,−1,1]²+Θ[−1,−1,2]*[1,1,1]²=0

in turn represents an invariant. Thus, for example, any piercing straight lines of f̂(t₁) and f̂(t₂), considered on the plane spanned by the vectors (−1, −1, 2) and (1, 1, 1), ξ₁ and ξ₂, correspond to an infinite number of invariants of S and S′ resp. of S and Σ′.

All combinatory possibilities for the situation of S, S′ and Σ′, as can easily be seen, are exhausted in terms of the result in the same plane.

The practical application of this fact in signal technology allows for example the analysis of a combination f̂(t) or of several combinations f₁̂(t), f₂̂(t), . . . , fₚ̂(t) of at least two signals s₁(t), s₂(t), . . . , sₘ(t) resp. of their transfer functions t₁(s₁(t)), t₂(s₂(t)), . . . , tₘ(sₘ(t))—or also of the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) by determining said invariants. Doing this enables the function of this combination f̂(t) or of these combinations f₁̂(t), f₂̂(t), . . . , fₚ̂(t) of at least two signals s₁(t), s₂(t), . . . , sₘ(t) resp. of their transfer functions t₁(s₁(t)), t₂(s₂(t)), . . . , tₘ(sₘ(t))—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t) for example on the complex number plane—the x₁ axis then coincides for example with the real axis, the x₂ axis then coincides for example with the imaginary axis—and subsequently enables the piercing points of these functions in the present example with the plane spanned by the vectors (1, 1, −2) and (1, 1, 1) or (−1, −1, 2) and (1, 1, 1) to be analyzed and which now constitute absolutely or also in terms of their statistical distribution precise reference points for further analysis, processing or optimization. For example, according to WO2011/009649 or also WO2011/009650, an optimization of pseudostereophonic audio signals can be carried out and subsequently the piercing points of the sum of the transfer functions f*[x(t)]=[x(t)/√ 2̅]*(−1+i) and g*[y(t)]=[y(t)/√ 2̅]*(1+i), see further below, with the plane spanned by the vectors (1, 1, −2) and (1, 1, 1) or (−1, −1, 2) and (1, 1, 1) can be determined. When these piercing points are weighted by using an appropriate method, see the detailed description, it will result in parameterizations according WO2011/009649 or also WO2011/009650, which prove particularly advantageous for the audio signals being analyzed.

According to one aspect, it is recommended practice to use (inherently known) compression algorithms or data reduction methods or to analyze characteristic features such as the minima or maxima for the signals or transfer functions or combinations or functions being analyzed, for the purpose of speeding up the evaluation thereof in accordance with the invention.

The algebraic principles of the present invention will first be explained with the aid of FIGS. 1C to 4C.

FIG. 1C shows the non-polarity constraint for S and S′ resp. S and Σ′. Reference number 1001 illustrates that for S and S′, expressed by f^{˜}(g′), 1002 illustrates that for S and Σ′, expressed by f^{˜}(g″). The intersection point 1004 of 1001 with the diagonal of the 1^{st} quadrant 1003 illustrates the coinciding of S and S′, the intersection point 1005 of 1001 and 1002 illustrates the sought non-polarity constraint itself; g′=g″=1 can be read directly.

FIG. 2C shows the functions S (2001), S′ (2002) and Σ′ (2003) as well as the plane 2004 spanned by the vectors (1, 1, −2) and (1, 1, 1), on which the sought algebraic invariants of S and S′ resp. of S and Σ′ are located, from the perspective of the 1^{st} quadrant of the corresponding complex number plane. 2005, 2006 and 2007 show the planes defined by the Cartesian coordinate system x₁=u₁, x₂=u₂, x₃=u₃.

FIG. 3C shows the functions S (2001), S′ (2002) and Σ′ (2003) as well as the plane 2004 spanned by the vectors (1, 1, −2) and (1, 1, 1), on which the sought algebraic invariants of S and S′ resp. of S and Σ′ are located, likewise from the perspective of the 1^{st} quadrant of the corresponding complex number plane. 2005, 2006 and 2007 show the planes defined by the Cartesian coordinate system x₁=u₁, x₂=u₂, x₃=u₃.

FIG. 4C shows the functions S (2001), S′ (2002) and Σ′ (2003) as well as the plane 2004 spanned by the vectors (1, 1, −2) and (1, 1, 1), on which the sought algebraic invariants of S and S′ resp. of S and Σ′ are located, from the perspective of the 4^{th} quadrant of the corresponding complex number plane. 2005, 2006 and 2007 show the planes defined by the Cartesian coordinate system x₁=u₁, x₂=u₂, x₃=u₃.

The practical-commercial application of the algebraic invariants just developed covers nearly the entire signal processing field. The stochastic analysis of audio signals, as known for example from the field of digital audio broadcasting (DAB), is of particular interest; in that field, so far, for the simulation of Gaussian processes, techniques such as the so-called Tapped Delay Line model or Monte Carlo methods (colored, complex Gaussian noise in two dimensions) were used, see bibliographical references. The transfer of the operating principles applied there for stabilizing optimization processes, such as described in WO2011/009650, would be conceivable, yet not very efficient in practice.

On the basis of the present algebraic invariants, it is however possible to define for example a weighting as follows:

For this purpose, a first optimization according to WO2011/009650, FIG. 1B, 2B, 3B to 5B, is performed on a signal section of the length t₁. The outputs of FIG. 5B are connected for example to a module 6001 according to FIG. 6C and the invariants (constituted at the intersection points ξₕ₁₀f the sum of the complex transfer functions f*[x(t₁)]=[x(t₁)/√ 2̅]*(−1+i) and g*[y(t₁)]=[y(t₁)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₁ from the total number k₁ are stored in a memory (“stack”) valid for all further described operation sequences; the mean value

$${ξ}_{1}^{∘} := ( {\sum }_{{h}_{1} = 1}^{{k}_{1}} {ξ}_{h 1} ) / {k}_{1}$$

is likewise calculated. The latter is stored together with the parameterization φ₁, f₁ (resp. n₁), α₁, β₁, determined by means of said first optimization, in a further dictionary valid for all further described operation sequences.

According to the function command 6004, in a second step a second optimization according to WO2011/009650, FIG. 1B, 2B, 3B to 5B, is then performed on a signal section t₂ of any length. The outputs of FIG. 5B are in turn again connected to the module 6001 and the invariants (constituted at the intersection points ξₕ₂ of the sum of the complex transfer functions f*[x(t₂)]=[x(t₂)/√ 2̅]*(−1+i) and g*[y(t₂)]=[y(t₂)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₂ of the represented algebraic model coincides here with the real axis, the axis x₂, u₂ with the imaginary axis) are analyzed in terms of their statistical distribution. All ξₕ₂ from the total number k₂ are stored in a memory (“stack”) valid for all further described operation sequences; the mean value

$${ξ}_{2}^{∘} := ( {\sum }_{{h}_{2} = 1}^{{k}_{2}} {ξ}_{h 2} ) / {k}_{2}$$

is likewise calculated. The latter is in turn again added together with the parameterization φ₂, f₂ (resp. n₂), α₂, β₂, determined by means of said second optimization, to the first mean value ξ^{o}₁ as well as its parameterization φ₁, f₁ (resp. n₁), α₁, β₁, in the dictionary valid for all further described operation sequences. Since the memory (“stack”) now contains more than one mean value, the module 6002 of FIG. 6C is then activated.

The latter calculates the mean value ξ*₂ of all intersection points ξₕ₁, ξₕ₂ stored in the stack:

$${ξ}_{2}^{∘} := ( {\sum }_{{h}_{1} = 1}^{{k}_{1}} {ξ}_{h 1} + {\sum }_{{h}_{2} = 1}^{{k}_{2}} {ξ}_{h 2} ) / ( {k}_{1} + {k}_{2} )$$

and selects from the dictionary among the mean values ξ^{o}₁, ξ^{o}₂ with their associated parameterization the mean value closest to ξ*₂. If this is the case for both mean values ξ^{o}₁, ξ^{o}₂, ξ^{o}₁ resp. the parameterization φ₁, f₁ (resp. n₁), α₁, β₁ is selected from the dictionary. The mean value selected from the dictionary is then transmitted together with ξ*₂ to the module 6003 of FIG. 6C. The latter verifies whether the mean value selected by the module 6002 of FIG. 6C is within the interval [−σ+ξ*₂, ξ*₂+σ], where σ>0 represents the standard deviation, freely selectable by the user, of the Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)}

If the mean value selected by the module 6002 of FIG. 6C is within the interval [−σ+ξ*₂, ξ*₂+σ], the parameterization selected by the module 6002 of FIG. 6C according to 6010 of FIG. 6C in the arrangement of FIG. 7A resp. FIG. 1B (which shows again for the sake of clarity the amplifier 717 and the MS matrix, wherein both of which are to be passed through only once) resp. the outputs 6006 and 6007 of FIG. 1B are activated, likewise the outputs 6008 and 6009 of FIG. 2B. The output 6006 of FIG. 1B runs into the input 6006 of FIG. 6C, the output 6007 of FIG. 1B runs into the input 6007 of FIG. 6C, the output 6008 of FIG. 2B runs into the input 6008 of FIG. 6C and the output 6009 of FIG. 2B runs into the input 6009 of FIG. 6C. Reference 6006 of FIG. 6C directly represents the output signal x(t) from the module 6003 of FIG. 6C, reference 6007 of FIG. 6C directly represents the output signal y(t) from the module 6003 of FIG. 6C, 6008 of FIG. 6C directly represents the output signal Re f*[x(t)]+g*[y(t)] from the module 6003 of FIG. 6C, 6009 of FIG. 6C directly represents the output signal Im f*[x(t)]+g*[y(t)] from the module 6003 of FIG. 6C. These signals, in the signal processing described above, are to be treated as if they represented the output signals of FIG. 5B, which with FIG. 6C then constitutes, in this example of application, an inseparable unit.

If the mean value selected by the module 6002 of FIG. 6C is outside the interval [−σ+ξ^{*}₂, ξ^{*}₂+σ], in a q^{th} step a q^{th} optimization is performed according to WO2011/009650, FIG. 1B, 2B, 3B to 5B, on a signal section t_{q} of any length. The outputs of FIG. 5B are in turn connected to the module 6001 of FIG. 6C and the invariants (constituted at the intersection points ξ_{hq} of the sum of the complex transfer functions f*[x(t_{q})]=[x(t_{q})/√ 2̅]*(−1+i) and g*[y(t_{q})]=[y(t_{q})/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξ_{hq} from the total number k_{q} are added to ξₕ₁, ξₕ₂, . . . , ξ_{hq-1} in a memory (“stack”) valid for all further described operation sequences; the mean value

$${ξ}_{q}^{∘} := ( {\sum }_{{h}_{q} = 1}^{{k}_{q}} {ξ}_{h q} ) / {k}_{q}$$

is likewise calculated. The latter is in turn added together with the parameterization φ_{q}, f_{q} (resp. n_{q}), α_{q}, β_{q′}, determined by means of said q^{th} optimization, to the first mean values ξ^{o}₁, ξ^{o}₁, . . . , ξ^{o}_{q-1} as well as to their parameterizations φ₁, f₁ (resp. n₁), α₁, β₁; φ₂, f₂ (resp. n₂), α₂, β₂; . . . ; φ_{q-1}, f_{q-1} (resp. n_{q-1}), α_{q-1}, βhd q-1, in the dictionary valid for all further described operation sequences. Since the memory (“stack”) now contains more than one mean value, the module 6002 of FIG. 6C is then activated.

The latter calculates the mean value ξ*_{q} of all intersection points ξₕ₁, ξₕ₂, . . . , ξ_{hq} stored in the stack:

$${ξ}_{q}^{∘} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1}^{{k}_{q}} {ξ}_{hq} ) / ( {k}_{1} + {k}_{2} + … {k}_{q} )$$

and selects from the dictionary among the mean values ξ^{o}₁, ξ^{o}₂, . . . , ξ^{o}_{q} with their associated parameterization φ, f (resp. n), α, β, the mean value closest to ξ*_{q}. If this is the case for different parameterizations, the parameterization that appears most often in the dictionary is selected. If several parameterizations appear the same number of times, the one that exhibits the widest scattering in the dictionary is selected, i.e. the one for which the difference d−c is maximum, where d represents the last and c the first index number of the optimization steps respectively undergone. If this too applies to several parameterizations, the first one that appears is selected. If two mean values from ξ^{o}₁, ξ^{o}₂, . . . , ξ^{o}_{q} are close to ξ*_{q}, insofar as in a q−1^{th} step one of the two mean values resp. their associated parameterizations is selected from the dictionary, the very same one resp. its associated parameterizations is retained. The mean value selected from the dictionary is then transmitted together with ξ*_{q} to the module 6003 of FIG. 6C. The latter verifies whether the mean value selected by the module 6002 of FIG. 6C is within the interval [−σ+ξ*_{q}, ξ*_{q}+σ], where σ>0 represents the standard deviation, freely selectable by the user at the beginning of the entire process illustrated here, of the Gauss distribution fictitiously set as zero in ξ*_{q}:

f^{∪}(z_{q}*)=(1/(√(2π)*σ))e^{-(1/2)*(((z}^{_{q}}^{*-ξ*}^{_{q}}^{)̂2)/σ̂2)}

If the mean value selected by the module 6002 of FIG. 6C is within the interval [−σ+ξ*_{q}, ξ*_{q}+σ], the parameterization selected by the module 6002 of FIG. 6C according to 6010 of FIG. 6C in the arrangement of FIG. 7A resp. FIG. 1B resp. the outputs 6006 and 6007 of FIG. 2B are activated, likewise the outputs 6008 and 6009 of FIG. 2B as well as the corresponding inputs and outputs of FIG. 6C. Reference 6006 of FIG. 6C again directly represents the output signal x(t) from the module 6003 of FIG. 6C, reference 6007 of FIG. 6C directly represents the output signal y(t) from the module 6003 of FIG. 6C, 6008 of FIG. 6C directly represents the output signal Re f*[x(t)]+g*[y(t)] from the module 6003 of FIG. 6C, 6009 of FIG. 6C directly represents the output signal Im f*[x(t)]+g*[y(t)] from the module 6003 of FIG. 6C. These signals, in the signal processing described above, are again to be treated as if they represented the output signals of FIG. 5B, which with FIG. 6C constitutes, in the present example of application, an inseparable unit.

If the mean value selected by the module 6002 of FIG. 6C is outside the interval [−σ+ξ*_{q}, ξ*_{q}+σ], in a q+1^{th} step a q+1^{th} optimization is performed in the same form as for the q^{th} step and for the q^{th} optimization. The process is repeated as long as necessary until one element of the dictionary fulfills the above requirements or a maximum number of allowed optimization steps has been reached.

FIG. 5C shows the convergence behavior of the just established weighting function for three optimization steps: 5001 represents in this case the first mean value ξ^{o}₁, 5002 the second mean value ξ^{o}₂, 5003 the first Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)}

where σ>0 represents the standard deviation, freely selectable by the user at the beginning of the entire process illustrated here, 5004 the third mean value ξ^{o}₃, which remains within the inflexion points defined by a of the Gauss distribution 5005 of same standard deviation, fictitiously set as zero in ξ*₃, and thus fulfills the convergence criterion.

In each case, the result is a parameterization φ, f (resp. n), α, β, which supplies a pseudostereophonic function that on average is optimum in relation to all algebraic invariants.

As the number of signal sections increases, the distribution of the intersection points ξ of the algebraic invariants on the half-plane respectively analyzed with the complex number plane approximates the Gauss distribution. The smaller the chosen standard deviation σ is, the closer to ideal the resulting parameterization will be. However, as an only finite number of signal sections are available, σ should not be chosen too small.

Nevertheless, the method in terms of its convergence is considerably faster for sufficiently long signal sections than mentioned simulation models, since algebraic invariants are available for the first time to serve as valid “points of reference” for a weighting of already determined parameterizations.

In principle, use of the described invariants is however not compulsorily bound to a system as in FIG. 3A to 12A resp. 1B, 2B, 3B, 4B, 5B, 6B, 10B, 7B to 9B resp. 5C and 6C, but can on the contrary be applied to nearly any part of the entire field of signal technology. The described normalization on the unit circle of the complex number plane, wherein for example two signals x(t) and y(t) are amplified uniformly by a factor ρ* (amplifiers 118, 119 in FIG. 1B) such that the maximum of both signals has a level of exactly 0 dB, is not necessary in this case. The value range for the analyzed combination or combinations—or also for any above function or functions of one or several signals—can thus according to the invention comprise the entire value range of the real or complex number plan and therefore does not remain limited to the unit circle.

If it is intended to normalize a combination f̂(t) or several combinations f₁̂(t), f₂̂(t), . . . , fₚ̂(t) of at least two signals s₁(t), s₂(t), . . . , sₘ(t) resp. of their transfer functions t₁(s₁(t)), t₂(s₂(t)), . . . , tₘ(sₘ(t))—or also the above freely definable function f^{#}(t) or freely definable functions f₁^{#}(t), f₂^{#}(t), . . . , f_{μ}^{#}(t) of one signal s^{#}(t) or of several signals s₁^{#}(t), s₂^{#}(t), s_{Ω}^{#}(t)—although there is no imperative necessity of doing so, this normalization can be freely definable.

Instead of the effective level control of the maximum value of L and R in the present example to 0 db (amplifiers 118 and 119 as well as logic element 120 in FIG. 1B), it is thus possible for example to achieve a normalization on the basis of the sums of the mean square energy of each of the two respective channels, i.e. for L equal to x_{#}(tᵢ) and R equal to y_{#}(tᵢ) on the basis of the sum z_{Li}+z_{Ri} of

$${z}_{Li} = ( 1 / {T}_{i} ) * {\int }_{0}^{{T}_{i}} {x}_{\#} ( {t}_{i} ) d t$$

$$and$$

$${z}_{Ri} = ( 1 / {T}_{i} ) * {\int }_{0}^{{T}_{i}} {y}_{\#} ( {t}_{i} ) d t$$

to introduce a normalization with respect to a reference value z_{ref} according to the principle that x_{#}(tᵢ) and y_{#}(tᵢ) each are to be multiplied by the factor

z_{ref}/(z_{Li}+z_{Ri})

If this principle is generalized for example according to FIG. 7C, this principle can be extended to any number of signals sⱼ (tᵢ) of the total number δ (7001), for each of which respectively the mean square energy is calculated (7002):

$${z}_{sj ( ti )} = ( 1 / {T}_{i} ) * {\int }_{0}^{{T}_{i}} {s}_{j} ( {t}_{i} ) d t ,$$

where again Tᵢ represents the time span of the time interval tᵢ, and which signals are subsequently multiplied (7003) with a weighting Gⱼ defined for each signal sⱼ (t).

Following this, the products Gⱼ*Z_{sj (ti)} thus obtained are summed according to 7004. This sum is transmitted to the amplifiers of 7005 that are individually connected to the original signal inputs s₁(tᵢ), s₂(tᵢ), . . . , s_{δ}(tᵢ), and the signals s₁(tᵢ), s₂(tᵢ), . . . , s_{δ}(tᵢ) are then uniformly amplified by the factor

$${Z}_{ref} / ( {\sum }_{j = 1}^{δ} {G}_{j} * {Z}_{sj ( ti )} )$$

and for example transmitted to the module 7006, which—according to the disclosure of the invention—determines the invariants of the combination f̂(t) or of several combinations f₁̂(t), f₂̂(t), . . . , fₚ̂(t) of at least two signals s₁(t), s₂(t), . . . , s_{δ}(t) resp. of their transfer functions t₁(s₁(t)), t₂(s₂(t)), . . . , t_{δ}(s_{δ}(t))—or also the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{δ}^{#}(t).

Similar considerations can in particular extend also for example to audio signals according for example to ITU-R BS.1770; the modules 7002 to 7005 are then omitted and the signals can be forwarded directly to the module 7006.

Even when analyzing a single, sufficiently long time span for a combination f̂(t) or several combinations f₁̂(t), f₂̂(t), . . . , fₚ̂(t) of at least two signals s₁(t), s₂(t), . . . , sₘ(t) resp. of their transfer functions t₁(s₁(t)), t₂(s₂(t)), . . . , tₘ(sₘ(t))—or also for the freely definable function f^{#}(t) or the freely definable functions f₁^{#}(t), f₂^{#}(t), . . . , f_{μ}^{#}(t) of one signal s^{#}(t) or of several signals s₁^{#}(t), s₂^{#}(t), . . . , s_{Ω}^{#}(t)—the invariants according to the above can be determined and used specifically in an industrial-technical context (for example for evaluating individual signals or processing or optimizing any signal parameter or transmission parameter). The application of the object of the invention it thus not limited to the examples given above, but is oriented in principle towards the described determination of invariants for any signals or signal sections of any length according to the disclosure of the invention.

Bibliographical references for PCT/EP2011/063322: 1. David Hilbert: Über die vollen Invariantensysteme (On Full Invariant Systems). Mathematische Annalen Bd.42, S. 313-373 (1893). Springer: Berlin, Heidelberg, 1970. 2. Henrik Schulze: Digital Audio Broadcasting. Das Übertragungssystem im Mobilfunkkanal (DAB transmission system in mobile radio channel)—Seminars script of the University and Polytechnic Paderborn (2002) (www.fh-meschede.de/public/schuize/docs/dab-seminar.pdf) 3. Rec. ITU-R BS.1770.

FIG. 1D shows a first inventive example of application. The basic circuit of EP1850639 has been expanded by a further time parameter s, which is multiplied respectively with the time differences L_{A} resp. L_{B} and thus yields the new time differences L′_{A} resp. L′_{B} as follows:

L_{A}′=L_{A}*s=[√(5/4−sin φ)−1/2]*s (3D)

and

L_{B}′=L_{B}*s=[√(5/4+sin φ)−1/2]*s (4D)

The new circuit schema can be directly seen from FIG. 1D. s>0 can represent both a constant (an ideal value for s for the present arrangement is for example 100 ms) as well as be selected freely by the user. In practice, the values of delay A′ resp. delay B′ of FIG. 1D essential for determining the spatial perception of the listener.

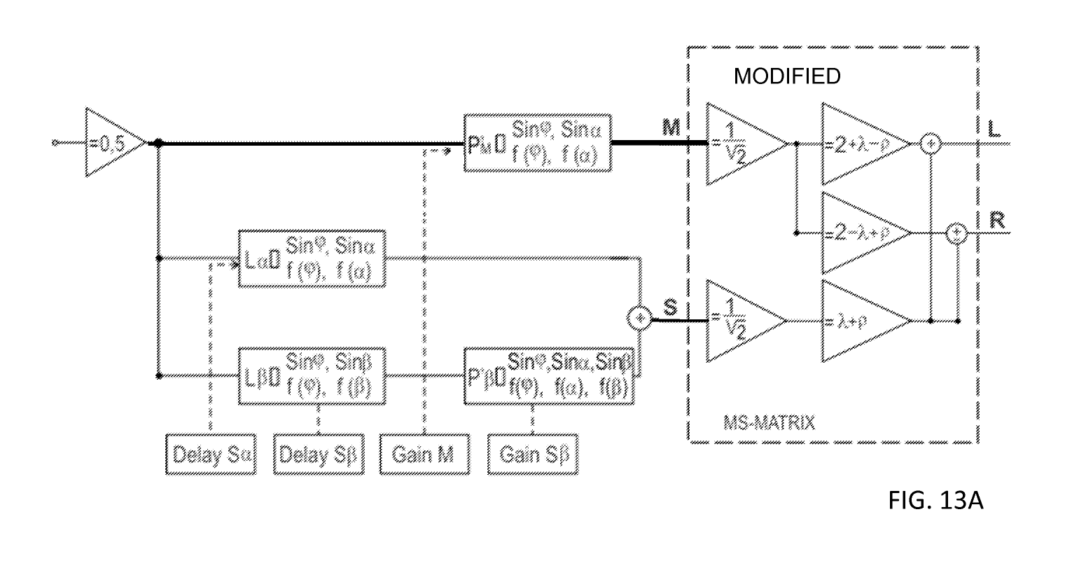

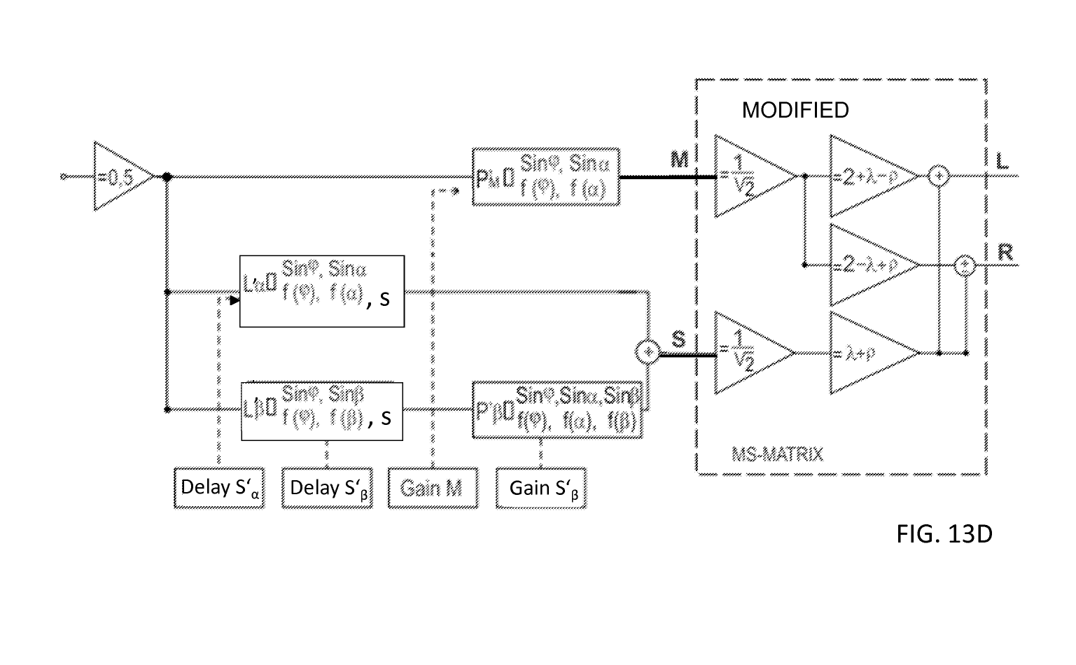

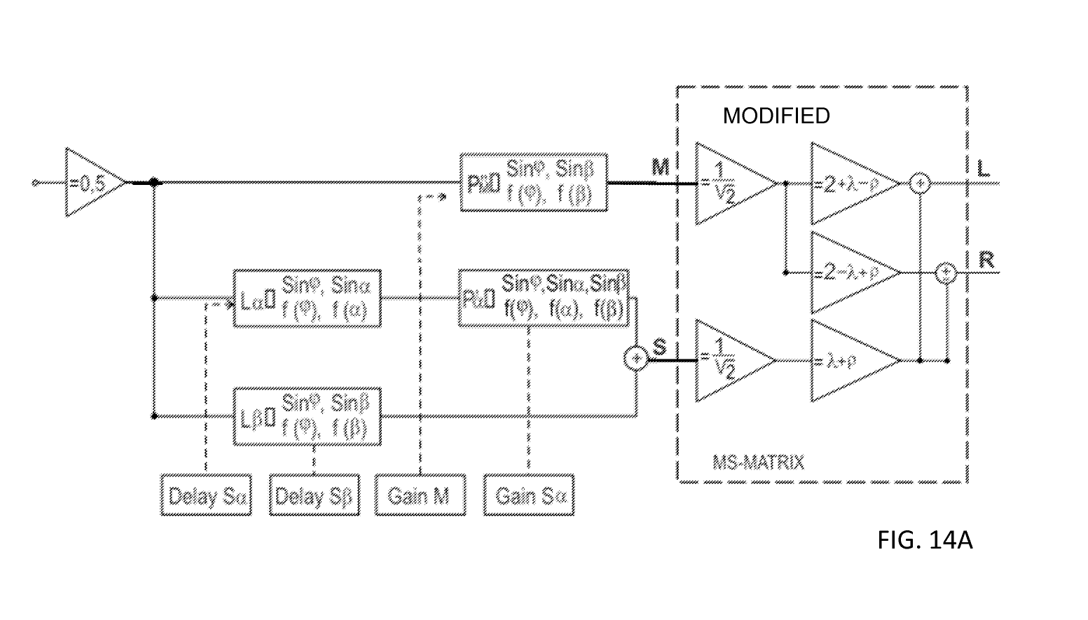

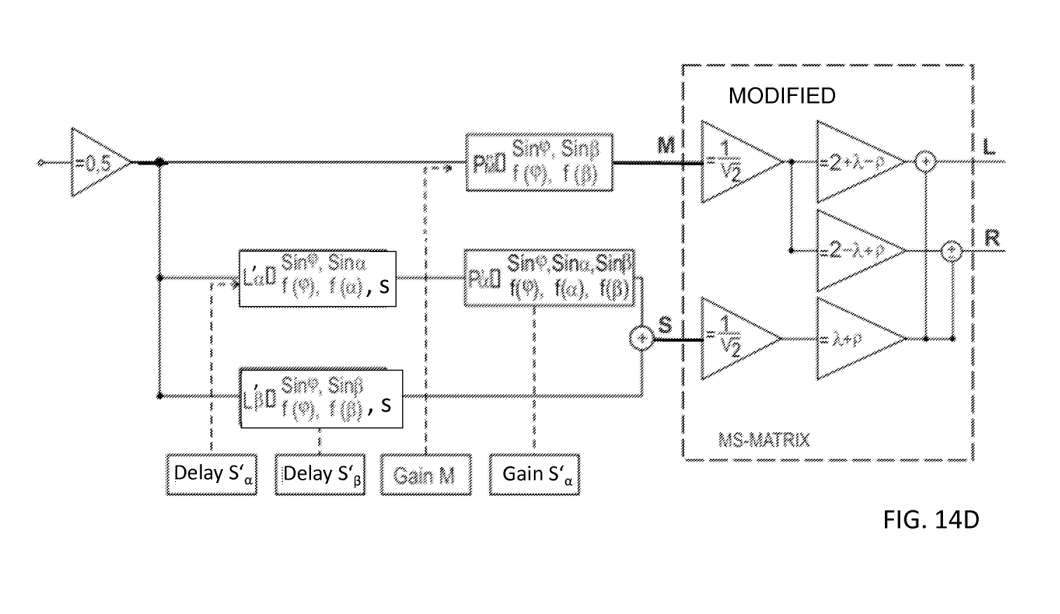

The transposition of this operating principle to WO2009/138205 results for example in the inventive arrangements of FIG. 2D, 3D, 4D, 5D, 6D (to which elements according to WO2011/009649 are added for a better illustration) as well as in FIG. 7D, FIG. 8D, FIG. 9D, FIG. 10D, FIG. 11D, FIG. 12D, FIG. 13D, FIG. 14D. Again, the time differences L_{α} and L_{β} are each multiplied with the same parameter s>0 and yield new time differences L_{α}′ and L_{β}′. Consequently, the following relations apply:

L_{α}′=L_{α}*s={−f(α)/(2 sin α)+√[f²(α)/(4 sin² α)+f²(φ)−(f(α)*f(φ)*sin φ)/sin α]}*s (1D)

and

L_{β}′=L_{β}*s={−f(β)/(2 sin β)+√[f²(β)/(4 sin² β)+f²(φ)+(f(β)*f(φ)*sin φ)/sin β]}*s (2D)

The new circuit schema can be seen directly in FIG. 2D, 3D, 4D, 5D, 6D (to which elements according to WO2011/009649 are added for a better illustration) as well as in FIG. 7D, FIG. 8D, FIG. 9D, FIG. 10D, FIG. 11D, FIG. 12D, FIG. 13D, FIG. 14D.

N.B. If stipulating f(φ)=f(α)=f(β)=1 and sin α=sin β=1 in the circuit schema 309 of FIG. 2D resp. in the circuit schema 409 of FIG. 3D resp. in the circuit schema 509 of FIG. 4D, variants of EP1850639 will result according to the invention that depend only on the parameter s and on the angle φ enclosed by the main axis and the sound source. In particular, for the circuit schema 309 of FIG. 2D, the following relations apply:

L_{α}′=L_{α}*s=[√(5/4−sin φ)−1/2]*s (3D)

and

L_{β}′=L_{β}*s=[√(5/4+sin φ)−1/2]*s (4D)

as well as

P_{α}=5/4−sin φ

and

P_{β}=5/4+sin φ,

for the circuit schema 409 of FIG. 3D the relations

L_{α}′=L_{α}*s=[√(5/4−sin φ)−1/2]*s (3D)

and

L_{β}′=L_{β}*s=[√(5/4+sin φ)−1/2]*s (4D)

as well as

P_{M}′=1/(5/4−sin φ)

and

P_{β}′=(5/4+sin φ)/(5/4−sin φ),

where 1/P_{M}′=(5/4−sin φ) may not be equal to zero or an element of an environment of zero, and for the circuit schema 509 of FIG. 4D the following relations apply:

L_{α}′=L_{α}*s=[√(5/4−sin φ)−1/2]*s (3D)

and

L_{β}′=L_{β}*s=[√(5/4+sin φ)−1/2]*s (4D)

as well as

P_{M}″=1/(5/4+sin φ)

and

P_{α}′=(5/4−sin φ)/(5/4+sin φ),

where 1/P_{M}″=(5/4+sin φ) may not be equal to zero or an element of an environment of zero.

N.B. It is also possible in the circuit schema 309 of FIG. 2D resp. in the circuit schema 409 of FIG. 3D resp. in the circuit schema 509 of FIG. 4D for α=β=π/2 and thus to stipulate sin α=sin β=1, yet to keep f(φ) resp. f(α) resp. f(β), i.e. to create an exclusive dependence on the angle φ enclosed by the sound source and the main axis of the mono signal that is to be rendered stereophonic, and on the directional pattern of the mono signal that is to be rendered stereophonic (which can be represented in polar coordinates). For the circuit schema 309 of FIG. 2D in particular the following relations apply:

L_{α}′=L_{α}*s={−f (α)/2+√[f²(α)/4+f²(φ)−(f(α)*f(φ)*sin φ)]}*s

and

L_{β}′=L_{β}*s={−f(β)/2+√[f²(β)/4+f²(φ)+(f(β)*f(φ)*sin φ)]}*s

as well as

P_{α}=f²(α)/4+f²(φ)−(f(α)*f(φ)*sin φ)

and

P_{β}=f²(β)/4+f²(φ)+(f(β)*f(φ)*sin φ)

and for the circuit schema 409 of FIG. 3D the relations

L_{α}′=L_{α}*s={−f(α)/2+√[f²(α)/4+f²(φ)−(f(α)*f(φ)*sin φ)]}*s

and

L_{β}′=L_{β}*s={−f(β)/2+√/[f²(β)/4+f²(φ)+(f(β)*f(φ)*sin φ]}*s

as well as

P_{M}′=1/[f²(α)/4+f²(φ)−(f(α)*f(φ)*sin φ)]

and

P_{β}′=[f²(β)/4+f²(φ)+(f(β)*f(φ)*sin φ)]/[f²(α)/4+f²(φ)−(f(α)*f(φ)*sin φ)],

where 1/P_{M}′=[f²(α)/4+f²(φ)−(f(α)*f(φ)*sin φ)] may not be equal to zero or an element of an environment of zero, and for the circuit schema 509 of FIG. 4D the relations

L_{α}′=L_{α}*s={−f(α)/2+√/[f²(α)/4+f²(φ)−(f(α)*f(φ)*sin φ)]}*s

and

L_{β}′=L_{β}*s={−f(β)/2+√/[f²(β)/4+f²(φ)+(f(β)*f(φ)*sin φ)]}*s

as well as

P_{M}″=1[f²(β)/4+f²(φ)+(f(β)*f(φ)*sin φ)]

and

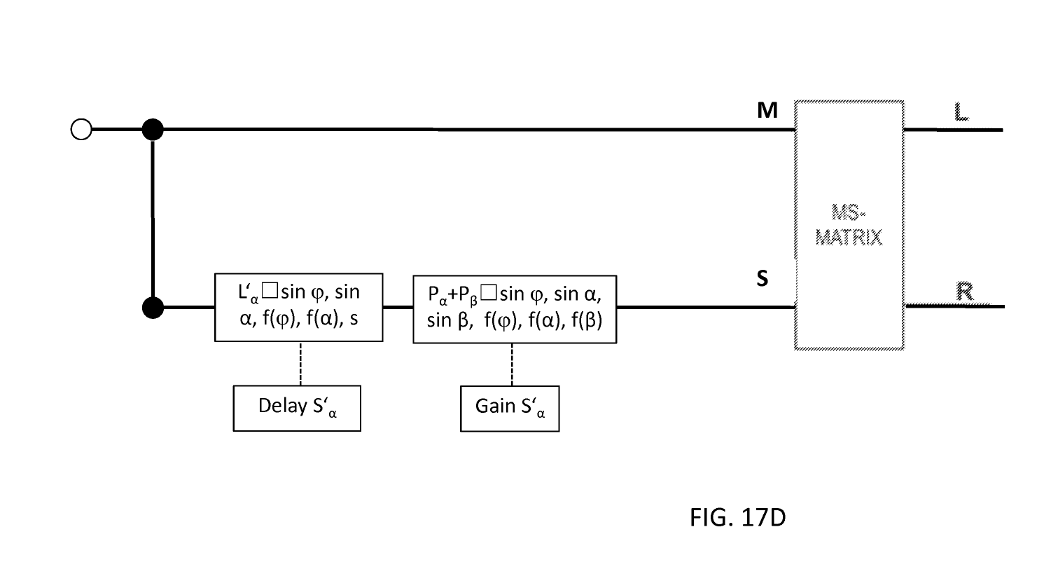

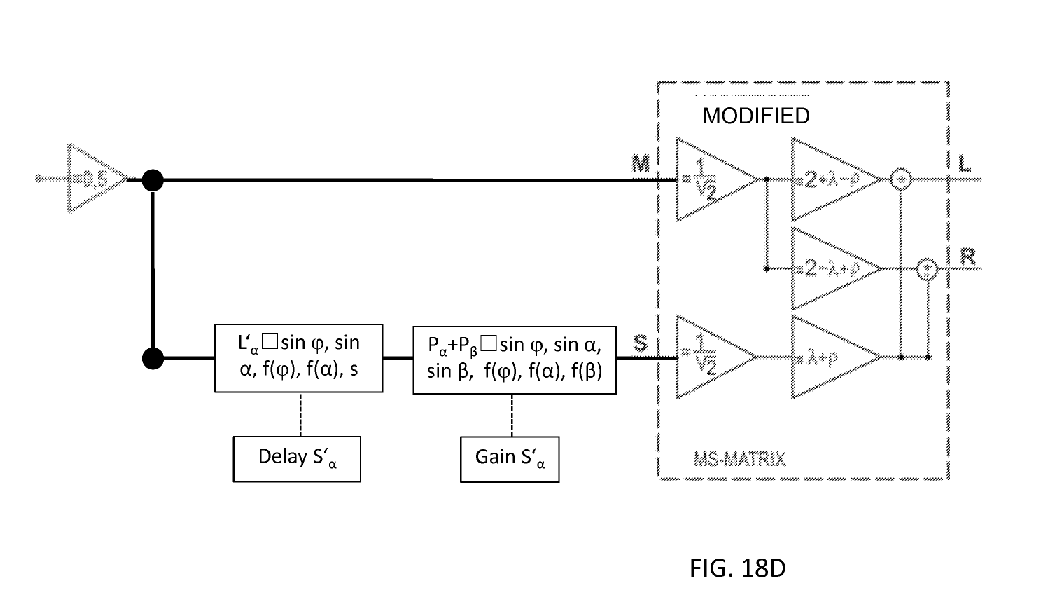

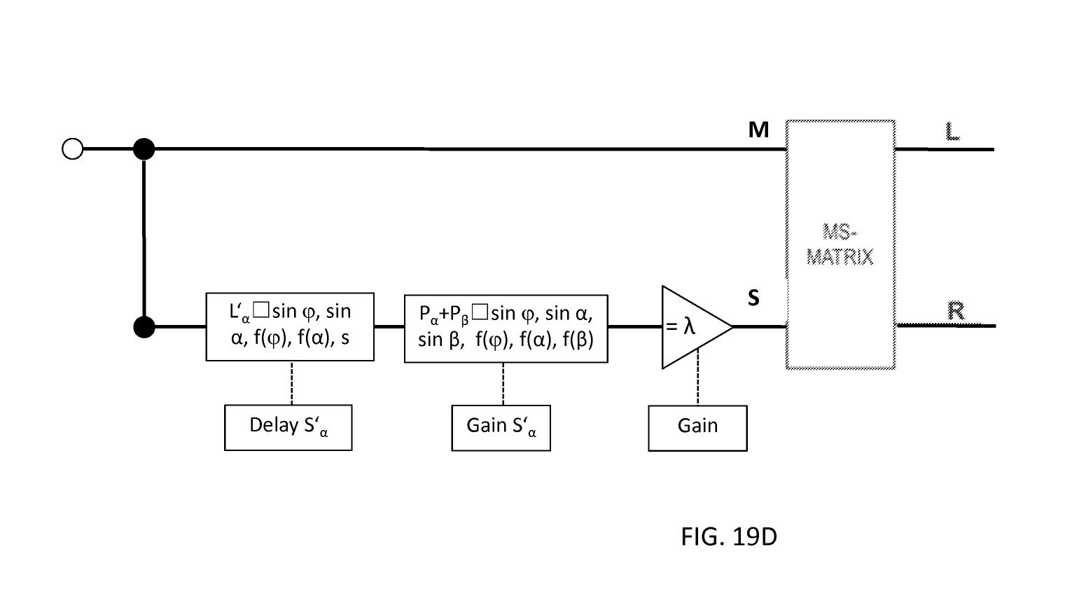

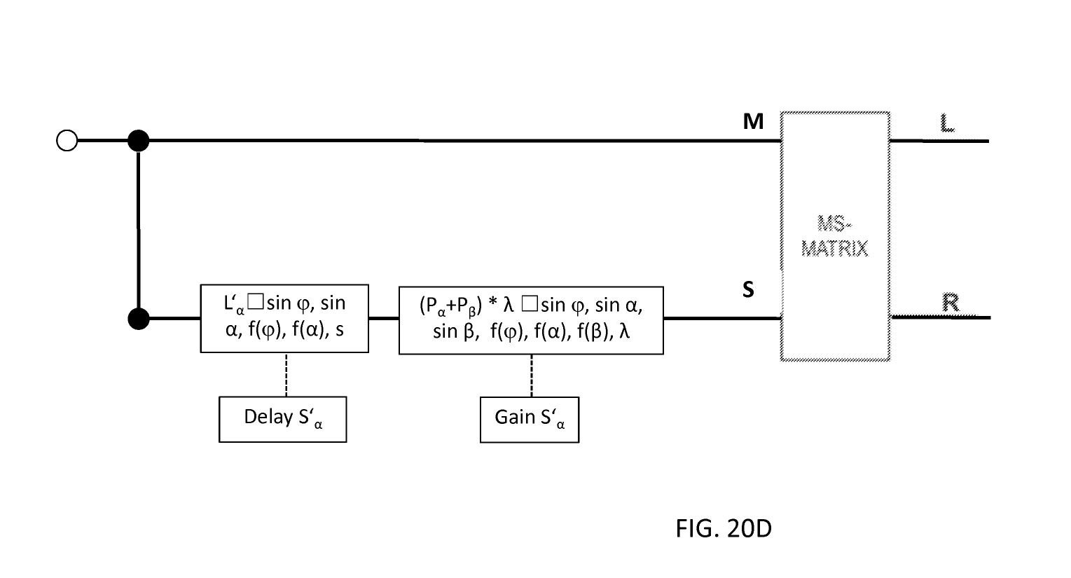

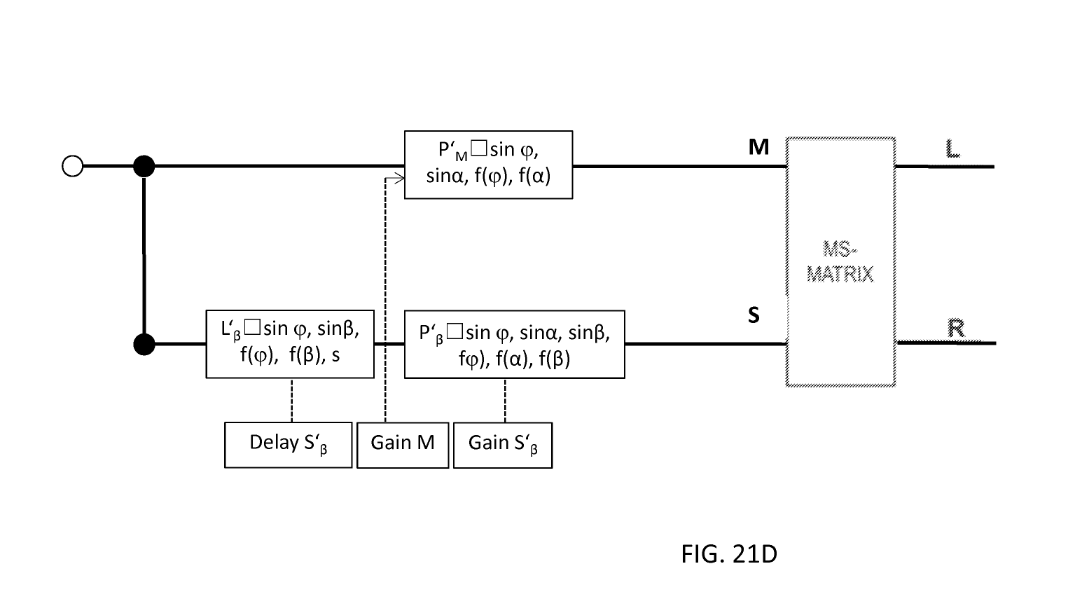

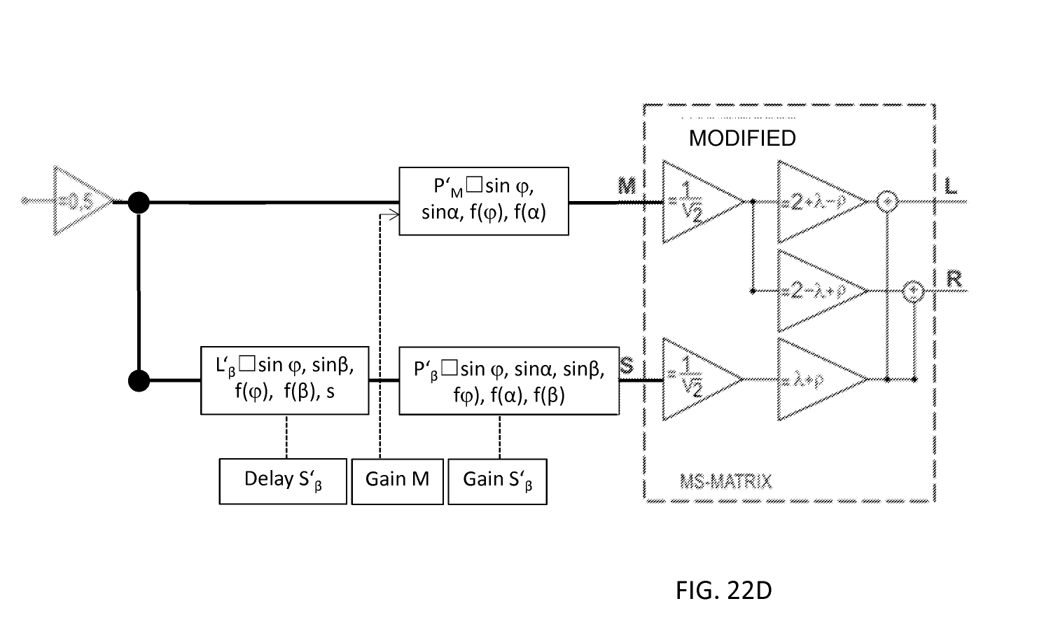

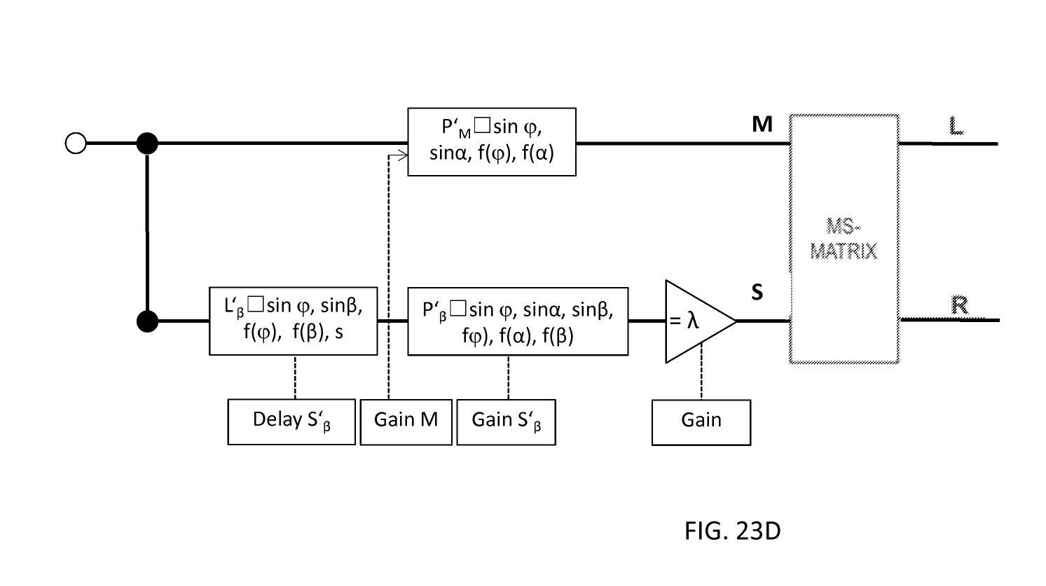

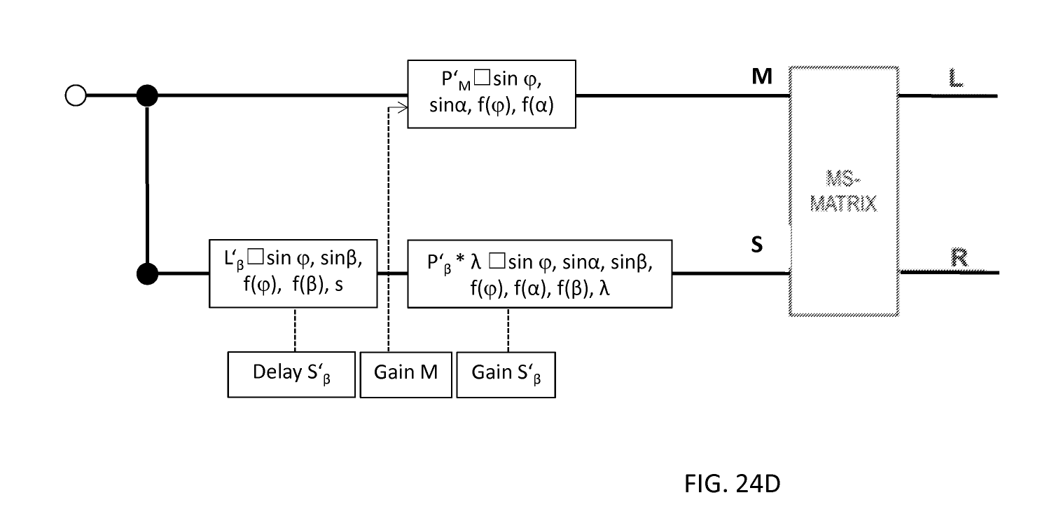

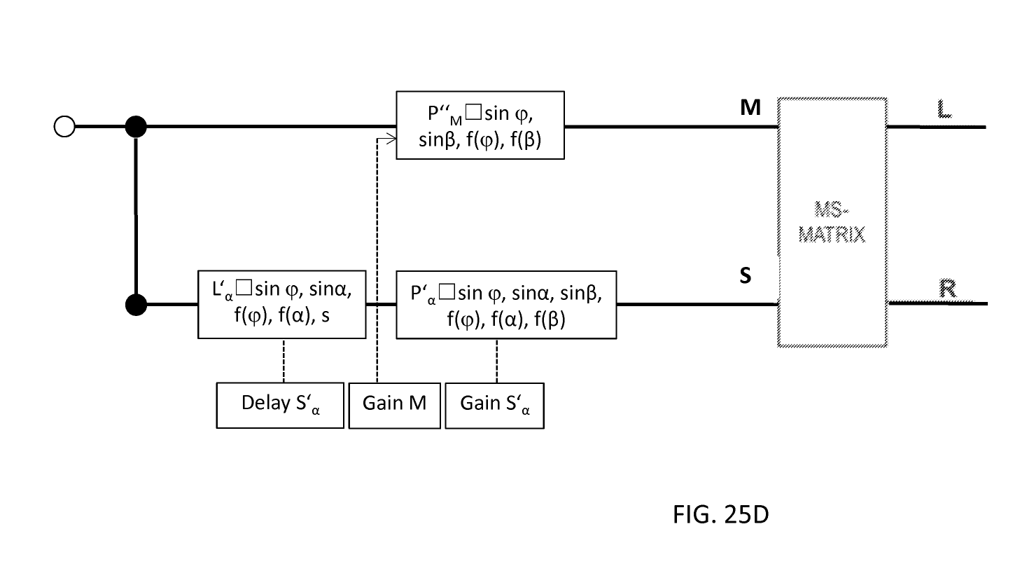

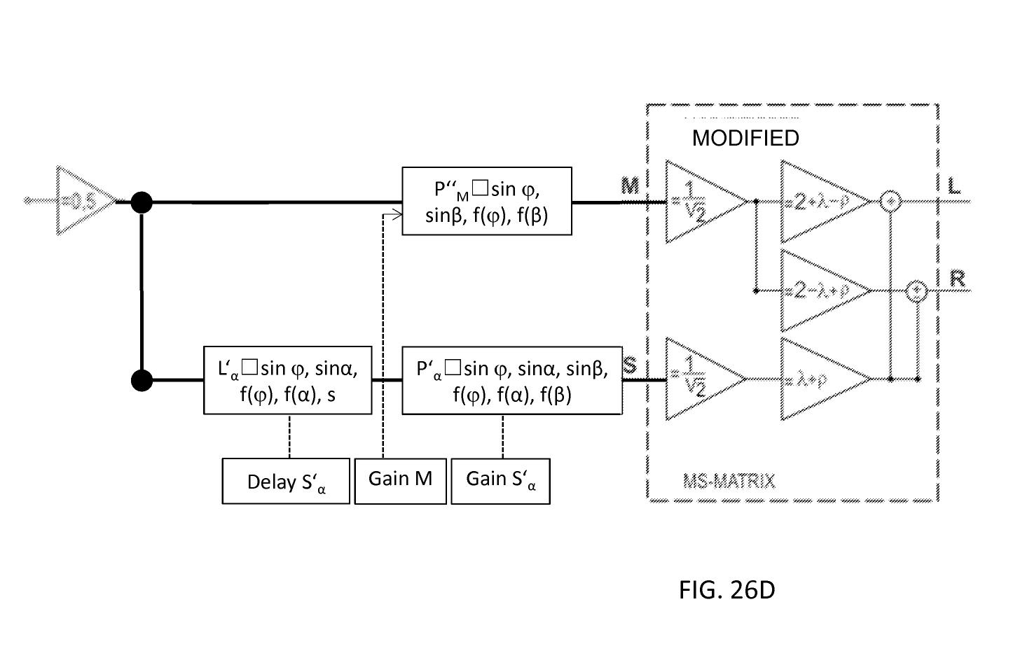

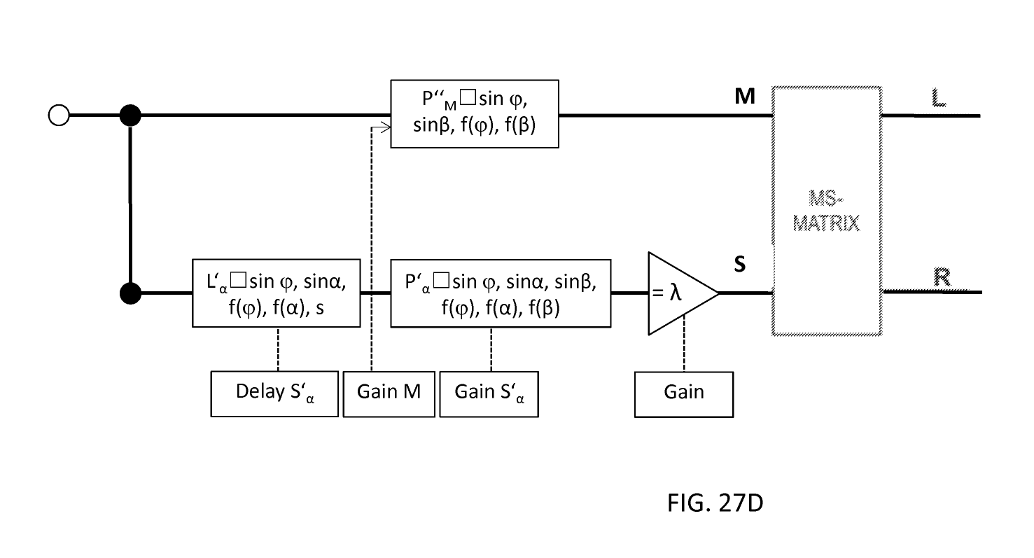

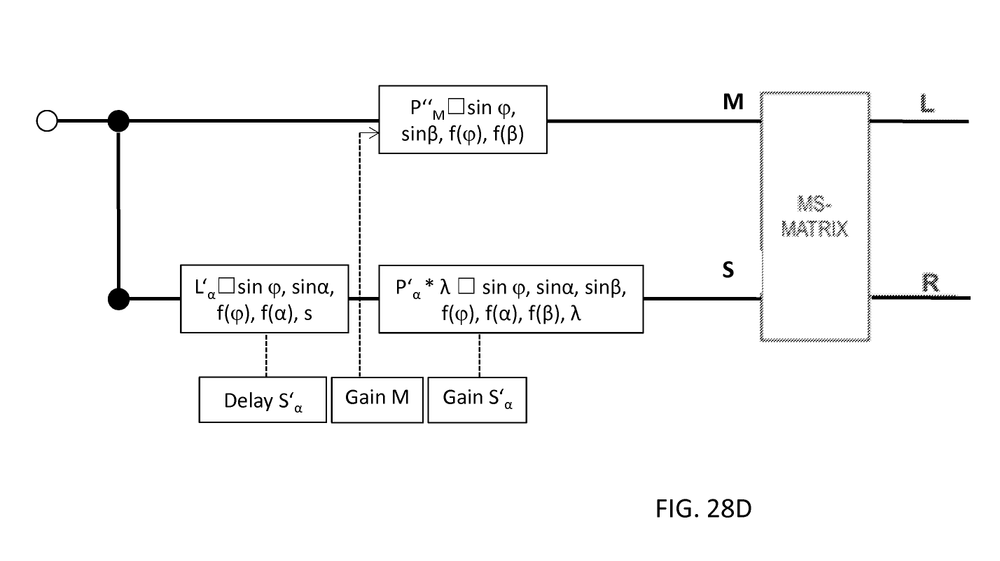

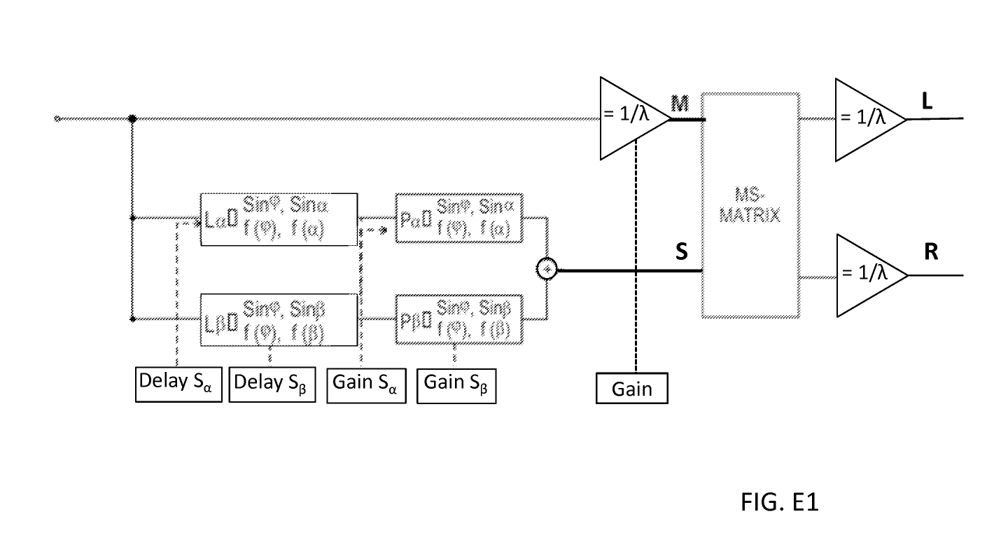

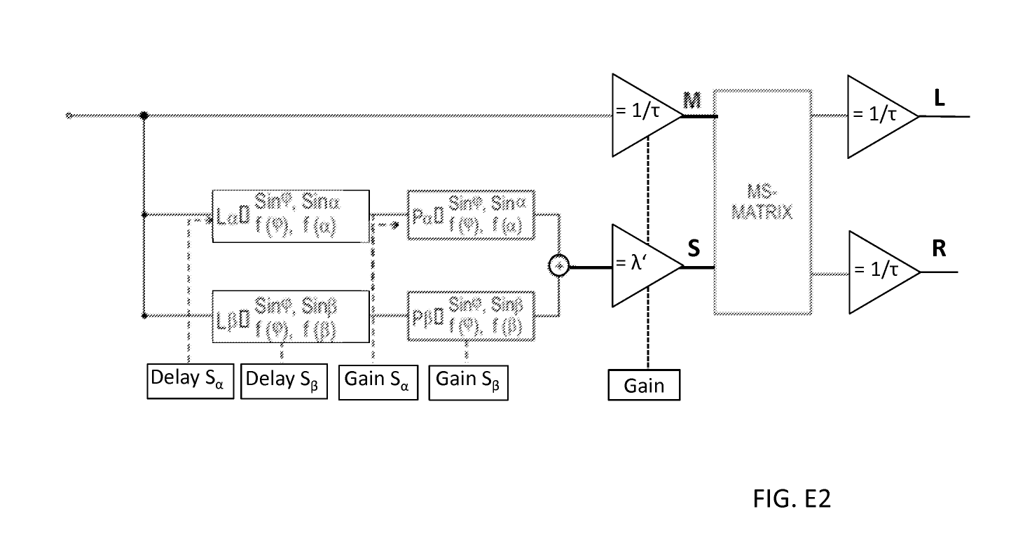

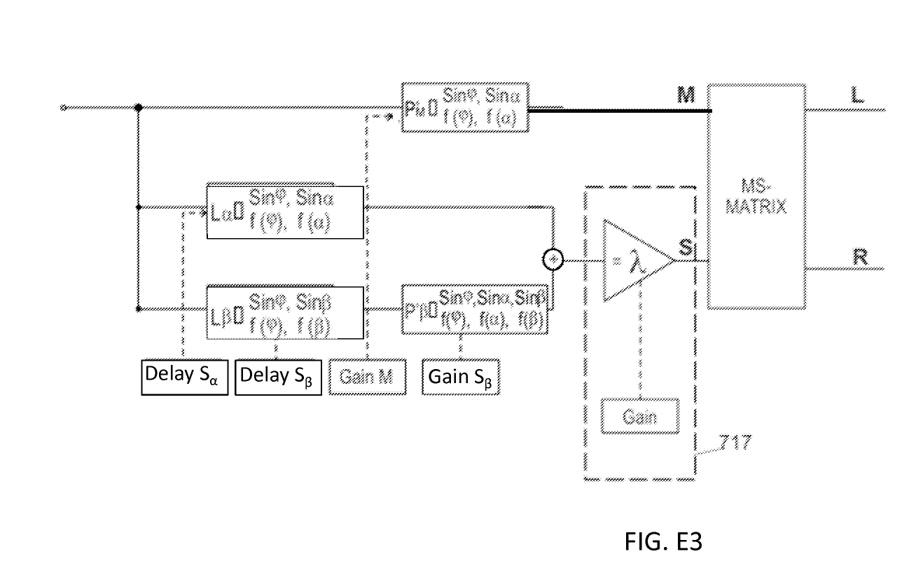

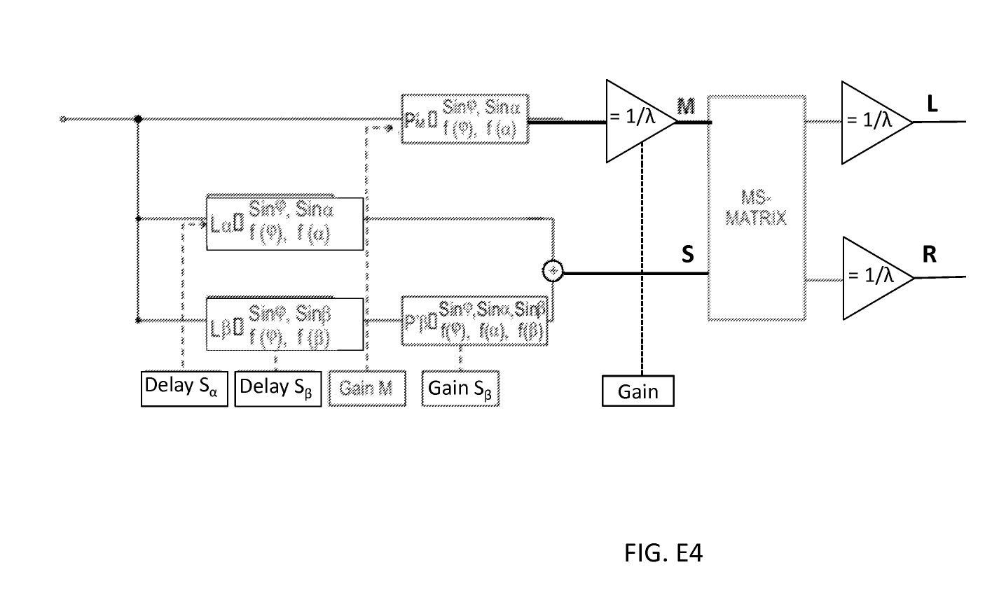

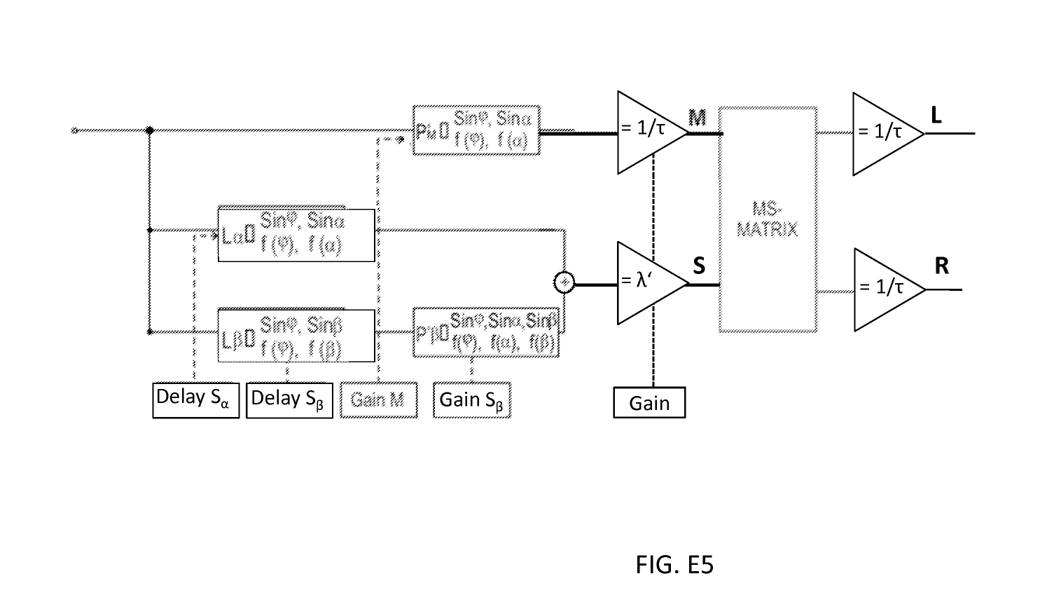

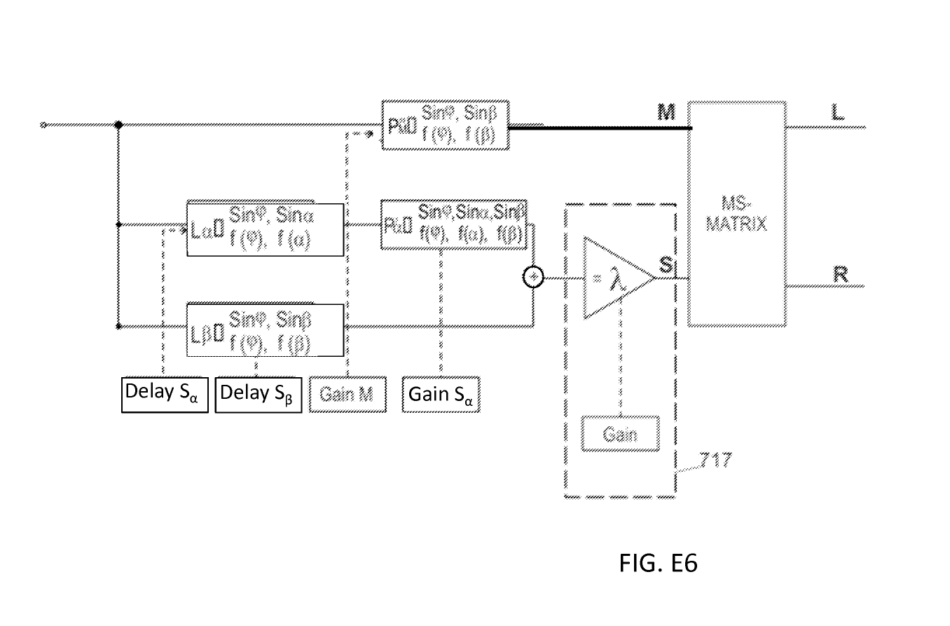

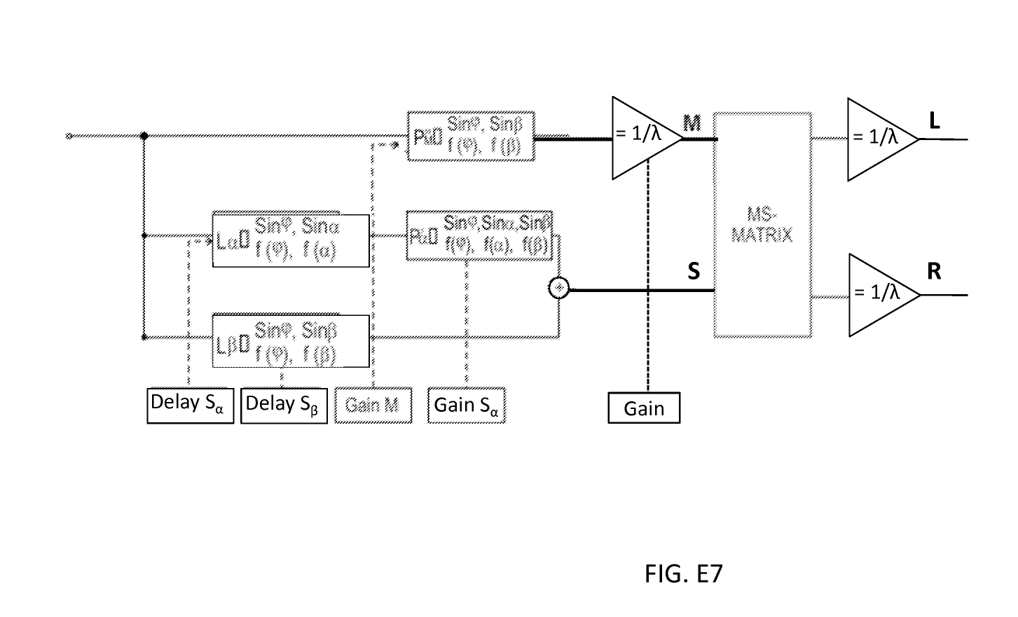

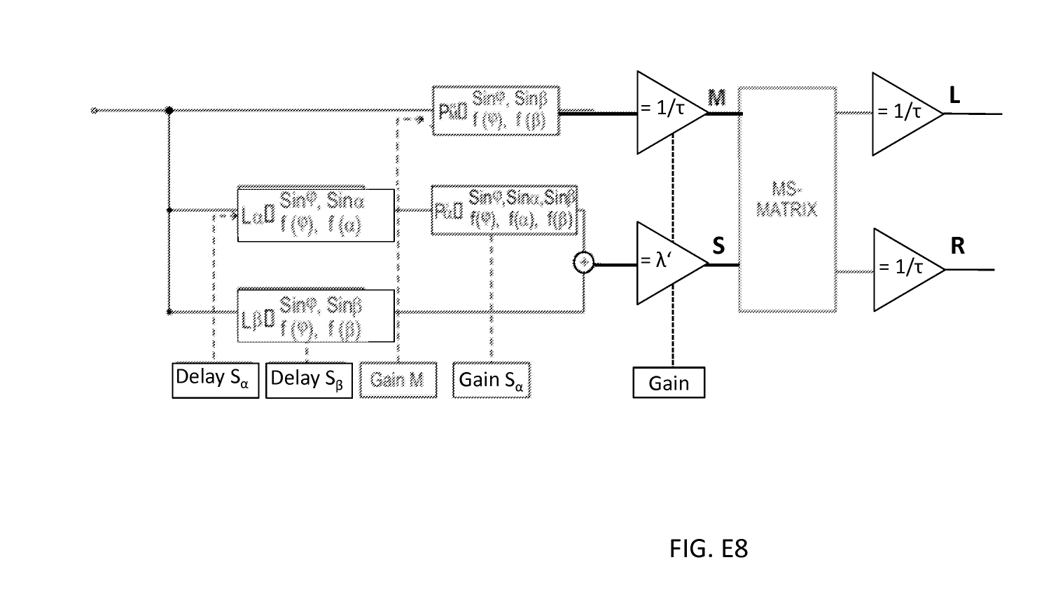

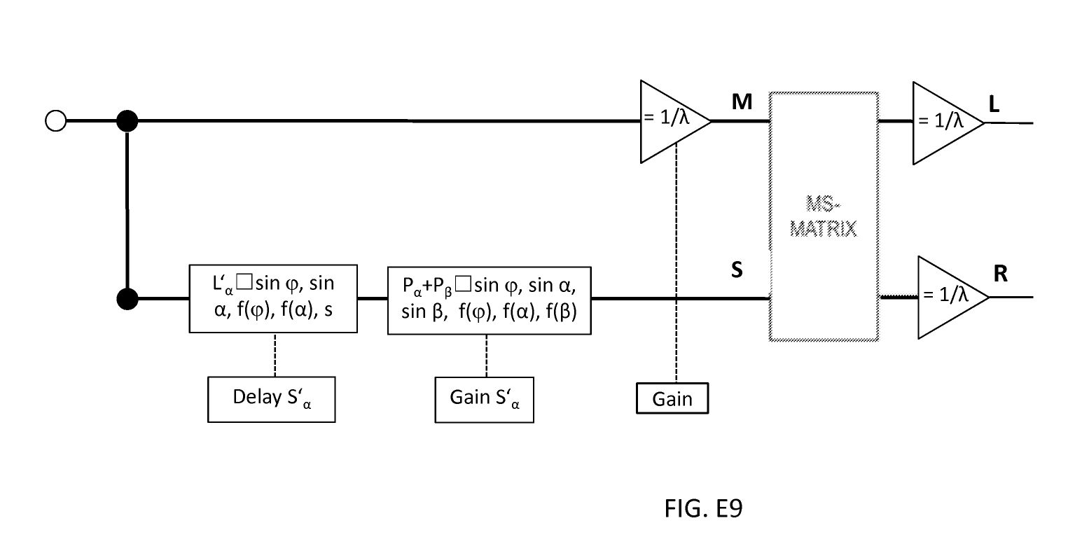

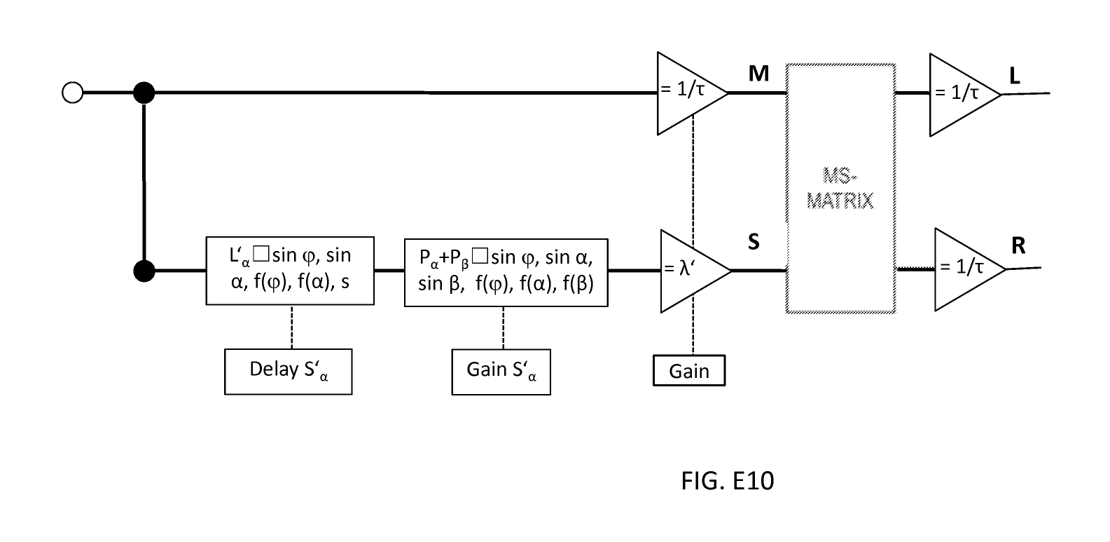

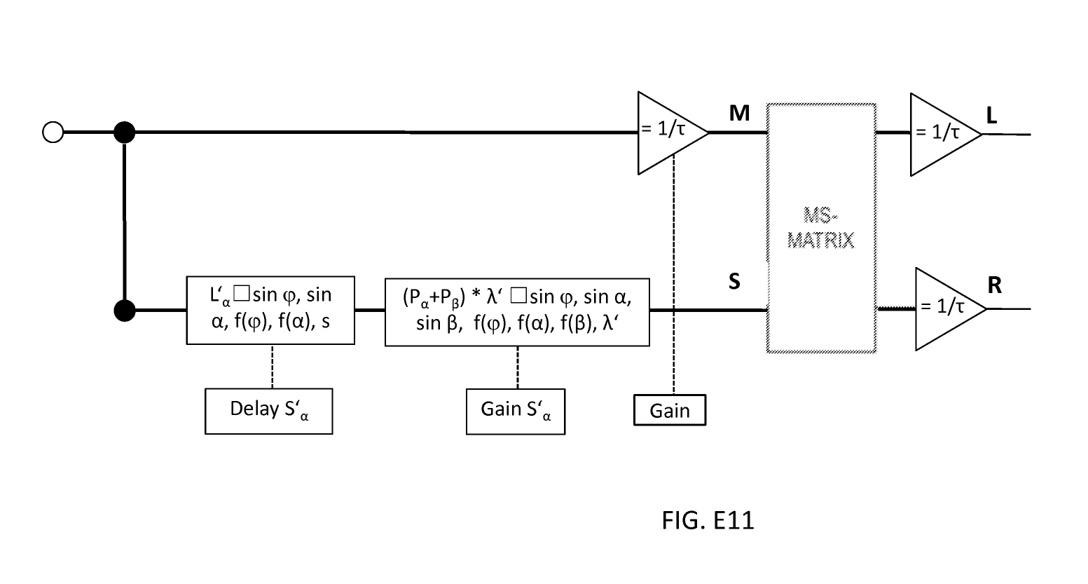

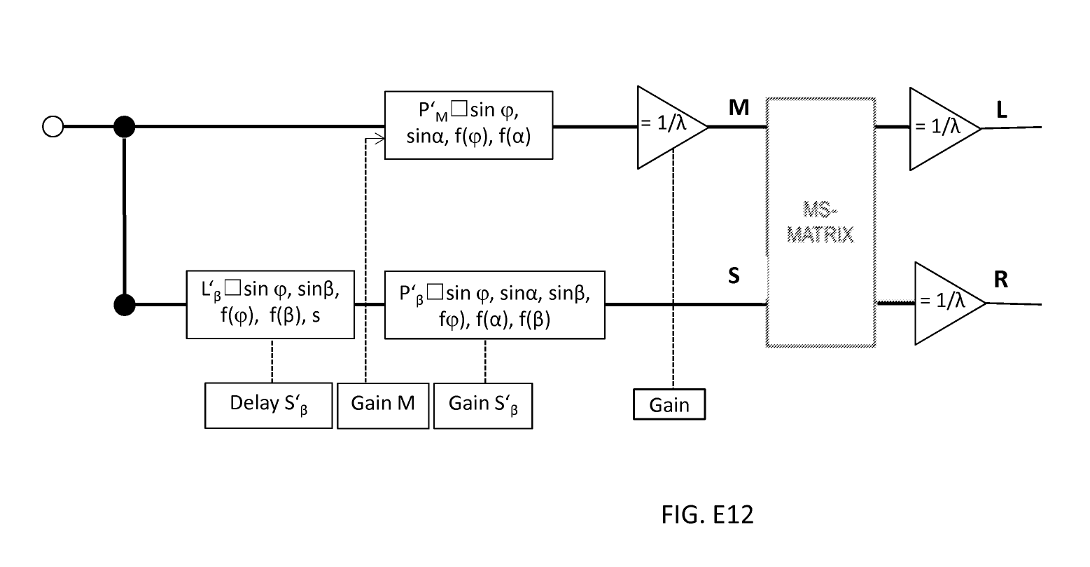

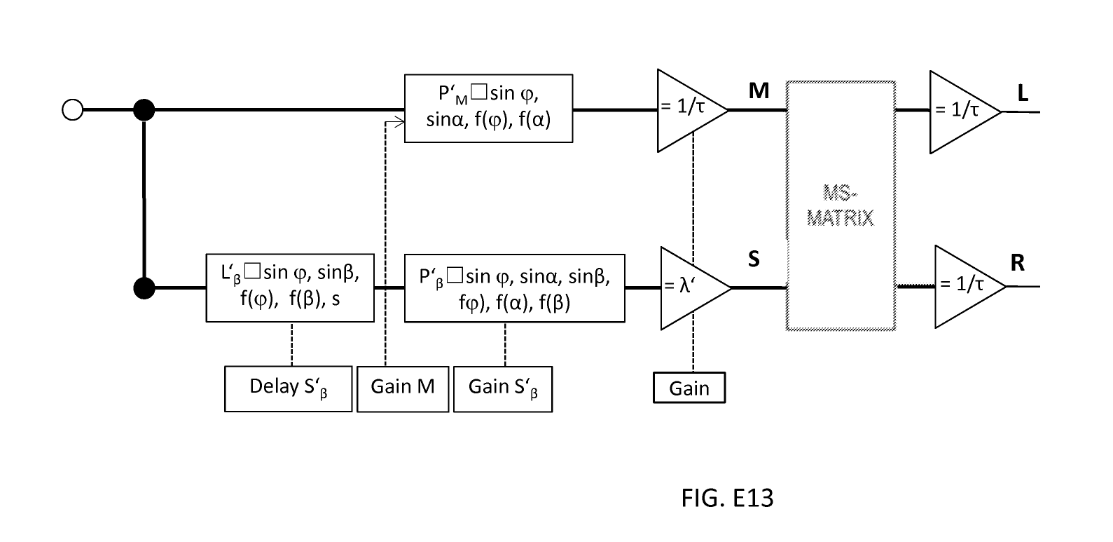

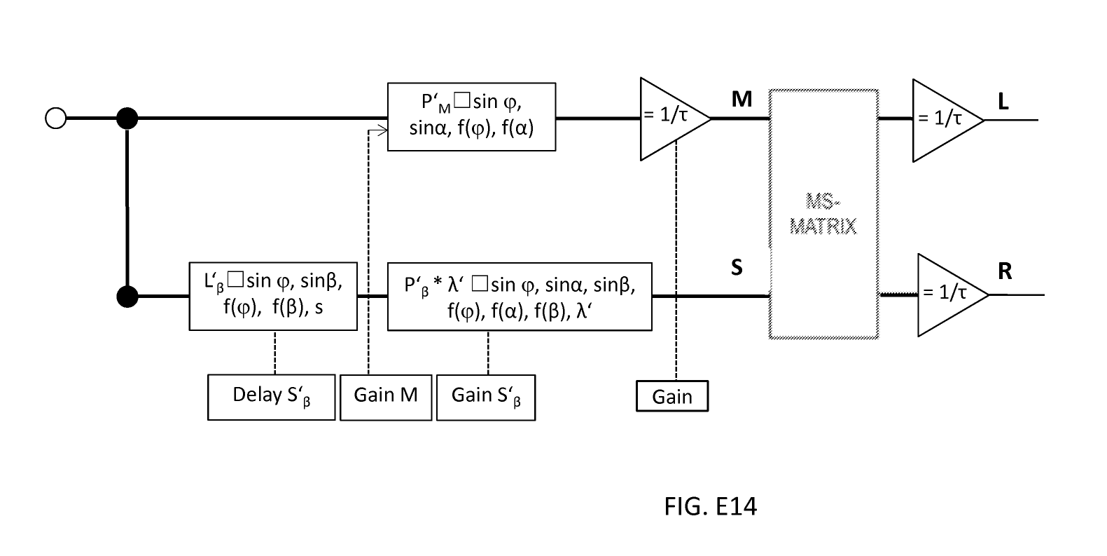

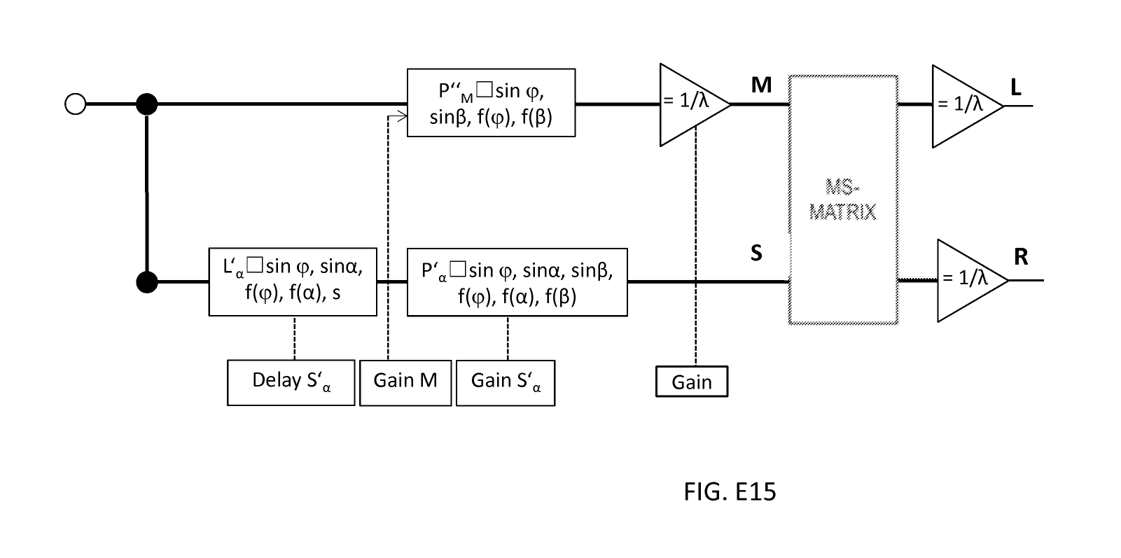

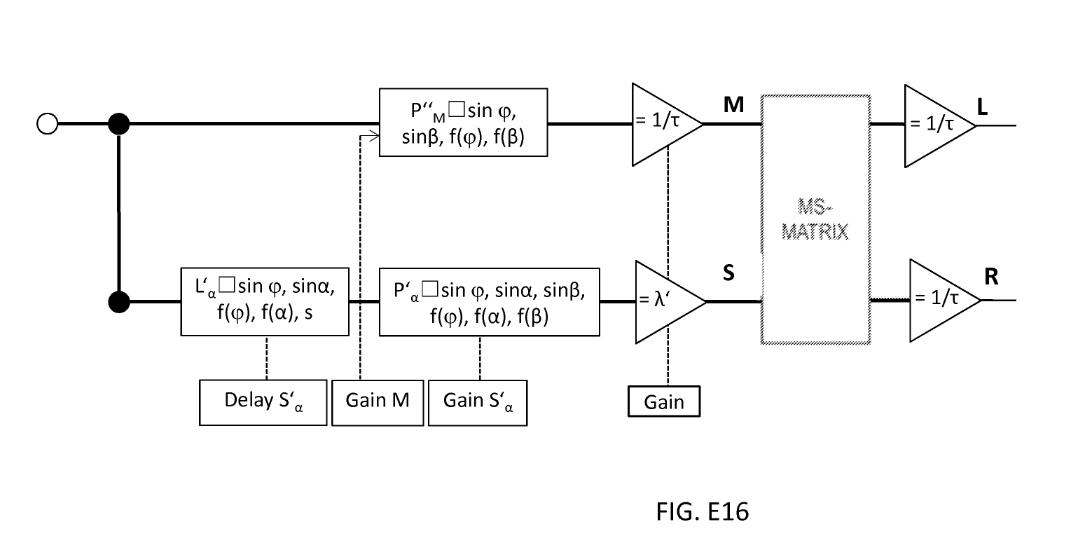

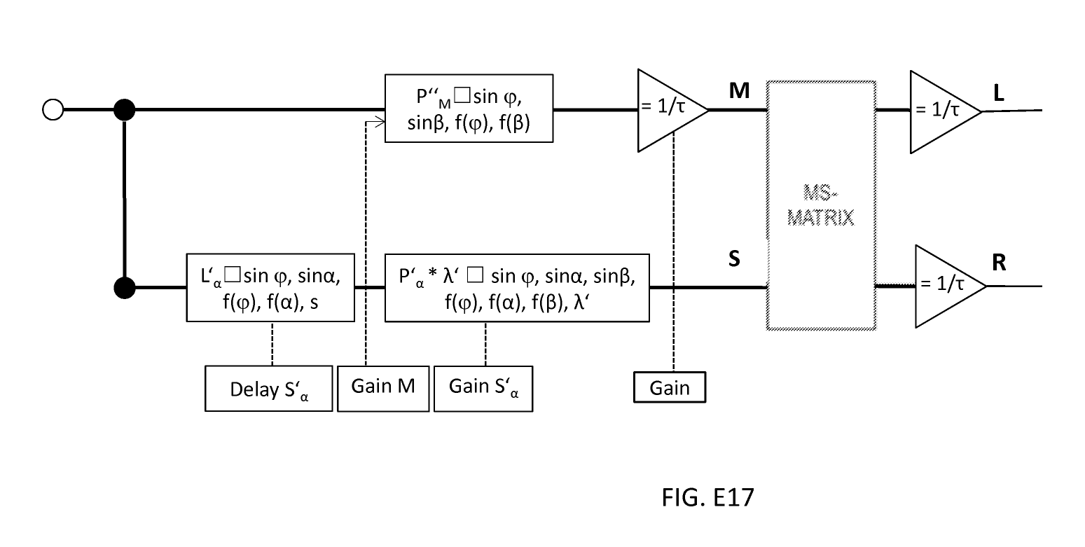

P_{α}′=[f²(α)/4+f²(φ)−(f(α)*f(φ)*sin φ)]/[f²(β)/4+f²(φ)+(f(β)*f(φ)*sin φ)]

where 1/P_{M}″=[f²(β)/4+f²(φ)+(f(β)*f(φ)*sin φ)] may not be equal to zero nor an element of an environment of zero. Under the condition L_{α}′=L_{β}′ it is possible with sin α=sin β=1 to further simplify with the above formulae (see below) the FIG. 17D, FIG. 18D, FIG. 19D, FIG. 20D, FIG. 21D, FIG. 22D, FIG. 23D, FIG. 24D, FIG. 25D, FIG. 26D, FIG. 27D, FIG. 28D resp. FIG. E9, FIG. E10, FIG. E11, FIG. E12, FIG. E13, FIG. E14, FIG. E15, FIG. E16, FIG. E17. In particular, see below, it is also possible here in FIG. E14 to integrate the amplification factor 1/τ (which is then to be multiplied with the amplification factor P_{M}′) into the gain M, resp. in FIG. E17 to integrate the amplification factor 1/τ (which is then to be multiplied with the amplification factor P_{M}″) into the gain M.

The choice of s, as shown in practice, is not trivial. If s is chosen too small, the pseudostereophonic effect to be achieved disappears, if s is chosen too great, disturbing artifacts will result. If s is about 100 milliseconds, this will yield for a modified device or a method according to WO2009/138205 or WO2011/009649 ideal pseudostereophonic signals that exhibit the same quality as with a classic MS recording technique.

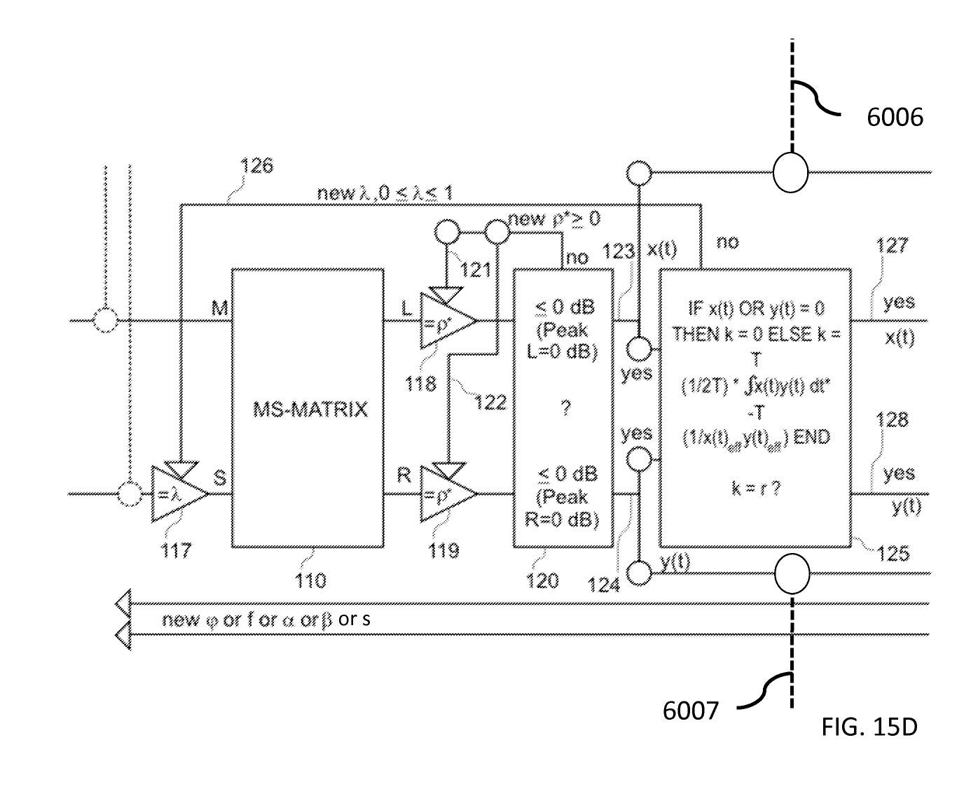

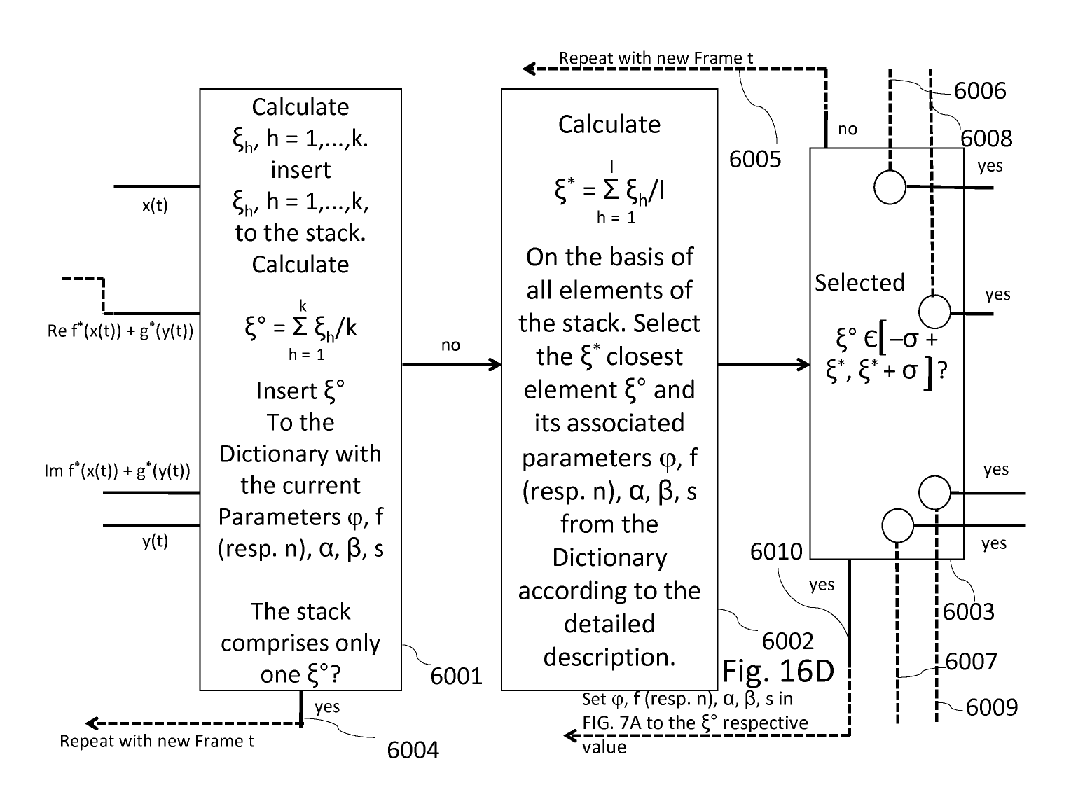

If the object of the invention is applied to WO2011/009649 or WO2011/009650, in particular to FIG. 1B as well as FIG. 4B (feedback 437a) and FIG. 5B (feedback 539a), it is not only the parameters φ resp. f (resp. n) resp. α resp. β that are optimized iteratively but henceforth newly also the parameter s>0 introduced according to the invention, in a new manner and as represented in FIG. 15D, using the same evaluation method described above. The overall system presented in WO2011/009649 or WO2011/009650 resp. CH01264/10 resp. PCT/EP2011/063322 in this case remains fully preserved with the addition of the just mentioned element (wherein FIG. 1B is hereinafter to be replaced with FIG. 15D).

If a system according to CH01264/10 resp. PCT/EP2011/063322 is to be added according to the invention, FIG. 6C is to be replaced by FIG. 16D. In more detail, a first optimization according to CH01776/09 resp. WO2011/009650, FIG. 15D, 2B, 3B to 5B, is performed on a signal section of the length t₁. The outputs of FIG. 5B are connected for example to a module 6001 according to FIG. 16D and the invariants (constituted at the intersection points ξₕ₁₀f the sum of the complex transfer functions f*[x(t₁)]=[x(t₁)/√ 2̅]*(−1+i) and g*[y(t₁)]=[y(t₁)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξₕ₁ from the total number k₁ are stored in a memory (“stack”) valid for all further described operation sequences; the mean value

$${ξ}_{1}^{∘} := ( {\sum }_{{h}_{1} = 1}^{{k}_{1}} {ξ}_{h 1} ) / {k}_{1}$$

is likewise calculated. The latter is stored together with the parameterization φ₁, f₁ (resp. n₁), α₁, β₁, s₁ determined by means of said first optimization, in a dictionary further valid for all further described operation sequences.

According to the function command 6004 of FIG. 16D, in a second step a second optimization according to WO2011/009650, FIG. 15D, 2B, 3B to 5B, is then performed on a signal section t₂ of any length. The outputs of FIG. 5B are in turn connected to the module 6001 of FIG. 16D and the invariants (constituted in the intersection points ξₕ₂ of the sum of the complex transfer functions f*[x(t₂)]=[x(t₂)/√ 2̅]*(−1+i) and g*[y(t₂)]=[y(t₂)/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₂ of the represented algebraic model coincides here with the real axis, the axis x₂, u₂ with the imaginary axis) are analyzed in terms of their statistical distribution. All ξₕ₂ from the total number k₂ are stored in a memory (“stack”) valid for all further described operation sequences; the mean value

$${ξ}_{2}^{∘} := ( {\sum }_{{h}_{2} = 1}^{{k}_{2}} {ξ}_{h 2} ) / {k}_{2}$$

is likewise calculated. The latter is in turn added together with the parameterization φ₂, f₂ (resp. n₂), α₂, β₂, s₂ determined by means of said second optimization, to the first mean value ξ^{o}₁ as well as its parameterization φ₁, f₁ (resp. n₁), α₁, β₁, s₁ in the dictionary valid for all further described operation sequences. Since the memory (“stack”) now contains more than one mean value, the module 6002 of FIG. 16D is then activated.

The latter calculates the mean value ξ*₂ of all intersection points ξₕ₁, ξₕ₂ stored in the stack:

$${ξ}_{2}^{∘} := ( {\sum }_{{h}_{1} = 1}^{{k}_{1}} {ξ}_{h 1} + {\sum }_{{h}_{2} = 1}^{{k}_{2}} {ξ}_{h 2} ) / ( {k}_{1} + {k}_{2} )$$

and selects from the dictionary among the mean values ξ^{o}₁, ξ^{o}₂ with their associated parameterization the mean value closest to ξ*₂. If this is the case for both mean values ξ^{o}₁, ξ^{o}₂, ξ^{o}₁ resp. the parameterization φ₁, f₁ (resp. n₁). α₁, β₁, s₁ is selected from the dictionary. The mean value selected from the dictionary is then transmitted together with ξ*₂ to the module 6003 of FIG. 16D. The latter verifies whether the mean value selected by the module 6002 is within the interval [−σ+ξ*₂, ξ*₂+σ], where σ>0 represents the standard deviation, freely selectable by the user, of the Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)}

If the mean value selected by the module 6002 of FIG. 16D is within the interval [−σ+ξ*₂, ξ*₂+σ], the parameterization selected by the module 6002 of FIG. 16D according to 6010 of FIG. 16D in the arrangement of FIG. 6D resp. FIG. 15D (which shows again for the sake of clarity the amplifier 717 and the MS matrix, wherein both of which are to be passed through only once) resp. the outputs 6006 and 6007 of FIG. 15D are activated, likewise the outputs 6008 and 6009 of FIG. 2B. The output 6006 of FIG. 15D runs into the input 6006 of FIG. 16D, the output 6007 of FIG. 15D runs into the input 6007 of FIG. 16D, the output 6008 of FIG. 2B runs into the input 6008 of FIG. 16D and the output 6009 of FIG. 2B runs into the input 6009 of FIG. 16D. Reference 6006 of FIG. 16D directly represents the output signal x(t) from the module 6003 of FIG. 16D, reference 6007 of FIG. 16D directly represents the output signal y(t) from the module 6003 of FIG. 16D, 6008 of FIG. 16D directly represents the output signal Re f*[x(t)]+g*[y(t)] from the module 6003 of FIG. 16D, 6009 of FIG. 16D directly represents the output signal Im f*[x(t)]+g*[y(t)] from the module 6003 of FIG. 16D. These signals, in the signal processing described above, are to be treated as if they represented the output signals of FIG. 5B, which with FIG. 16D then constitutes, in this example of application, an inseparable unit.

If the mean value selected by the module 6002 is outside the interval [−σ+ξ*₂, ξ*₂+σ], in a q^{th} step a q^{th} optimization is performed according to WO2011/009650, FIG. 15D, 2B, 3B to 5B on a signal section t_{q} of any length. The outputs of FIG. 5B are in turn connected to the module 6001 of FIG. 16D and the invariants (constituted at the intersection points ξ_{hq} of the sum of the complex transfer functions f*[x(t_{q})]=[x(t_{q})/√ 2̅]*(−1+i) and g*[y(t_{q})]=[y(t_{q})/√ 2̅]*(1+i) with the half-plane spanned by the vectors (1, 1, −2) and (1, 1, 1) or also (−1, −1, 2) and (1, 1, 1) and located in the 1^{st} or also 3^{rd} quadrants of the complex number plane—the axis of x₁, u₁ of the represented algebraic model coincides here with the real axis, the axis x₂, u₂ with the imaginary axis) are analyzed in terms of their statistical distribution. All ξ_{hq} from the total number k_{q} are added to ξₕ₁, ξₕ₂, . . . , ξ_{q-1} in a memory (“stack”) valid for all further described operation sequences; the mean value

$${ξ}_{q}^{∘} := ( {\sum }_{{h}_{q} = 1}^{{k}_{q}} {ξ}_{h q} ) / {k}_{q}$$

is likewise calculated. The latter is in turn added together with the parameterization φ_{q}, f_{q} (resp. n_{q}), α_{q}, β_{q}, s_{q} determined by means of said q^{th} optimization, to the first mean values ξ^{o}₁, ξ^{o}₁, . . . , ξ^{o}_{q-1} as well as to their parameterizations φ₁, f₁ (resp. n₁), α₁, β₁, s₁; φ₂, f₂ (resp. n₂), α₂, β₂, s₁; . . . ; φ_{q-1}, f_{q-1} (resp. n_{q-1}), α_{q-1}, β_{q-1}, s_{q-1}, in the dictionary valid for all further described operation sequences. Since the memory (“stack”) now contains more than one mean value, the module 6002 of FIG. 16D is then activated.

The latter calculates the mean value ξ*_{q} of all intersection points ξₕ₁, ξₕ₂, . . . , ξ_{hq} stored in the stack:

$${ξ}_{q}^{∘} := ( {\sum }_{{h}_{1} = 1}^{{k}_{1}} {ξ}_{h 1} + {\sum }_{{h}_{2} = 1}^{{k}_{2}} {ξ}_{h 2} + … + {\sum }_{{h}_{q} = 1}^{{k}_{q}} {ξ}_{hq} ) / ( {k}_{1} + {k}_{2} + … {k}_{q} )$$

and selects from the dictionary among the mean values ξ^{o}₁, ξ^{o}₂, . . . , ξ^{o}_{q} with their associated parameterization φ, f (resp. n), α, β, s, the mean value closest to ξ*_{q}. If this is the case for different parameterizations, the parameterization that appears most often in the dictionary is selected. If several parameterizations appear the same number of times, the one that exhibits the widest scattering in the dictionary is selected, i.e. the one for which the difference d−c is maximum, where d represents the last and c the first index number of the optimization steps respectively undergone. If this too applies to several parameterizations, the first one that appears is selected. If two mean values from ξ^{o}₁, ξ^{o}₂, . . . , ξ^{o}_{q} are close to ξ*_{q}, insofar as in a q−1^{th} step one of the two mean values resp. their associated parameterizations is selected from the dictionary, the very same one resp. its associated parameterizations is retained. The mean value selected from the dictionary is then transmitted together with ξ*_{q} to the module 6003 of FIG. 16D. The latter verifies whether the mean value selected by the module 6002 of FIG. 16D is within the interval [−σ+ξ*_{q}, ξ*_{q}+σ], where σ>0 represents the standard deviation, freely selectable by the user at the beginning of the entire process illustrated here, of the Gauss distribution fictitiously set as zero in ξ*_{q}:

f^{∪}(z_{q}*)=(1/(√(2π)*σ))e^{-(1/2)*(((z}^{_{q}}^{*-ξ*}^{_{q}}^{)̂2)/σ̂2)}

If the mean value selected by the module 6002 of FIG. 16D is within the interval [−σ+ξ*_{q}, ξ*_{q}+σ], the parameterization selected by the module 6002 of FIG. 16D according to 6010 of FIG. 16D in the arrangement of FIG. 6D resp. FIG. 15D resp. the outputs 6006 and 6007 of FIG. 15D are activated, likewise the outputs 6008 and 6009 of FIG. 2B as well as the corresponding inputs and outputs of FIG. 16D. The output 6006 of FIG. 15D runs into the input 6006 of FIG. 16D, the output 6007 of FIG. 15D runs into the input 6007 of FIG. 16D, the output 6008 of FIG. 2B runs into the input 6008 of FIG. 16D and the output 6009 of FIG. 2B runs into the input 6009 of FIG. 16D. Reference 6006 of FIG. 16D again directly represents the output signal x(t) from the module 6003 of FIG. 16D, reference 6007 directly represents the output signal y(t) from the module 6003 of FIG. 16D, 6008 of FIG. 16D directly represents the output signal Re f*[x(t)]+g*[y(t)] from the module 6003 of FIG. 16D, 6009 of FIG. 16D directly represents the output signal Im f*[x(t)]+g*[y(t)] from the module 6003 of FIG. 16D. These signals, in the signal processing described above, are again to be treated as if they represented the output signals of FIG. 5B, which with FIG. 16D constitutes, in the present example of application, an inseparable unit.

If the mean value selected by the module 6002 of FIG. 16D is outside the interval [−σ+ξ*_{q}, ξ*_{q}+σ], in a q+1^{th} step a q+1^{th} optimization is performed in the same form as for the q^{th} step and for the q^{th} optimization. The process is repeated as long as necessary until one element of the dictionary fulfills the above requirements or a maximum number of allowed optimization steps has been reached.

FIG. 5C shows the convergence behavior of the just established weighting function for three optimization steps: 5001 represents in this case the first mean value ξ^{o}₁, 5002 the second mean value ξ^{o}₂, 5003 the first Gauss distribution fictitiously set as zero in ξ*₂:

f^{∪}(z₂*)=(1/(√(2π)*σ))e^{-(1/2)*(((z}^{₂}^{*-ξ*}^{₂}^{)̂2)/σ̂2)}

where σ>0 represents the standard deviation, freely selectable by the user at the beginning of the entire process illustrated here, 5004 the third mean value ξ^{o}₃, which remains within the inflexion points defined by a of the Gauss distribution 5005 of same standard deviation, fictitiously set as zero in ξ*₃, and thus fulfills the convergence criterion.

In each case, the result is a parameterization φ, f (resp. n), α, β and henceforth newly s, which supplies a pseudostereophonic function that on average is optimum in relation to all algebraic invariants.

As the number of signal sections increases, the distribution of the intersection points ξ of the algebraic invariants on the half-plane respectively analyzed with the complex number plane approximates the Gauss distribution. The smaller the chosen standard deviation σ is, the closer to ideal the resulting parameterization will be. However, as an only finite number of signal sections are available, σ should not be chosen too small.

Nevertheless, the method represented in FIG. 16D in terms of its convergence is considerably faster for sufficiently long signal sections than mentioned simulation models, since algebraic invariants are available for the first time to serve as valid “points of reference” for a weighting of already determined parameterizations.

Hereinafter two variant embodiments, represented in FIG. 13D and FIG. 14D, are presented using the modified MS matrix described by the equations (1A) and (2A).

Two further variant embodiments, illustrated in FIG. 7D and FIG. 8D, of the circuits of FIG. 3D and FIG. 4D, derived from FIG. E3 and FIG. E6, which in turn can be derived from the equations (3A) and (4A) resp. from FIG. 4A and FIG. 5A for the special case of identical inversely proportional attenuations λ=ρ, are also presented. The panorama potentiometers 411 and 412 of FIG. 3D are in this case replaced with an amplifier 717 with the amplification factor λ; the same applies for the panorama potentiometers 511 and 512 of FIG. 4D.

According to the equations (3AA) and (4AA), the variant embodiments of FIG. 9D and FIG. 11D can be derived from FIG. 7D and FIG. 8D and, in the same way, according to the equations (3AAA) and (4AAA) the variants of FIG. 10D and FIG. 12D can be derived.

FIG. 17D illustrates a simplification of the circuit schema 309 of FIG. 2D for the case L′_{α}=L′_{β}. This case arises for example when the fictitious opening angles are symmetrical with the main axis, i.e. for α=β, wherein φ=0 applies.

FIG. 18D illustrates a simplification of the circuit schema of FIG. 6A for the case L′_{α}=L′_{β}. This case arises for example when the fictitious opening angles are symmetrical with the main axis, i.e. for α=β, wherein φ=0 applies.

FIG. 19D illustrates a simplification of FIG. 6D, likewise for the case L′_{α}=L′_{β}. This case arises for example when the fictitious opening angles are symmetrical with the main axis, i.e. for α=β, wherein φ=0 applies. Such a simplification already supplies convincing results that rival a first-class MS recording, and is thus not trivial.

FIG. 20D illustrates a circuit equivalent to FIG. 19D, wherein the amplification factor λ is directly integrated in gain S′_{α}. It represents the simplest circuit form that in its exact angle-dependent virtualization of a classical MS array is not trivial.

FIG. 21D illustrates a simplification of the circuit schema 409 of FIG. 3D likewise for the case L′_{α}=L′_{β}. This case arises for example when the fictitious opening angles are symmetrical with the main axis, i.e. for α=β, wherein φ=0 applies. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. 22D illustrates a simplification of the circuit schema of FIG. 13D likewise for the case L′_{α}=L′_{β}. This case arises for example when the fictitious opening angles are symmetrical with the main axis, i.e. for α=β, wherein φ=0 applies. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. 23D illustrates an inventive simplification derived from FIG. 3D, likewise for the case L′_{α}=L′_{β}, wherein the elements 411 and 412—provided that the attenuation fo the left input signal λ is equal to the attenuation for the right input signal ρ—are replaced with the amplification of the S signal by the factor λ represented here (for deriving this fact, see the above formulae (3A) and (4A)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. 24D illustrates a circuit equivalent to FIG. 23D, wherein the amplification factor λ is directly integrated in gain S′_{β}. It represents a simple circuit form that in its exact angle-dependent virtualization of a classical MS array is however not trivial. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. 25D illustrates a simplification of the circuit schema 509 of FIG. 4D likewise for the case L′_{α}=L′_{β}. This case arises for example when the fictitious opening angles are symmetrical with the main axis, i.e. for α=β, wherein φ=0 applies. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

FIG. 26D illustrates a simplification of the circuit schema of FIG. 14D likewise for the case L′_{α}=L′_{β}. This case arises for example when the fictitious opening angles are symmetrical with the main axis, i.e. for α=β, wherein φ=0 applies. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

FIG. 27D illustrates an inventive simplification derived from FIG. 4D likewise for the case L′_{α}=L′_{β}, wherein the elements 511 and 512—provided that the attenuation fo the left input signal λ is equal to the attenuation for the right input signal ρ—are replaced with the amplification of the S signal by the factor λ represented here (for deriving this fact, see the above formulae (3A) and (4A)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

FIG. 28D illustrates a circuit equivalent to FIG. 27D, wherein the amplification factor λ is directly integrated in gain S′_{α}. It represents a simple circuit form that in its exact angle-dependent virtualization of a classical MS array is however not trivial. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

When applying the considerations on FIG. E1 and FIG. E2, see above, the variant embodiments illustrated enable furthermore the following new variants according to FIG. E9, FIG. E10, FIG. E11, FIG. E12, FIG. E13, FIG. E14, FIG. E15, FIG. E16 and FIG. E17 for the special case of identical inversely proportional attenuations λ=ρ.

FIG. E9, taking into account FIG. E1 resp. the equations (3AA) and (4AA) illustrates a simplification of FIG. 6D likewise for the case L′_{α}=L′_{β}. This case arises for example when the fictitious opening angles are symmetrical with the main axis, i.e. for α=β, wherein φ=0 applies. Such a simplification already supplies convincing results that rival a first-class MS recording, and is thus not trivial.

FIG. E10, taking into account FIG. E2 resp. the equations (3AAA) and (4AAA), illustrates a simplification of FIG. 6D likewise for the case L′_{α}=L′_{β}. This case arises for example when the fictitious opening angles are symmetrical with the main axis, i.e. for α=β, wherein φ=0 applies. Such a simplification already supplies convincing results that rival a first-class MS recording, and is thus not trivial.

FIG. E11, taking into account FIG. E2 resp. the equations (3AAA) and (4AAA), illustrates a circuit equivalent to FIG. E10, wherein the amplification factor λ′ is directly integrated in gain S′_{α}. It represents the simplest circuit form that in its exact angle-dependent virtualization of a classical MS array is not trivial.

FIG. E12, taking into account FIG. 23D resp. the equations (3AA) and (4AA), illustrates an inventive simplification derived from FIG. 3D, likewise for the case L′_{α}=L′_{β}, wherein the elements 411 and 412—provided that the attenuation of the left input signal λ is equal to the attenuation for the right input signal ρ—are replaced with the amplification of the M signal by the factor 1/λ represented here (for deriving this fact, see the above formulae (3AA) and (4AA)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. E13, taking into account FIG. 23D resp. the equations (3AAA) and (4AAA), illustrates an inventive simplification likewise derived from FIG. 3D, likewise for the case L′_{α}=L′_{β}, wherein the elements 411 and 412—provided that the attenuation of the left input signal λ is equal to the attenuation for the right input signal ρ—are replaced with the amplification of the M signal by the factor 1/τ resp. the amplification of the S signal by the factor λ′ represented here (for deriving this fact, see the above formulae (3AAA) and (4AAA)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. E14, taking into account FIG. 23D resp. the equations (3AAA) and (4AAA), illustrates a circuit equivalent to FIG. E13, wherein the amplification factor λ′ is directly integrated in gain S′_{β}. It represents a simple circuit form that in its exact angle-dependent virtualization of a classical MS array is not trivial. As mentioned in WO2009/138205, for this simplification also the following expression applies:

f²(α)/(4 sin² α)+f²(φ)−(f(α)*f(φ)*sin φ)/sin α

may not be equal to zero nor an element of an environment of zero.

FIG. E15, taking into account FIG. 27D resp. the equations (3AA) and (4AA), illustrates an inventive simplification derived from FIG. 3D, likewise for the case L′_{α}=L′_{β}, wherein the elements 511 and 512—provided that the attenuation of the left input signal λ is equal to the attenuation for the right input signal ρ—are replaced with the amplification of the M signal by the factor 1/λ represented here (for deriving this fact, see the above formulae (3AA) and (4AA)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

FIG. E16, taking into account FIG. 27D resp. the equations (3AAA) and (4AAA), illustrates an inventive simplification derived from FIG. 4D, likewise for the case L′_{α}=L′_{β}, wherein the elements 511 and 512—provided that the attenuation of the left input signal λ is equal to the attenuation for the right input signal ρ—are replaced with the amplification of the M signal by the factor 1/τ resp. the amplification of the S signal by the factor λ′ represented here (for deriving this fact, see the above formulae (3AAA) and (4AAA)). The case L′_{α}=L′_{β} arises for example when the fictitious opening angles are symmetrical with the main axis, i.e. for α=β, wherein φ=0 applies. Such a simplification also supplies convincing results that rival a first-class MS recording, and is thus not trivial. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

FIG. E17, taking into account FIG. 27D resp. the equations (3AAA) and (4AAA), illustrates a circuit equivalent to FIG. E16, wherein the amplification factor λ′ is directly integrated in gain S′_{α}. It represents a simple circuit form that in its exact angle-dependent virtualization of a classical MS array is not trivial. As mentioned in WO2009/138205, for this simplification also the following expression applies:

f²(β)/(4 sin² β)+f²(φ)+(f(β)*f(φ)*sin φ)/sin β

may not be equal to zero nor an element of an environment of zero.

In the same way, incidentally, in FIG. E14 the amplification factor 1/τ (which is then to be multiplied with the amplification factor P_{M}′) can be integrated into the gain M resp. in FIG. E17 the amplification factor 1/τ (which is then to be multiplied with the amplification factor P_{M}″) can be integrated into the gain M.

Similarly, in FIG. E12 the amplification factor 1/λ (which is then to be multiplied with the amplification factor P_{M}′) can be integrated into the gain M resp. in FIG. E15 the amplification factor 1/λ (which is then to be multiplied with the amplification factor P_{M}″) can be integrated into the gain M.

N.B. FIG. 11F shows the total possible parameter combinations for the parameter f (resp. n) which describe the directional pattern of the signal that is to be rendered stereophonic, the angle φ—to be ascertained manually or by metrology—enclosed by the main axis and the sound source, the fictitious left opening angle α and the fictitious right opening angle β. These parameter combinations, which each include one line of FIG. 11F, can be derived from the following equations (1D) and (2D) as well as from the amplification factors P_{α} resp. P_{β} resp. P_{α}′ resp. P_{β}′ resp. P_{M}′ resp. P_{M}″ formed from the discriminants of the equations (1D) and (2D) according to WO2009/138205, wherein “X” designates those parameters of the following equations on which the respective circuit depends; other parameters yield constants or values equal to 1 or 0. The associated comments represent concrete cases in which the respective parameter combination is encountered. In particular, for FIG. 15 of WO2009/138205, the following equations apply:

L_{α}′=L_{α}*s={−f(α)/(2 sin α)+√[f²(α)/(4 sin² α)+f²(φ)−(f(α)*f(φ)*sin φ)/sin α]}*s (1D)

and

L_{β}′=L_{β}*s={−f(β)/(2 sin β)+√[f²(β)/(4 sin² β)+f²(φ)+(f(β)*f(φ*sin φ)/sin β]}*s (2D)

as well as

P_{α}=f²(α)/(4 sin² α)+f²(φ)−(f(α)*f(φ)*sin φ)/sin α

and

P_{α}=f²(β)/(4 sin² β)+f²(φ)+(f(β)*f(φ)*sin φ)/sin β,

for the FIG. 16 of WO2009/138205 the equations

L_{α}′=L_{α}*s={−f(α)/(2 sin α)+√[f²(α)/(4 sin² α)+f²(φ)−(f(α)*f(φ)*sin φ)/sin α]}*s (1D)

and

L_{β}′=L_{β}*s={−f(β)/(2 sin β)+√[f²(β)/(4 sin² β)+f²(φ)+(f(β)*f(φ)*sin φ)/sin β]}*s (2D)

as well as

P_{M}′=1/[f²(α)/(4 sin² α)+f²(φ)−(f(α)*f(φ)*sin φ)/sin α]

and

P_{β}′=[f²(β)/(4 sin² β)+f²(φ)+(f(β)*f(φ)*sin φ)/sin β]/[f²(α)/(4 sin² α)+f²(φ)−(f(α)*f(φ)*sin φ)/sin α],

where the expression [f²(α)/(4 sin² α)+f²(φ)−(f(α)*f(φ)*sin φ)/sin α] may not be equal to zero nor an element of an environment of zero,
and for the FIG. 17 of WO2009/138205 the equations

L_{α}′=L_{α}*s={−f(α)/(2 sin α)+√[f²(α)/(4 sin² α)+f²(φ)−(f(α)*f(φ)*sin φ)/sin α]}*s (1D)

and

L_{β}′=L_{β}*s={−f(β)/(2 sin β)+√[f²(β)/(4 sin² β)+f²(φ)+(f(β)*f(φ)*sin β)/sin β]}*s (2D)

as well as

P_{M}″=1/[f²(β)/(4 sin² β)+f²(φ)+(f(β)*f(φ)*sin φ)/sin β]

and

P_{α}′=[f²(α)/(4 sin² α)+f²(φ)−(f(α)*f(φ)*sin φ)/sin α]/[f²(β)/(4 sin² β)+f²(φ)+(f(β)*f(φ)*sin φ)/sin β],

where the expression [f²(β)/(4 sin² β)+f²(φ)+(f(β)*f(q))*sin φ)/sin β] may not be equal to zero nor an element of an environment of zero. The principles given above by way of example for the simplification of the circuit schemata according to FIG. 15 resp. FIG. 16 resp. FIG. 17 of WO2009/138205 or also according to EP1850639 for the case L_{α}′=L_{β}′ or P_{α}=P_{β} or also for the case of identical disciminants of L_{α}′ and L_{β}′, if appropriate in combination with the inversely proportional attenuations λ or ρ or with the amplification factors 1/λ or 1/τ or λ′, can be applied in the same way on the circuit schemata obtained according to FIG. 11F. In particular, FIG. 11F shows—see for example the cases of constant values for the angle φ—that the angle (φ) to be ascertained manually or by metrology, enclosed by the main axis and the sound source, can also be chosen or stipulated arbitrarily.

N.B. If φ lies to the left of the main axis of the mono signal that is to be rendered stereophonic, φ is positive; if on the contrary φ lies to the right of the main axis of the mono signal that is to be rendered stereophonic, φ is negative.

N.B. In particular, instead of the respective calculation of the time differences L_{α} or L_{β} or L_{A} or L_{B} or L_{α}′ or L_{β}′ or L_{A}′ or L_{B}′ resp. of the amplification factors P_{α} or P_{β} or P_{α}′ or P_{β}′ or P_{M} or P_{M}′ or P_{M}″ or P_{A} or P_{B}, if appropriate taking into account the inversely proportional attentuations λ or ρ or the amplification factors 1/λ or 1/τ or λ′, it is also possible to use a dictionary with corresponding values for the inventive delaying or amplification of the input signal that is to be rendered stereophonic. For example, α resp. β resp. φ can be varied in 5° steps and a corresponding dictionary can be created on the basis of the values obtained for the time differences L_{α} or L_{β} or L_{A} or L_{B} or L_{α}′ or L_{β}′ or L_{A}′ or L_{B}′ resp. for the amplification factors P_{α} or P_{β} or P_{α}′ or P_{β}′ or P_{M} or P_{M}′ or P_{M}″ or P_{A} or P_{B}, if appropriate taking into account the inversely proportional attentuations λ or ρ or the amplification factors 1/λ or 1/τ or λ′.

FIG. 4F illustrates the simplest form of application of all-pass filters to the object of the invention. It provides that for inventive arrangements according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, the characteristic good emphasis of the center sound sources is eliminated in favor of a dispersed sound with good source localization. For example, an all-pass filter of any order (see for example FIG. 1F resp. 2F) is connected downstream to the left and/or right channel of a stereophonic or pseudostereophonic output signal of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D. FIG. 4F, in connection with the object of the invention, thus provides for a convincing dispersation of the phantom sources of the resulting signal.

Similarly, a phase shifter (see for example FIG. 3F) connected downstream to the left and/or right channel of a stereophonic or pseudostereophonic output signal of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, provides an additional dispersation of the sound, see for example FIG. 5F. In particular, a combination of all-pass filters and phase shifters for the subsequently influencing of the sound image in a targeted manner is also possible.

All described arrangements can be used in particular on systems for reproducing sound with more than two loudspeakers. An approximation of multi-channel signals is especially made possible, as shown in FIG. 6F resp. FIG. 7F resp. FIG. 8F.

For example, according to FIG. 6F, a sideways-balanced five-channel signal according to Rec. ITU-R BS.774-1 (see FIG. 9F) can be derived from a mono signal. For this purpose, a mono signal M according to FIG. 6F is converted into a pseudostereophonic signal L, R by means of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D. Similarly, the signal L is converted into a pseudostereophonic signal LS, C₁ and similarly the signal R is converted into a pseudostereophonic signal C₂, RS. If during these conversions care is given to ensure that C₁ is approximately equal to C₂, the decoded five-channel signal according to Rec. ITU-R BS.775-1 (see FIG. 9F) with respect to table 2 of Rec. ITU-R BS.775-1 (see FIG. 10F) after being downmixed to the stereo 2/0 format is approximately identical to the (amplified) signal L, R, and after being downmixed to the mono 1/0 format is approximately identical to the (amplified) signal M. For example, an existing five-channel signal according to Rec. ITU-R BS.775-1 can thus be converted according to the disclosure of the invention on the basis of a monophonic signal with the addition of the respective filter parameters f (resp. n) resp. φ resp. α resp. β resp. λ resp. ρ or 1/λ or 1/τ resp. λ′ resp. s for L, R resp. LS, C₁ resp. C₂, RS, and this therefore results in bandwidth savings of nearly 80%!

A first variant embodiment, given by way of example, for decoding a five-channel signal according to Rec. ITU-R BS.775-1 with a good center sound emphasis is illustrated in FIG. 7F. In this case, the mono signal M is used directly as center channel C and from the latter, by means of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, is converted into a pseudostereophonic signal L, R. Similarly, the signal M resp. C is converted into a pseudostereophonic signal LS, RS. The decoded five-channel signal according to Rec. ITU-R BS.775-1 (see FIG. 9F) with respect to table 2 of the Rec. ITU-R BS.775-1 (see FIG. 10F) after being downmixed to the stereo-2/0 format does not correspond to the (amplified) signal L, R, yet after being downmixed to the mono-1/0 format corresponds exactly to the (amplified) signal M. For example, an existing five-channel signal according to Rec. ITU-R BS.775-1 can thus be converted according to the disclosure of the invention on the basis of a monophonic signal with the addition of the respective filter parameters f (resp. n) resp. φ resp. α resp. β resp. λ resp. ρ or 1/λ or 1/τ resp. λ′ resp. s for L, R resp. LS, RS, and this therefore results in bandwidth savings of nearly 80%!

If less value is set on bandwidth savings, the following variant embodiment according to FIG. 8F for deriving a five-channel signal according to ITU-R BS.775-1 with a good sideways balance is for example also possible. The signal L is directly used as signal M₁, and from the latter, converted into a pseudo-stereophonic signal LS, C₁ by means of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D. Similarly, the signal R is directly used as signal M₂, and from the latter converted in the same way into a pseudostereophonic signal C₂, RS. If during these conversions care is given to ensure that C₁ is approximately equal to C₂, the decoded five-channel signal according to Rec. ITU-R BS.775-1 (see FIG. 9F) with respect to table 2 of Rec. ITU-R BS.775-1 (see FIG. 10F) after being downmixed to the stereo 2/0 format is approximately identical to the (amplified) signal L, R, yet after being downmixed to the mono 1/0 format is approximately identical to the (amplified) signal M₁+M₂. For example, an existing five-channel signal according to Rec. ITU-R BS.775-1 can thus be converted according to the disclosure of the invention on the basis of a monophonic signal with the addition of the respective filter parameters f (resp. n) resp. φ resp. α resp. β resp. λ resp. ρ or 1/λ or 1/τ resp. λ′ resp. s for. LS, C₁ resp. C₂, RS, and this therefore results in bandwidth savings of nearly 60%!

By analogy, for n-channel systems for reproducing sounds, related arrangements can be achieved that altogether enable, by means of an inventive arrangement according to EP1850639 or WO2009/138205 or WO2011/009649 or WO2011/009650 or CH01264/10 resp. PCT/EP2011/063322 resp. FIG. E3 or also FIG. E4 or also FIG. E5 bzw. FIG. E6 or also FIG. E7 or also FIG. E8 resp. FIG. 9D or also FIG. 10D resp. FIG. 11D or also FIG. 12D resp. FIG. 13A resp. FIG. 14A resp. FIG. 13D resp. FIG. 14D resp. FIG. E1 or also FIG. E2 or also just described arrangements of the form of FIG. 17D resp. FIG. 19D or simplified FIG. 20D or also FIG. 21D resp. FIG. 23D or simplified FIG. 24D or also FIG. 25D resp. FIG. 27D or simplified FIG. 28D resp. FIG. E9 or also FIG. E10 or simplified FIG. E11 resp. FIG. E12 resp. FIG. E13 or simplified FIG. E14 resp. FIG. E15 or also FIG. E16 or simplified FIG. E17 resp. FIG. 18D resp. FIG. 22D resp. FIG. 26D, a coding on the basis of one or several signals with the addition of the respective filter parameters f (resp. n) resp. φ resp. α resp. β resp. λ resp. ρ or 1/λ or 1/τ resp. λ′ resp. s.

N.B. A series of elements of the described circuits can easily be exchanged, arranged differently, can be grouped into a single element or separated into several elements, based on individual parameters of the original element, including a series of trivial variations such as the cascading of several amplifiers etc. These variant embodiments, despite having not been explicitly mentioned, are part of the object of the invention.

N.B. Represented inventive arrangements or methods can additionally use prior art compression algorithms, data reduction methods etc. resp. the analysis of characteristic features, such as the minima or maxima for the faster evaluation in accordance with the invention of existing or generated signals or signal portions.

### BIBLIOGRAPHICAL REFERENCES

1. Tony Hirvonen, Athanasios Mouchtaris: On the Multichannel Sinusoidal Model for Coding Audio Object Signals.—AES Convention Paper 8418.
2. Rec. ITU-R BS. 775-1

1. Device for stereophonizing a mono signal resp. for obtaining pseudostereophonic signals, in which calculated time differences before they are used on a mono signal to be rendered stereophonic are multiplied with a time parameter greater than zero and thus new time differences are obtained.

2. Device according to claim 1, in which said time differences are calculated on the basis of an angle ascertained or stipulated manually or by metrology and enclosed by a sound source and a main axis of the mono signal to be rendered stereophonic.

3. Device according to claim 1, in which said time parameter is between 29 milliseconds and 146 milliseconds, preferably 100 milliseconds.

4. Device according to claim 1, in which said time parameter can be chosen freely by a user.

5. Device according to claim 1, in which a parameter describing a directional pattern of a signal that is to be rendered stereophonic, or the angle ascertained or stipulated manually or by metrology and enclosed by the main axis and the sound source, or a fictitious left opening angle or a fictitious right opening angle or an attenuation or amplification factors or a degree of correlation or a parameter for defining an allowable value range or a limit value for determining resp. maximizing an absolute value or a deviation or a parameter defining a localisation direction or a limit value for selecting an image width or a deviation or a limit value for optimizing the function values with respect to an image width or a deviation for forming a resulting stereo signal or said time parameter can be optimized automatically or interactively.

6. Device according to claim 1, in which either:
one stereo decoder for the pseudostereo conversion and two panorama potentiometers connected downstream thereto are passed through, wherein each panorama potentiometer forms two collective buses; or:
one stereo decoder for the pseudostereo conversion and one amplifier, connected upstream of the stereo decoder, for amplifying an input signal from the stereo decoder are passed through; or:
one stereo decoder for the pseudostereo conversion and respectively one amplifier connected upstream of the stereo decoder for each input signal of the stereo decoder are passed through; or:
a modified stereo decoder for the pseudostereo conversion, which contains an adder and a subtractor in order to add resp. to subtract input signals respectively amplified by predetermined factors, is passed through in order to generate signals that are identical with said collective bus signals.

7. Device according to claim 1, further comprising means for data compression or data reduction.

8. Device according to claim 1, further comprising at least one all-pass filter of first or second or n^{th} order.

9. Device according to claim 1, further comprising at least one phase shifter.

10. Device according to claim 1, further comprising:
means for obtaining a first pseudostereophonic signal L, R from a mono signal M,
means for obtaining a second pseudostereophonic signal LS, C₁ from the obtained signal L,
means for obtaining a third pseudostereophonic signal C₂, RS from the obtained signal R.

11. Device according to claim 1, further comprising outputs for signals for systems for reproducing sounds with n loudspeakers, wherein n≧2.

12. Device according to claim 1, further comprising a dictionary with values for the delaying or amplifying of the input signal to be rendered stereophonic, which is used instead of the respective calculation of the time differences (or of the amplification factors, if necessary taking into account the inversely proportional attenuations or the amplification factors.

13. Device according to claim 12, further comprising means that contain the dictionary in the interval [0, π/2] on the basis of values varied respectively by π/36.

14. Method for stereophonizing a mono signal resp. for obtaining pseudostereophonic signals, wherein calculated time differences before they are used on a mono signal to be rendered stereophonic are multiplied with a time parameter greater than zero and thus new time differences are obtained.

15. Method according to claim 14, wherein that said time differences are calculated on the basis of an angle ascertained or stipulated manually or by metrology and enclosed by a sound source and a main axis of the mono signal to be rendered stereophonic.

16. Method according to claim 14, wherein said time parameter is between 29 milliseconds and 146 milliseconds, preferably 100 milliseconds.

17. Method according to claim 14, wherein said time parameter can be chosen freely by a user.

18. Method according to claim 14, wherein a parameter describing a directional pattern of a signal that is to be rendered stereophonic, or the angle ascertained or stipulated manually or by metrology and enclosed by the main axis and the sound source, or a fictitious left opening angle or a fictitious right opening angle or an attenuation or amplification factors or a degree of correlation or a parameter for defining an allowable value range or a limit value for determining resp. maximizing an absolute value or a deviation or a parameter defining a localisation direction or a limit value for selecting an image width or a deviation or a limit value for optimizing the function values with respect to an image width or a deviation for forming a resulting stereo signal or said time parameter can be optimized automatically or interactively.

19. Method according to claim 14, wherein a parameter describing a directional pattern of a signal that is to be rendered stereophonic, or the angle ascertained or stipulated manually or by metrology and enclosed by the main axis and the sound source, or a fictitious left opening angle or a fictitious right opening angle or an attenuation or amplification factors or a degree of correlation or a parameter for defining an allowable value range or a limit value for determining resp. maximizing an absolute value or a deviation or a parameter defining a localisation direction or a limit value for selecting an image width or a deviation or a limit value for optimizing the function values with respect to an image width or a deviation (κ) for forming a resulting stereo signal or said time parameter are optimized on the basis of algebraic invariants.

20. Method according to claim 14, wherein
(a) the angle ascertained or stipulated manually or by metrology is analyzed; or:
(aa) an arbitrarily or algorithmically determined fictitious opening angle, lying to the left of a main axis, is not an element of an environment of zero nor equal to zero, and for which, provided said angle ascertained or stipulated manually or by metrology is positive, the condition is met that this angle ascertained or stipulated manually or by metrology is smaller than or equal to said fictitious opening angle lying to the left of the main axis, is analyzed; or:
(bb) an arbitrarily or algorithmically determined fictitious opening angle, lying to the right of a main axis, is not an element of an environment of zero nor equal to zero, and for which, provided said angle ascertained or stipulated manually or by metrology is negative, the condition is met that the value of this angle ascertained or stipulated manually or by metrology is smaller than or equal to said fictitious opening angle lying to the right of the main axis, is analyzed; or:
(cc) a directional characteristic, ascertained or also stipulated manually or by metrology, of the mono signal to be rendered stereophonic is analyzed; and overall:
(b) an amplification factor depending on said angle ascertained or stipulated manually or by metrology or on said fictitious opening angle or on a directional characteristic of the mono signal to be rendered stereophonic is calculated; or:
(c) an amplification factor depending on said angle (φ) ascertained or stipulated manually or by metrology or on said fictitious opening angle or on a directional characteristic of the mono signal to be rendered stereophonic is calculated; and overall:
(d) a delay time depending on said angle ascertained or stipulated manually or by metrology or on said fictitious opening angle or on a directional characteristic of the mono signal to be rendered stereophonic as well as overall on said time parameter is calculated; or:
(e) a delay time depending on said angle ascertained or stipulated manually or by metrology or on said fictitious opening angle or on a directional characteristic of the mono signal to be rendered stereophonic as well as overall on said time parameter is calculated; and overall:
(f) the mono signal to be rendered stereophonic is used directly as mid signal; as well as either:
(g) the mono signal to be rendered stereophonic is delayed by a delay time and subsequently amplified by an amplification factor; or alternatively: the mono signal to be rendered stereophonic is amplified by an amplification factor and subsequently delayed by a delay time; or alternatively, in case both said amplification factors are equal: the mono signal to be rendered stereophonic is delayed by a delay time and subsequently amplified by an amplification factor; or alternatively, in case both said amplification factors are equal: the mono signal to be rendered stereophonic is amplified by an amplification factor and subsequently delayed by a delay time; or alternatively, in case both said delay times are equal: the mono signal to be rendered stereophonic is delayed by a delay time and subsequently amplified by an amplification factor; or alternatively, in case both said delay times are equal: the mono signal to be rendered stereophonic is amplified by an amplification factor and subsequently delayed by a delay time; or alternatively, in case both said delay times are equal and both said amplification factors are equal: the mono signal to be rendered stereophonic is delayed by a delay time and subsequently amplified by an amplification factor; or alternatively, in case both said delay times are equal and both said amplification factors are equal: the mono signal to be rendered stereophonic is amplified by an amplification factor and subsequently delayed by a delay time;
(h) the mono signal to be rendered stereophonic is delayed by a delay time and subsequently amplified by an amplification factor; or alternatively: the mono signal to be rendered stereophonic is amplified by an amplification factor and subsequently delayed by a delay time; or alternatively, in case both said amplification factors are equal: the mono signal to be rendered stereophonic is delayed by a delay time and subsequently amplified by an amplification factor; or alternatively, in case both said amplification factors are equal: the mono signal to be rendered stereophonic is amplified by an amplification factor and subsequently delayed by a delay time; or alternatively, in case both said delay times are equal: the mono signal to be rendered stereophonic is delayed by a delay time and subsequently amplified by an amplification factor; or alternatively, in case both said delay times are equal: the mono signal to be rendered stereophonic is amplified by an amplification factor and subsequently delayed by a delay time; or alternatively, in case both said delay times are equal and both said amplification factors are equal: the mono signal to be rendered stereophonic is delayed by a delay time and subsequently amplified by an amplification factor; or alternatively, in case both said delay times are equal and both said amplification factors are equal: the mono signal to be rendered stereophonic is amplified and subsequently delayed by a delay time;
(i) the signals obtained under (g) and (h) are added in order to obtain a side signal; or, in case both said delay times are equal:
(j) the mono signal to be rendered stereophonic is delayed by a delay time and subsequently either: in case both said amplification factors are equal: amplified by an amplification factor; or, in case both said amplification factors are not equal: amplified by the sum of amplification factors, in order to obtain a side signal; or alternatively:
(k) the mono signal to be rendered stereophonic is either: in case both said amplification factors are equal: amplified by an amplification factor; oder, in case both said amplification factors are not equal: amplified by the sum of amplification factors and subsequently delayed by a delay time, in order to obtain a side signal; or alternatively:
(l) the mono signal to be rendered stereophonic is amplified by an amplification factor, delayed by a delay time and subsequently either: in case both said amplification factors are equal: amplified by a first amplification factor; or, in case both said amplification factors are not equal: amplified by a second amplification factor; or alternatively:
(m) the mono signal to be rendered stereophonic is amplified by an amplification factor, delayed by a delay time and subsequently either: in case both said amplification factors are equal: amplified by a second amplification factor; or, in case both said amplification factors are not equal: amplified by a first amplification factor; as well as overall:
(n) the stereo decoding of the mid and side signal into a stereo signal takes place; or alternatively: the stereo decoding of the mid and side signal into a stereo signal on the basis of a modified stereo decoder takes place, which contains an adder and a subtractor in order to add resp. to subtract input signals respectively amplified by predetermined factors.

21. Method according to claim 14, wherein
(a) the angle ascertained or stipulated manually or by metrology is analyzed; or:
(aa) an arbitrarily or algorithmically determined fictitious opening angle, lying to the left of a main axis, is not an element of an environment of zero nor equal to zero, and for which, provided said angle ascertained or stipulated manually or by metrology is positive, the condition is met that this angle ascertained or stipulated manually or by metrology is smaller than or equal to said fictitious opening angle lying to the left of the main axis, is analyzed; or:
(bb) an arbitrarily or algorithmically determined fictitious opening angle, lying to the right of a main axis, is not an element of an environment of zero nor equal to zero, and for which, provided said angle ascertained or stipulated manually or by metrology is negative, the condition is met that the value of this angle ascertained or stipulated manually or by metrology is smaller than or equal to said fictitious opening angle lying to the right of the main axis, is analyzed; or:
(cc) a directional characteristic, ascertained or also stipulated manually or by metrology, of the mono signal to be rendered stereophonic is analyzed; and overall:
(b) an amplification factor depending on said angle ascertained or stipulated manually or by metrology or on said fictitious opening angle or on a directional characteristic of the mono signal to be rendered stereophonic is calculated, wherein may not be equal to zero or an element of an environment of zero;
(c) an amplification factor depending on said angle ascertained or stipulated manually or by metrology or on one of said fictitious opening angles or on a directional characteristic of the mono signal to be rendered stereophonic is calculated; and overall:
(d) a delay time depending on said angle ascertained or stipulated manually or by metrology or on said fictitious opening angle or on a directional characteristic of the mono signal to be rendered stereophonic as well as overall on said time parameter is calculated; or:
(e) a delay time depending on said angle ascertained or stipulated manually or by metrology or on said fictitious opening angle or on a directional characteristic of the mono signal to be rendered stereophonic as well as overall on said time parameter (s) is calculated; and overall:
(f) the mono signal to be rendered stereophonic is amplified by an amplification factor; as well as either:
(g) the mono signal to be rendered stereophonic is delayed by a delay time; or alternatively, in case both said delay times are equal: the mono signal to be rendered stereophonic is delayed by a delay time;
(h) the mono signal to be rendered stereophonic is delayed by a delay time and subsequently amplified by a second amplification factor; or alternatively: the mono signal to be rendered stereophonic is amplified by a second amplification factor and subsequently delayed by a delay time; or alternatively, in case both said delay times are equal: the mono signal to be rendered stereophonic is delayed by a delay time and subsequently amplified by a second amplification factor; or alternatively, in case both said delay times are equal: the mono signal to be rendered stereophonic is amplified by a second amplification factor and subsequently delayed by a delay time;
(i) the signals obtained under (g) and (h) are added to obtain a side signal; or, in case both said delay times are equal:
(j) the mono signal to be rendered stereophonic is delayed by a delay time and subsequently amplified by a second amplification factor, in order to obtain a side signal; or alternatively:
(k) the mono signal to be rendered stereophonic is amplified by an amplification factor and subsequently delayed by a delay time, in order to obtain a side signal; as well as overall:
(l) the stereo decoding of the mid and side signal into a stereo signal takes place; or alternatively: the stereo decoding of the mid and side signal into a stereo signal on the basis of a modified stereo decoder takes place, which contains an adder and a subtractor in order to add resp. to subtract input signals respectively amplified by predetermined factors.

22. Method according to claim 14, wherein
(a) the angle ascertained or stipulated manually or by metrology is analyzed; or:
(aa) an arbitrarily or algorithmically determined fictitious opening angle, lying to the left of a main axis, is not an element of an environment of zero nor equal to zero, and for which, provided said angle ascertained or stipulated manually or by metrology is positive, the condition is met that this angle ascertained or stipulated manually or by metrology is smaller than or equal to said fictitious opening angle lying to the left of the main axis, is analyzed; or:
(bb) an arbitrarily or algorithmically determined fictitious opening angle, lying to the right of a main axis, is not an element of an environment of zero nor equal to zero, and for which, provided said angle ascertained or stipulated manually or by metrology is negative, the condition is met that the value of this angle ascertained or stipulated manually or by metrology is smaller than or equal to said fictitious opening angle lying to the right of the main axis, is analyzed; or:
(cc) a directional characteristic, ascertained or also stipulated manually or by metrology, of the mono signal to be rendered stereophonic is analyzed; and overall:
(b) an amplification factor depending on said angle ascertained or stipulated manually or by metrology or on said fictitious opening angle or on a directional characteristic of the mono signal to be rendered stereophonic is calculated, wherein a value 1/P_{M}″ may not be equal to zero nor an element of an environment of zero;
(c) an amplification factor depending on said angle ascertained or stipulated manually or by metrology or on one of said fictitious opening angles or on the directional characteristic of the mono signal to be rendered stereophonic is calculated; and overall:
(d) a delay time depending on said angle ascertained or stipulated manually or by metrology or on said fictitious opening angle or on a directional characteristic of the mono signal to be rendered stereophonic as well as overall on said time parameter is calculated; or:
(e) a delay time depending on said angle ascertained or stipulated manually or by metrology or on said fictitious opening angle or on a directional characteristic of the mono signal to be rendered stereophonic as well as overall on said time parameter is calculated; and overall:
(f) the mono signal to be rendered stereophonic is amplified by an amplification factor; as well as either:
(g) the mono signal to be rendered stereophonic is delayed by a delay time and subsequently amplified by an amplification factor; or alternatively: the mono signal to be rendered stereophonic is amplified by an amplification factor and subsequently delayed by a delay time; or alternatively, in case both said delay times are equal: the mono signal to be rendered stereophonic is delayed by a delay time and subsequently amplified by an amplification factor; or alternatively, in case both said delay times are equal: the mono signal to be rendered stereophonic is amplified by an amplification factor (P_{α}′) and subsequently delayed by a delay time;
(g) the mono signal to be rendered stereophonic is delayed by a second delay time; or alternatively, in case both said delay times are equal: the mono signal to be rendered stereophonic is delayed by a first delay time;
(i) the signals obtained under (g) and (h) are added to obtain a side signal; or, in case both said delay times are equal:
(j) the mono signal to be rendered stereophonic is delayed by a delay time and subsequently amplified by a first amplification factor, in order to obtain a side signal; or alternatively:
(k) the mono signal to be rendered stereophonic is amplified by a first amplification factor and subsequently delayed by a delay time, in order to obtain a side signal; as well as overall:
(j) the stereo decoding of the mid and side signal into a stereo signal takes place; or alternatively: the stereo decoding of the mid and side signal into a stereo signal on the basis of a modified stereo decoder takes place, which contains an adder and a subtractor in order to add resp. to subtract input signals respectively amplified by predetermined factors.

23. Method according to claim 14, wherein
(a) the angle ascertained or stipulated manually or by metrology a constant value is assumed; or:
(aa) an arbitrarily or algorithmically determined fictitious opening angle, lying to the left of a main axis, that is not an element of an environment of zero nor equal to zero, and for which, provided said angle ascertained or stipulated manually or by metrology is positive, the condition is met that this angle ascertained or stipulated manually or by metrology is smaller than or equal to said fictitious opening angle lying to the left of the main axis, a constant value is assumed; or:
(bb) an arbitrarily or algorithmically determined fictitious opening angle, lying to the right of a main axis, that is not an element of an environment of zero nor equal to zero, and for which, provided said angle ascertained or stipulated manually or by metrology is negative, the condition is met that the value of this angle ascertained or stipulated manually or by metrology is smaller than or equal to said fictitious opening angle lying to the right of the main axis, a constant value is assumed; wherein:
(cc) a directional characteristic, ascertained or also stipulated manually or by metrology, of the mono signal to be rendered stereophonic can be stipulated at will; and overall:
(b) a constant time difference previously calculated from one of these constant values or a constant amplification factor previously calculated from one of these constant values is used in a device according to claim 1.

24. Method according to claim 14, wherein
a delay time is calculated by the multiplication of constants (√5−1)/2 with said time parameter or a preset value for this time parameter, multiplied with said just mentioned constant, is used as delay time,
an amplification factor is equal to the constant 4/5,
the mono signal to be rendered stereophonic is multiplied by an amplification factor 4/5, in order to obtain a mid signal,
the mono signal to be rendered stereophonic is delayed by a delay time (L_{α}′=L_{β}′) in order to obtain a side signal,
the stereo decoding of the mid and side signal into a stereo signal takes place; or alternatively: the stereo decoding of the mid and side signal into a stereo signal on the basis of a modified stereo decoder takes place, which contains an adder and a subtractor in order to add resp. to subtract input signals respectively amplified by predetermined factors.

25. Method according to claim 14, wherein
a delay time is calculated by the multiplication of constants (√5−1)/2 with said time parameter or a preset value for this time parameter, multiplied with said just mentioned constant, is used as delay time,
an amplification factor is equal to the constant 5/4,
the mono signal to be rendered stereophonic is used directly as mid signal,
the mono signal to be rendered stereophonic is delayed by a delay time and subsequently amplified by an amplification factor 5/2 in order to obtain a side signal; or alternatively: the mono signal to be rendered stereophonic is amplified by an amplification factor 5/2 and subsequently delayed by a delay time in order to obtain a side signal; or alternatively: a main signal to be rendered stereophonic is amplified by a first amplification factor and subsequently delayed by a delay time and subsequently amplified by a second amplification factor in order to obtain a side signal, wherein for the first and second amplification factors the relation first amplification factor*second amplification factor=5/2 applies,
the stereo decoding of the mid and side signal into a stereo signal takes place; or alternatively: the stereo decoding of the mid and side signal into a stereo signal on the basis of a modified stereo decoder takes place, which contains an adder and a subtractor in order to add resp. to subtract input signals respectively amplified by predetermined factors.

26. Method according to claim 14, wherein the side signal prior to passing through the stereo decoder additionally appears amplified by an attenuation or an amplification factor.

27. Method according to claim 14, wherein the mid signal prior to passing through the stereo decoder additionally appears amplified by a reciprocal attenuation or an amplification factor, wherein (1≧τ+λ′≧0 and λ=τ+λ′).

28. Method according to claim 14, wherein either:
one stereo decoder for the pseudostereo conversion and two panorama potentiometers connected downstream thereto are passed through, wherein each panorama potentiometer forms two collective buses; or:
one stereo decoder for the pseudostereo conversion and one amplifier, connected upstream of the stereo decoder, for amplifying an input signal from the stereo decoder are passed through; or:
one stereo decoder for the pseudostereo conversion and respectively one amplifier connected upstream of the stereo decoder for each input signal of the stereo decoder are passed through; or:
a modified stereo decoder for the pseudostereo conversion, which contains an adder and a subtractor in order to add resp. to subtract input signals respectively amplified by predetermined factors, is passed through in order to generate signals that are identical with said collective bus signals.

29. Method according to claim 14, wherein an automatic or interactive optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of one or several weighting functions.

30. Method according to claim 14, wherein an automatic or interactive optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of the reverberation of an existing stereophonic or pseudostereophonic signal or on the basis of characteristics defined by the user relating to the reverberation.

31. Method according to claim 14, wherein the optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation (ε) or of a limit value for optimizing the function values with respect to an image width or of a deviation for forming a resulting stereo signal or of said time parameter takes place on the basis of the first main reflection of an existing stereophonic or pseudostereophonic signal.

32. Method according to claim 14, wherein the optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter can be stipulated or can be influenced by the user with respect to the characteristics of the achieved reverberation or of the achieved first main reflection.

33. Method according to claim 14, wherein an optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of an operator containing the specific transfer functions for the formation of the first main reflection from the stereophonic or pseudostereophonic signal delayed by the delay time.

34. Method according to claim 14, wherein the optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of one or several operators containing the specific transfer functions for the formation of the reverberation from the delayed or undelayed stereophonic or pseudostereophonic signal.

35. Method according to claim 14, wherein the optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of the technical implementation of a so-called inverse problem.

36. Method according to claim 14, wherein an optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of a dictionary or of a dictionary of operators.

37. Method according to claim 14, wherein the optimization of a parameter describing the directional pattern of a signal that is to be rendered stereophonic, or of said angle ascertained or stipulated manually or by metrology and enclosed by the main axis and the sound source, or of a fictitious left opening angle or of a fictitious right opening angle or of an attenuation or of amplification factors or of a degree of correlation or of a parameter for defining an allowable value range or a limit value for determining resp. maximizing an absolute value or of a deviation or of a parameter defining a localisation direction or of a limit value for selecting an image width or of a deviation or of a limit value for optimizing the function values with respect to an image width or of a deviation for forming a resulting stereo signal or of said time parameter takes place on the basis of the comparison with the sinusoidal model or with another localization model or other characteristics of an existing stereophonic or pseudostereophonic signal.

38. Method according to claim 14, comprising the additional use of compression algorithms or data reduction methods.

39. Method according to claim 14, wherein at least one all-pass filter of first or second or n^{th} order is used.

40. Method according to claim 14, wherein at least one phase shifter is used.

41. Method according to claim 14, wherein
a first pseudostereophonic signal is obtained from a mono signal,
a second pseudostereophonic signal is obtained from an obtained left signal,
a third pseudostereophonic signal is obtained from an obtained right signal; wherein optionally:
the obtained signals are matched to one another.

42. Method according to claim 14, wherein
a mono signal is used directly as signal,
from the mono signal a first pseudostereophonic signal is obtained,
from the mono signal a second pseudostereophonic signal is obtained.

43. Method according to claim 14, wherein
from the left channel of a stereo signal a first pseudostereophonic signal is obtained,
from the right channel of a stereo signal a second pseudostereophonic signal is obtained; wherein optionally:
the obtained signals are matched to one another.

44. Method according to claim 14, wherein signals for systems for reproducing sound with n loudspeakers, n≧2, are created.

45. Method according to claim 14, wherein instead of the respective calculation of the time differences or of the amplification factors, if necessary taking into account the inversely proportional attenuations or the amplification factors, a dictionary with corresponding values for the delaying or amplifying of the input signal to be rendered stereophonic is used.

46. Method according to claim 45, wherein the dictionary is created in the interval [0, π/2] on the basis of values varied respectively by π/36 from a fictitious opening angle or from said angle ascertained or stipulated manually or by metrology.
